(19) United States
(12) Patent Application Publication
(10) Pub. No.: US 2025/0350541 A1
(43) Pub. Date: Nov. 13, 2025

(54) USER INTERFACES FOR MANAGING COMMUNICATIONS

(71) Applicant: Apple Inc., Cupertino, CA (US)

(72) Inventor: Grant R. PAUL, San Francisco, CA (US)

(21) Appl. No.: 19/046,385

(22) Filed: Feb. 5, 2025

Related U.S. Application Data
(60) Provisional application No. 63/646,783, filed on May 13, 2024.
(60) Provisional application No. 63/657,053, filed on Jun. 6, 2024.

(51) Int. Cl. H04L 41/22; G06F 9/451; H04L 51/04

(52) U.S. Cl. CPC H04L 41/22; G06F 9/451; H04L 51/04

(57) ABSTRACT

The present disclosure generally relates to managing communications. In some examples, a computer system prompts a user to confirm sending a communication based on a determination that the communication is being sent to an external device that is operating in a particular mode of operation.

### CROSS-REFERENCE TO RELATED APPLICATIONS

This application claims priority to U.S. Provisional Patent Application No. 63/657,053, filed Jun. 6, 2024, entitled “USER INTERFACES FOR MANAGING COMMUNICATIONS,” and U.S. Provisional Patent Application No. 63/646,783, filed May 13, 2024, entitled “USER INTERFACES FOR MANAGING COMMUNICATIONS,” the entire contents of each of which are hereby incorporated by reference.

### FIELD

The present disclosure relates generally to computer user interfaces, and more specifically to techniques for managing communications.

### BACKGROUND

Electronic computer systems provide means for communicating such as via text messages and email.

### BRIEF SUMMARY

Some techniques for managing communications using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for managing communications. Such methods and interfaces optionally complement or replace other methods for managing communications. Such methods and interfaces reduce the cognitive burden on a user and produce a more efficient human-machine interface. For battery-operated computing devices, such methods and interfaces conserve power and increase the time between battery charges.

In accordance with some embodiments, a method is described. The method comprises: at a computer system: while the computer system is operating in a first mode of operation, wherein the computer system is configured to perform communications via a non-terrestrial communication network when operating in the first mode of operation, receiving a request to communicate with an external device; and in response to receiving the request to communicate with an external device, wherein the external device is associated with a non-emergency number: in accordance with a determination that a set of criteria is met, initiating a process for communicating with the external device via the non-terrestrial communication network; and in accordance with a determination that the set of criteria is not met, prompting a user of the computer system to connect to the non-terrestrial communication network without initiating the process for communicating with the external device via the non-terrestrial communication network.

In accordance with some embodiments, a non-transitory computer-readable storage medium is described. The non-transitory computer-readable storage medium stores one or more programs configured to be executed by one or more processors of a computer system. The one or more programs include instructions for: while the computer system is operating in a first mode of operation, wherein the computer system is configured to perform communications via a non-terrestrial communication network when operating in the first mode of operation, receiving a request to communicate with an external device; and in response to receiving the request to communicate with an external device, wherein the external device is associated with a non-emergency number: in accordance with a determination that a set of criteria is met, initiating a process for communicating with the external device via the non-terrestrial communication network; and in accordance with a determination that the set of criteria is not met, prompting a user of the computer system to connect to the non-terrestrial communication network without initiating the process for communicating with the external device via the non-terrestrial communication network.

In accordance with some embodiments, a transitory computer-readable storage medium is described. The transitory computer-readable storage medium stores one or more programs configured to be executed by one or more processors of a computer system. The one or more programs include instructions for: while the computer system is operating in a first mode of operation, wherein the computer system is configured to perform communications via a non-terrestrial communication network when operating in the first mode of operation, receiving a request to communicate with an external device; and in response to receiving the request to communicate with an external device, wherein the external device is associated with a non-emergency number: in accordance with a determination that a set of criteria is met, initiating a process for communicating with the external device via the non-terrestrial communication network; and in accordance with a determination that the set of criteria is not met, prompting a user of the computer system to connect to the non-terrestrial communication network without initiating the process for communicating with the external device via the non-terrestrial communication network.

In accordance with some embodiments, a computer system is described. The computer system comprises one or more processors and memory storing one or more programs configured to be executed by the one or more processors. The one or more programs include instructions for: while the computer system is operating in a first mode of operation, wherein the computer system is configured to perform communications via a non-terrestrial communication network when operating in the first mode of operation, receiving a request to communicate with an external device; and in response to receiving the request to communicate with an external device, wherein the external device is associated with a non-emergency number: in accordance with a determination that a set of criteria is met, initiating a process for communicating with the external device via the non-terrestrial communication network; and in accordance with a determination that the set of criteria is not met, prompting a user of the computer system to connect to the non-terrestrial communication network without initiating the process for communicating with the external device via the non-terrestrial communication network.

In accordance with some embodiments, a computer system is described. The computer system comprises: means for, while the computer system is operating in a first mode of operation, wherein the computer system is configured to perform communications via a non-terrestrial communication network when operating in the first mode of operation, receiving a request to communicate with an external device; and means for, in response to receiving the request to communicate with an external device, wherein the external device is associated with a non-emergency number: in accordance with a determination that a set of criteria is met, initiating a process for communicating with the external device via the non-terrestrial communication network; and in accordance with a determination that the set of criteria is not met, prompting a user of the computer system to connect to the non-terrestrial communication network without initiating the process for communicating with the external device via the non-terrestrial communication network.

In accordance with some embodiments, a computer program product is described. The computer program product comprises one or more programs configured to be executed by one or more processors of a computer system. The one or more programs include instructions for: while the computer system is operating in a first mode of operation, wherein the computer system is configured to perform communications via a non-terrestrial communication network when operating in the first mode of operation, receiving a request to communicate with an external device; and in response to receiving the request to communicate with an external device, wherein the external device is associated with a non-emergency number: in accordance with a determination that a set of criteria is met, initiating a process for communicating with the external device via the non-terrestrial communication network; and in accordance with a determination that the set of criteria is not met, prompting a user of the computer system to connect to the non-terrestrial communication network without initiating the process for communicating with the external device via the non-terrestrial communication network.

In accordance with some embodiments, a method is described. The method comprises: at a computer system that is in communication with a display generation component and one or more input devices: while the computer system is operating in a first mode of operation, wherein the computer system is configured to communicate with an external device via a terrestrial communication network while operating in the first mode of operation: in accordance with a determination that a set of communication criteria is met, displaying, via the display generation component: a first selectable user interface element that, when selected via user input, causes the computer system to activate a second mode of operation different from the first mode of operation, wherein the computer system is configured to communicate with the external device via a non-terrestrial communication network while operating in the second mode of operation; and a second selectable user interface element that, when selected via user input, causes the computer system to maintain operation in the first mode of operation; detecting, via the one or more input devices, a first user input; and in response to detecting the first user input: in accordance with a determination that the first user input corresponds to the first selectable user interface element: transitioning operation of the computer system from the first mode of operation to the second mode of operation; and prompting a user of the computer system to position the computer system in a predetermined orientation; and in accordance with a determination that the first user input corresponds to the second selectable user interface element, maintaining operation of the computer system in the first mode of operation.

In accordance with some embodiments, a non-transitory computer-readable storage medium is described. The non-transitory computer-readable storage medium stores one or more programs configured to be executed by one or more processors of a computer system that is in communication with a display generation component and one or more input devices. The one or more programs include instructions for: while the computer system is operating in a first mode of operation, wherein the computer system is configured to communicate with an external device via a terrestrial communication network while operating in the first mode of operation: in accordance with a determination that a set of communication criteria is met, displaying, via the display generation component: a first selectable user interface element that, when selected via user input, causes the computer system to activate a second mode of operation different from the first mode of operation, wherein the computer system is configured to communicate with the external device via a non-terrestrial communication network while operating in the second mode of operation; and a second selectable user interface element that, when selected via user input, causes the computer system to maintain operation in the first mode of operation; detecting, via the one or more input devices, a first user input; and in response to detecting the first user input: in accordance with a determination that the first user input corresponds to the first selectable user interface element: transitioning operation of the computer system from the first mode of operation to the second mode of operation; and prompting a user of the computer system to position the computer system in a predetermined orientation; and in accordance with a determination that the first user input corresponds to the second selectable user interface element, maintaining operation of the computer system in the first mode of operation.

In accordance with some embodiments, a transitory computer-readable storage medium is described. The transitory computer-readable storage medium stores one or more programs configured to be executed by one or more processors of a computer system that is in communication with a display generation component and one or more input devices. The one or more programs include instructions for: while the computer system is operating in a first mode of operation, wherein the computer system is configured to communicate with an external device via a terrestrial communication network while operating in the first mode of operation: in accordance with a determination that a set of communication criteria is met, displaying, via the display generation component: a first selectable user interface element that, when selected via user input, causes the computer system to activate a second mode of operation different from the first mode of operation, wherein the computer system is configured to communicate with the external device via a non-terrestrial communication network while operating in the second mode of operation; and a second selectable user interface element that, when selected via user input, causes the computer system to maintain operation in the first mode of operation; detecting, via the one or more input devices, a first user input; and in response to detecting the first user input: in accordance with a determination that the first user input corresponds to the first selectable user interface element: transitioning operation of the computer system from the first mode of operation to the second mode of operation; and prompting a user of the computer system to position the computer system in a predetermined orientation; and in accordance with a determination that the first user input corresponds to the second selectable user interface element, maintaining operation of the computer system in the first mode of operation.

In accordance with some embodiments, a computer system configured to communicate with a display generation component and one or more input devices is described. The computer system comprises one or more processors and memory storing one or more programs configured to be executed by the one or more processors. The one or more programs include instructions for: while the computer system is operating in a first mode of operation, wherein the computer system is configured to communicate with an external device via a terrestrial communication network while operating in the first mode of operation: in accordance with a determination that a set of communication criteria is met, displaying, via the display generation component: a first selectable user interface element that, when selected via user input, causes the computer system to activate a second mode of operation different from the first mode of operation, wherein the computer system is configured to communicate with the external device via a non-terrestrial communication network while operating in the second mode of operation; and a second selectable user interface element that, when selected via user input, causes the computer system to maintain operation in the first mode of operation; detecting, via the one or more input devices, a first user input; and in response to detecting the first user input: in accordance with a determination that the first user input corresponds to the first selectable user interface element: transitioning operation of the computer system from the first mode of operation to the second mode of operation; and prompting a user of the computer system to position the computer system in a predetermined orientation; and in accordance with a determination that the first user input corresponds to the second selectable user interface element, maintaining operation of the computer system in the first mode of operation.

In accordance with some embodiments, a computer system configured to communicate with a display generation component and one or more input devices is described. The computer system comprises: means for, while the computer system is operating in a first mode of operation, wherein the computer system is configured to communicate with an external device via a terrestrial communication network while operating in the first mode of operation: in accordance with a determination that a set of communication criteria is met, displaying, via the display generation component: a first selectable user interface element that, when selected via user input, causes the computer system to activate a second mode of operation different from the first mode of operation, wherein the computer system is configured to communicate with the external device via a non-terrestrial communication network while operating in the second mode of operation; and a second selectable user interface element that, when selected via user input, causes the computer system to maintain operation in the first mode of operation; means for detecting, via the one or more input devices, a first user input; and means for, in response to detecting the first user input: in accordance with a determination that the first user input corresponds to the first selectable user interface element: transitioning operation of the computer system from the first mode of operation to the second mode of operation; and prompting a user of the computer system to position the computer system in a predetermined orientation; and in accordance with a determination that the first user input corresponds to the second selectable user interface element, maintaining operation of the computer system in the first mode of operation.

In accordance with some embodiments, a computer program product is described. The computer program product comprises one or more programs configured to be executed by one or more processors of a computer system that is in communication with a display generation component and one or more input devices. The one or more programs include instructions for: while the computer system is operating in a first mode of operation, wherein the computer system is configured to communicate with an external device via a terrestrial communication network while operating in the first mode of operation: in accordance with a determination that a set of communication criteria is met, displaying, via the display generation component: a first selectable user interface element that, when selected via user input, causes the computer system to activate a second mode of operation different from the first mode of operation, wherein the computer system is configured to communicate with the external device via a non-terrestrial communication network while operating in the second mode of operation; and a second selectable user interface element that, when selected via user input, causes the computer system to maintain operation in the first mode of operation; detecting, via the one or more input devices, a first user input; and in response to detecting the first user input: in accordance with a determination that the first user input corresponds to the first selectable user interface element: transitioning operation of the computer system from the first mode of operation to the second mode of operation; and prompting a user of the computer system to position the computer system in a predetermined orientation; and in accordance with a determination that the first user input corresponds to the second selectable user interface element, maintaining operation of the computer system in the first mode of operation.

In accordance with some embodiments, a method is described. The method comprises: at a computer system: in response to a request to send a communication to an external device: in accordance with a determination that the external device is operating in a first mode of operation, prompting a user of the computer system to provide an input to confirm sending the communication to the external device via a first communication protocol; and in accordance with a determination that the external device is not operating in the first mode of operation: forgoing prompting the user to provide a user input to confirm sending the communication to the external device via the first communication protocol; and sending the communication to the external device via a second communication protocol different from the first communication protocol.

In accordance with some embodiments, a non-transitory computer-readable storage medium is described. The non-transitory computer-readable storage medium stores one or more programs configured to be executed by one or more processors of a computer system. The one or more programs include instructions for: in response to a request to send a communication to an external device: in accordance with a determination that the external device is operating in a first mode of operation, prompting a user of the computer system to provide an input to confirm sending the communication to the external device via a first communication protocol; and in accordance with a determination that the external device is not operating in the first mode of operation: forgoing prompting the user to provide a user input to confirm sending the communication to the external device via the first communication protocol; and sending the communication to the external device via a second communication protocol different from the first communication protocol.

In accordance with some embodiments, a transitory computer-readable storage medium is described. The transitory computer-readable storage medium stores one or more programs configured to be executed by one or more processors of a computer system. The one or more programs include instructions for: in response to a request to send a communication to an external device: in accordance with a determination that the external device is operating in a first mode of operation, prompting a user of the computer system to provide an input to confirm sending the communication to the external device via a first communication protocol; and in accordance with a determination that the external device is not operating in the first mode of operation: forgoing prompting the user to provide a user input to confirm sending the communication to the external device via the first communication protocol; and sending the communication to the external device via a second communication protocol different from the first communication protocol.

In accordance with some embodiments, a computer system is described. The computer system comprises one or more processors and memory storing one or more programs configured to be executed by the one or more processors. The one or more programs include instructions for: in response to a request to send a communication to an external device: in accordance with a determination that the external device is operating in a first mode of operation, prompting a user of the computer system to provide an input to confirm sending the communication to the external device via a first communication protocol; and in accordance with a determination that the external device is not operating in the first mode of operation: forgoing prompting the user to provide a user input to confirm sending the communication to the external device via the first communication protocol; and sending the communication to the external device via a second communication protocol different from the first communication protocol.

In accordance with some embodiments, a computer system is described. The computer system comprises: means for, in response to a request to send a communication to an external device: in accordance with a determination that the external device is operating in a first mode of operation, prompting a user of the computer system to provide an input to confirm sending the communication to the external device via a first communication protocol; and in accordance with a determination that the external device is not operating in the first mode of operation: forgoing prompting the user to provide a user input to confirm sending the communication to the external device via the first communication protocol; and sending the communication to the external device via a second communication protocol different from the first communication protocol.

In accordance with some embodiments, a computer program product is described. The computer program product comprises one or more programs configured to be executed by one or more processors of a computer system. The one or more programs include instructions for: in response to a request to send a communication to an external device: in accordance with a determination that the external device is operating in a first mode of operation, prompting a user of the computer system to provide an input to confirm sending the communication to the external device via a first communication protocol; and in accordance with a determination that the external device is not operating in the first mode of operation: forgoing prompting the user to provide a user input to confirm sending the communication to the external device via the first communication protocol; and sending the communication to the external device via a second communication protocol different from the first communication protocol.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for managing communications, thereby increasing the effectiveness, efficiency, and user satisfaction with such devices. Such methods and interfaces may complement or replace other methods for managing communications.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6AP illustrate exemplary user interfaces for managing communications, in accordance with some embodiments.

FIG. 7 is a flow diagram illustrating methods for initiating communications via a non-terrestrial network, in accordance with some embodiments.

FIG. 8 is a flow diagram illustrating methods for transitioning between operating modes, in accordance with some embodiments.

FIG. 9 is a flow diagram illustrating methods for initiating communications, in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for managing communications. For example, there is a need for electronic devices that initiate communications when connected to a non-terrestrial communication network and/or prompt a user to connect to the non-terrestrial communication network when not connected to the non-terrestrial communication network. There is also a need for electronic devices that prompt a user to transition between operating modes when terrestrial communication networks are not available. In addition, there is a need for electronic devices that prompt a user to confirm sending a communication when a recipient device is operating in a particular mode. Such techniques can reduce the cognitive burden on a user who communicates via a computer system, thereby enhancing productivity. Further, such techniques can reduce processor and battery power otherwise wasted on redundant user inputs.

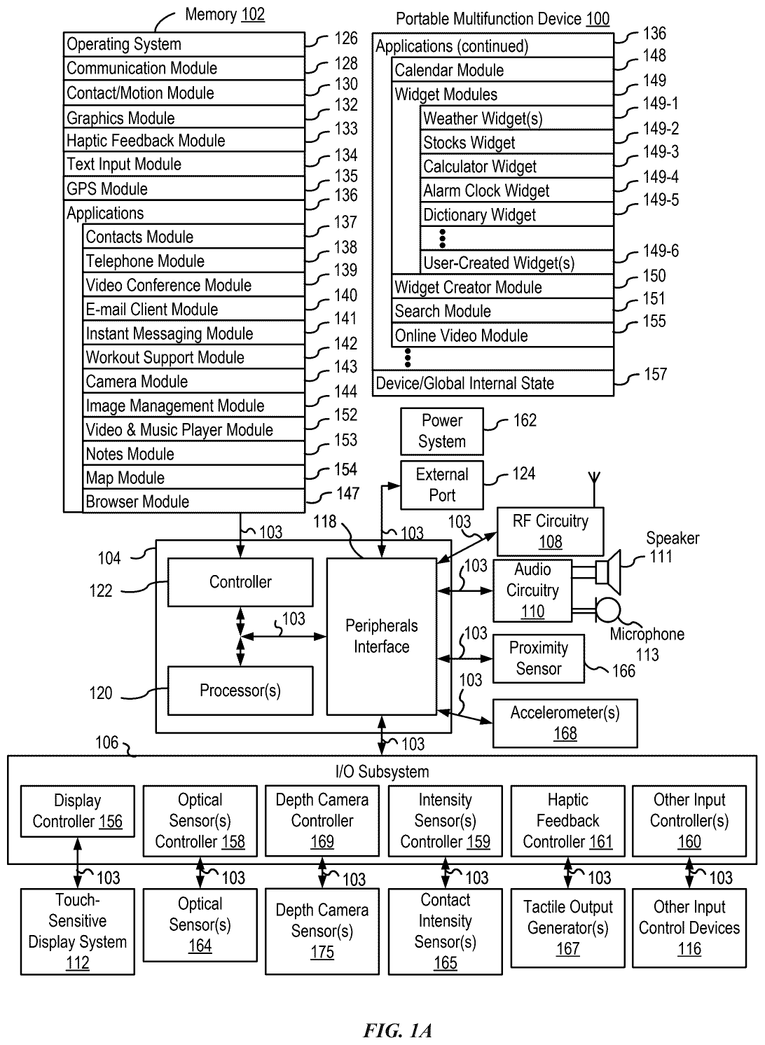

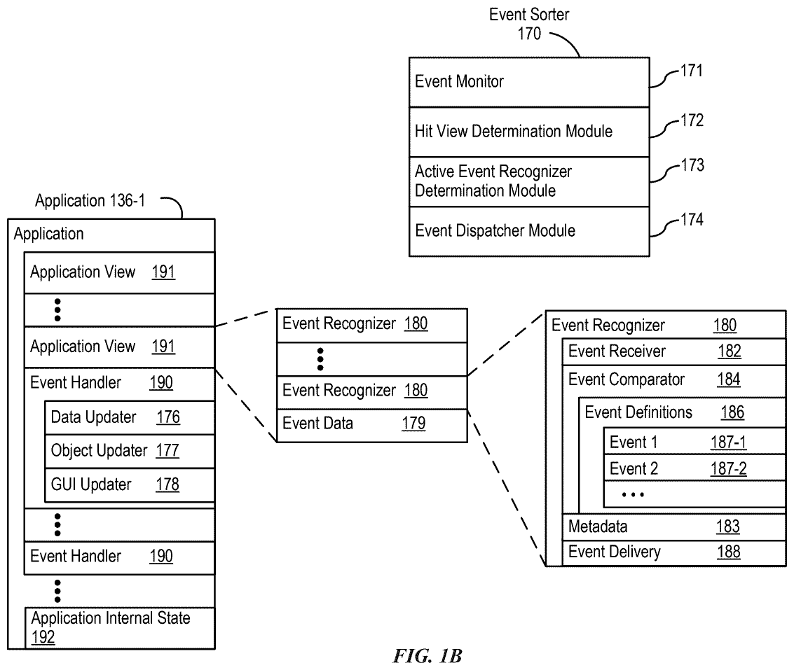

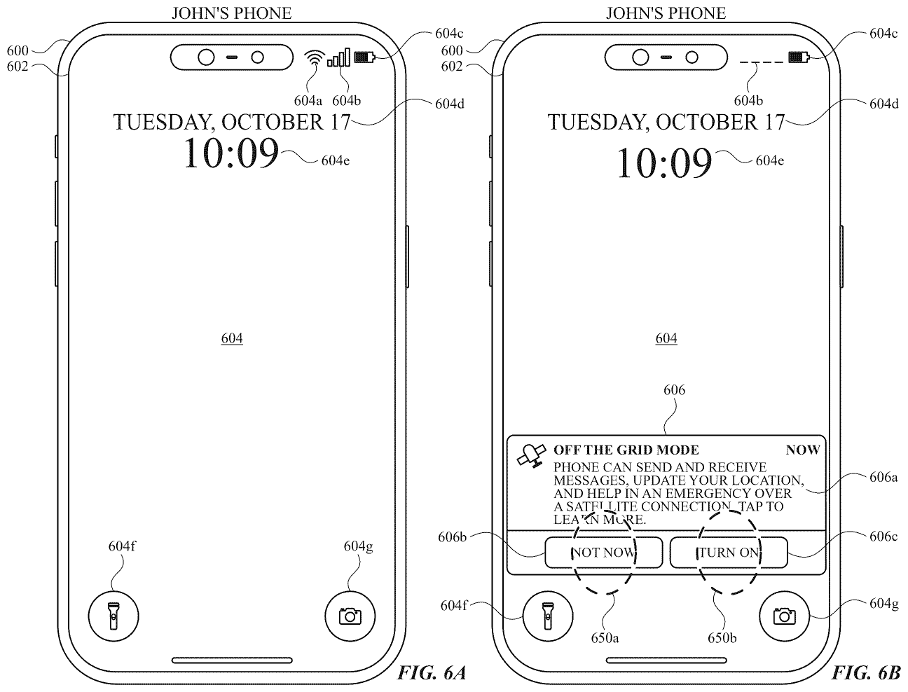

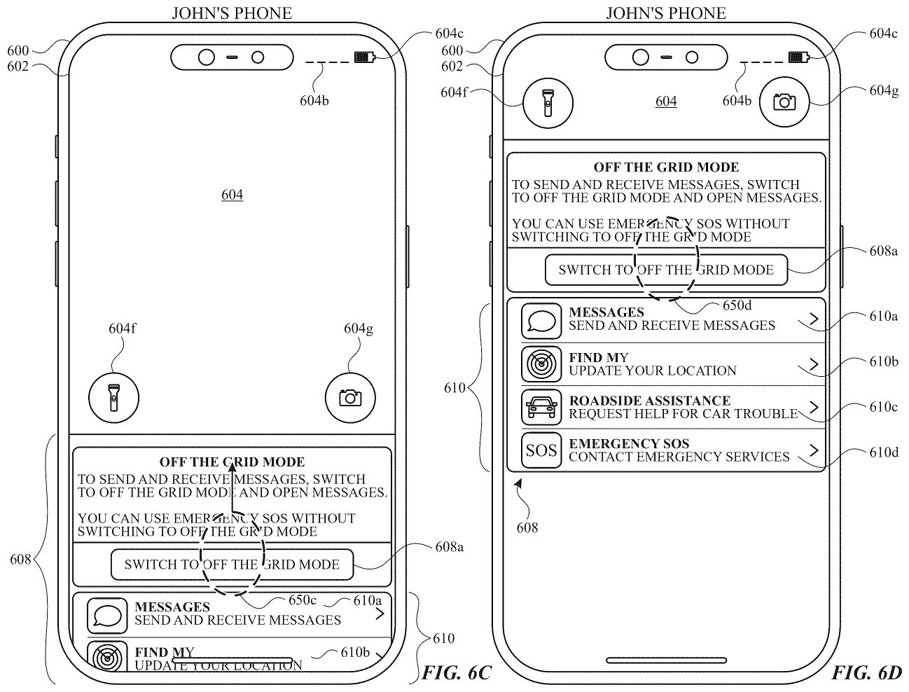

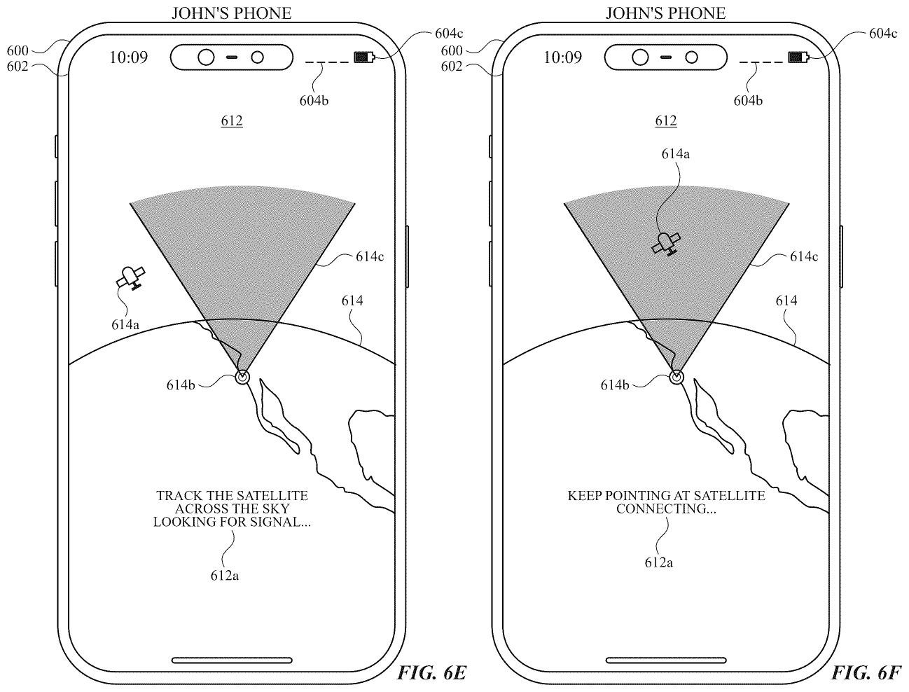

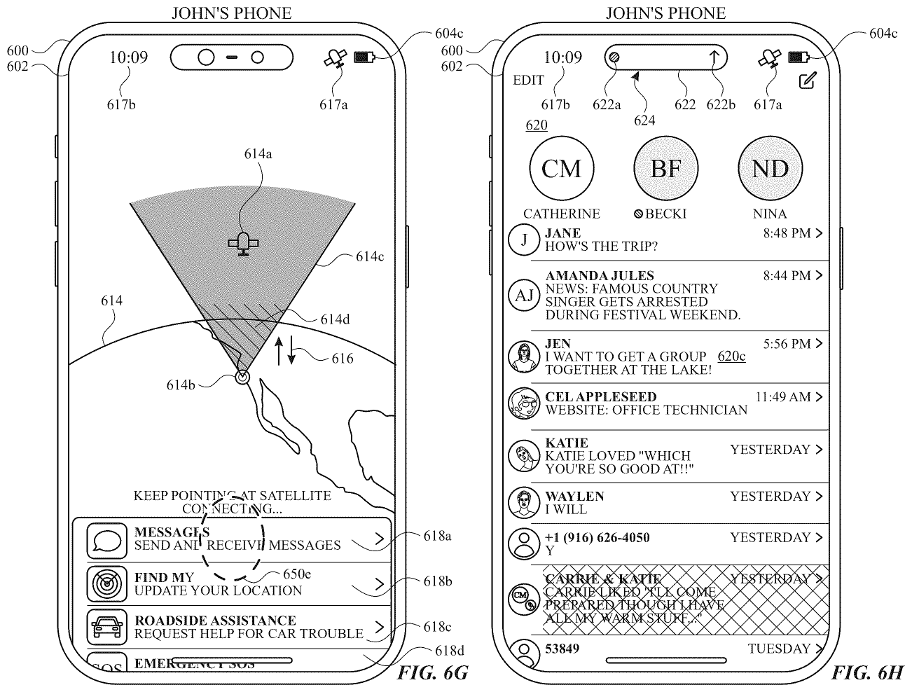

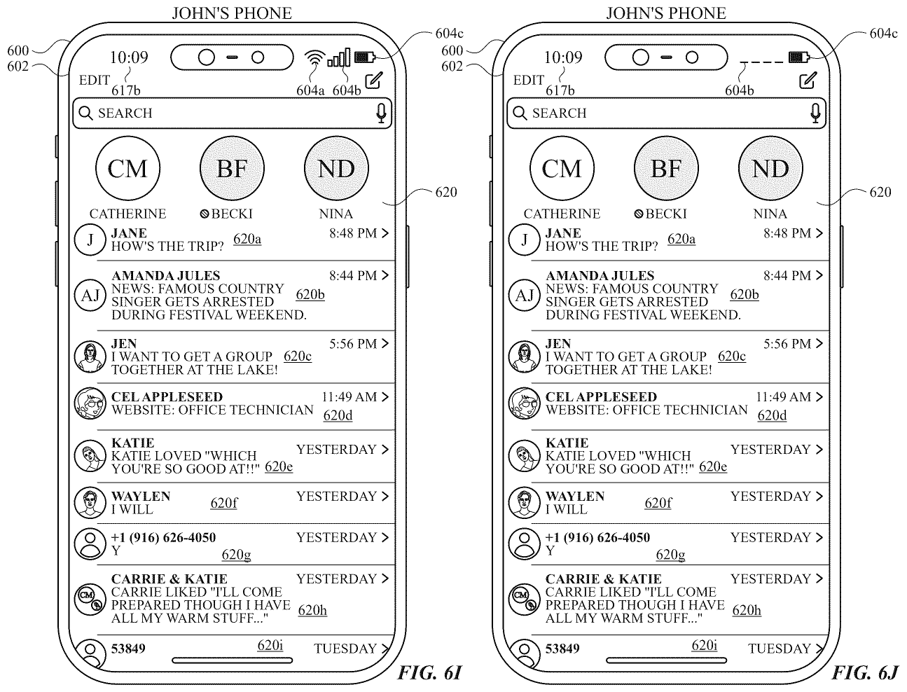

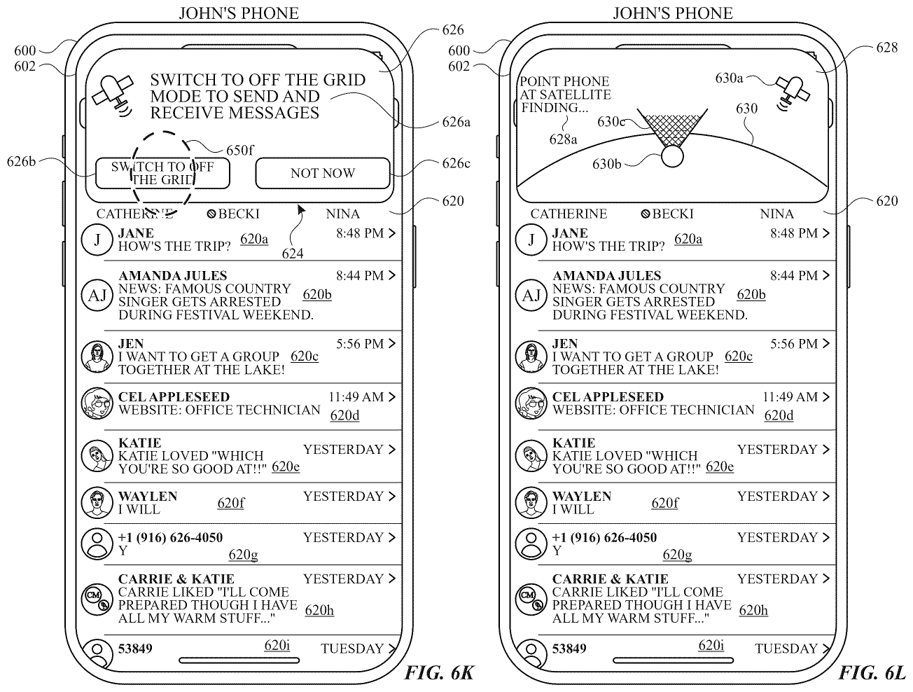

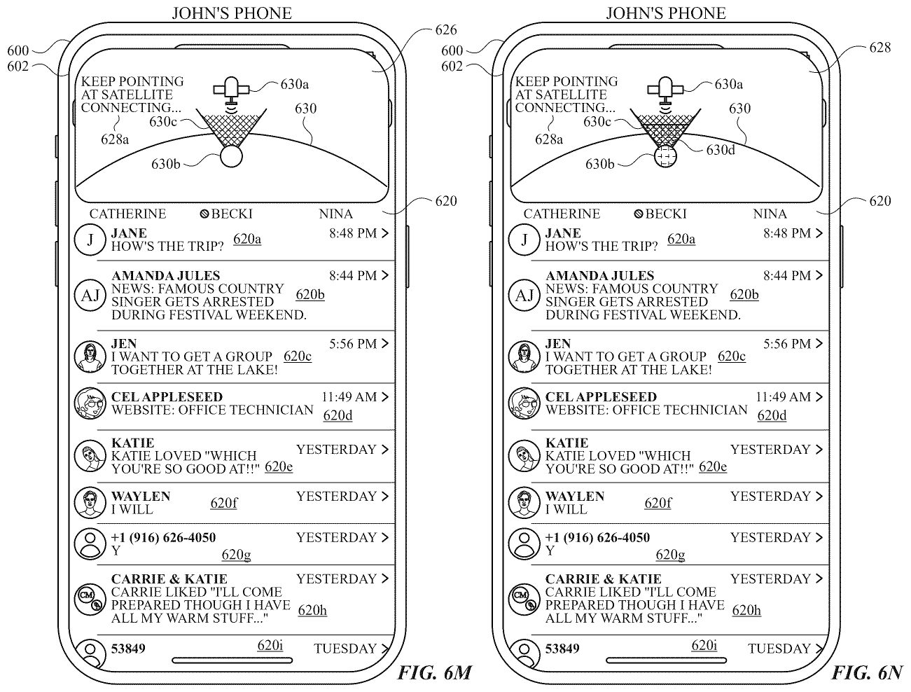

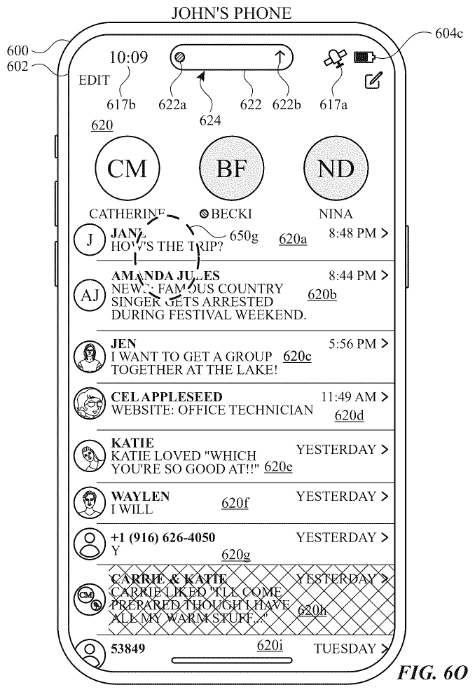

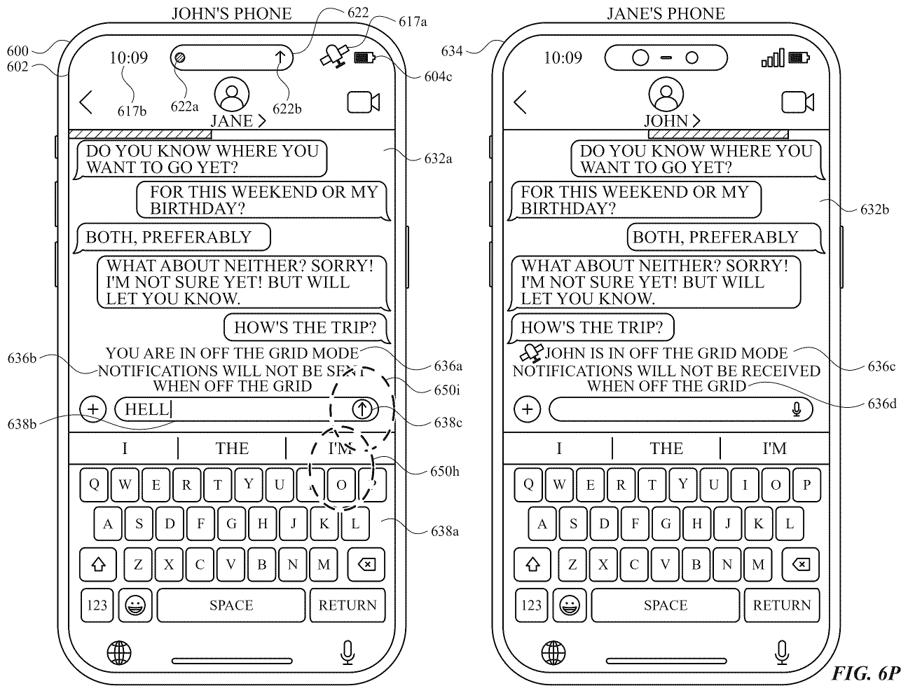

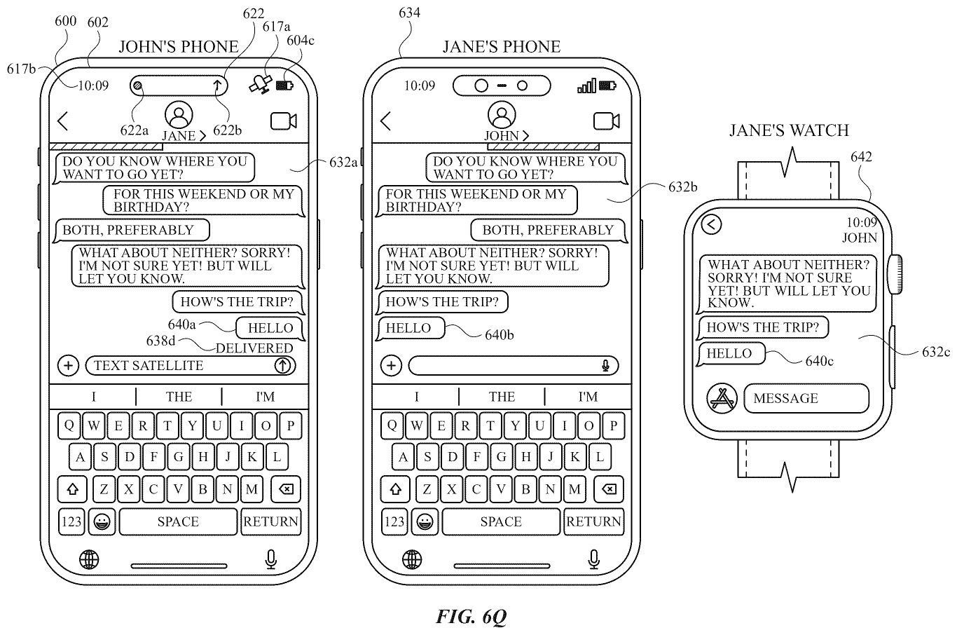

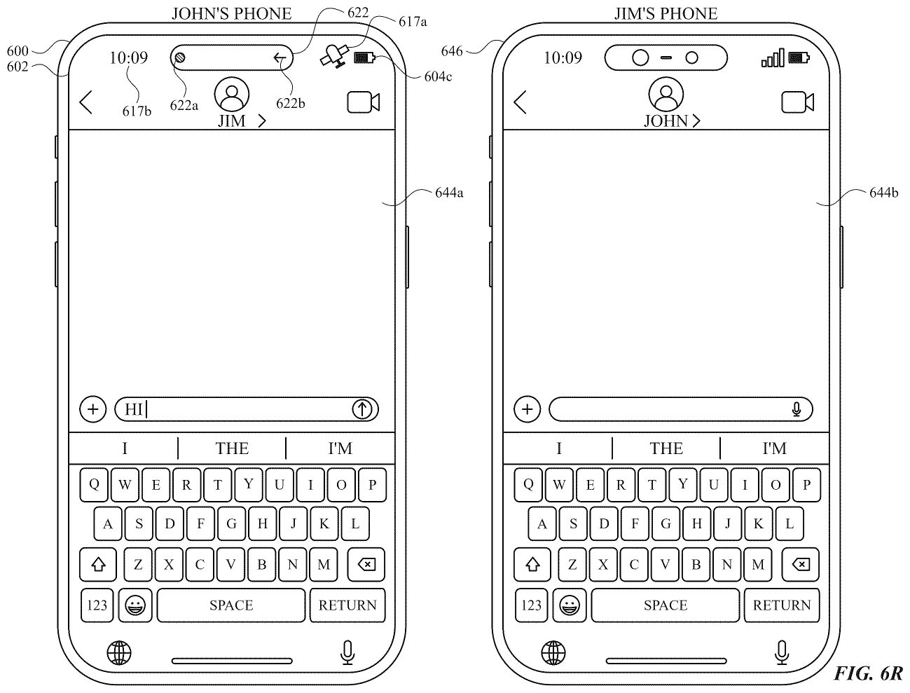

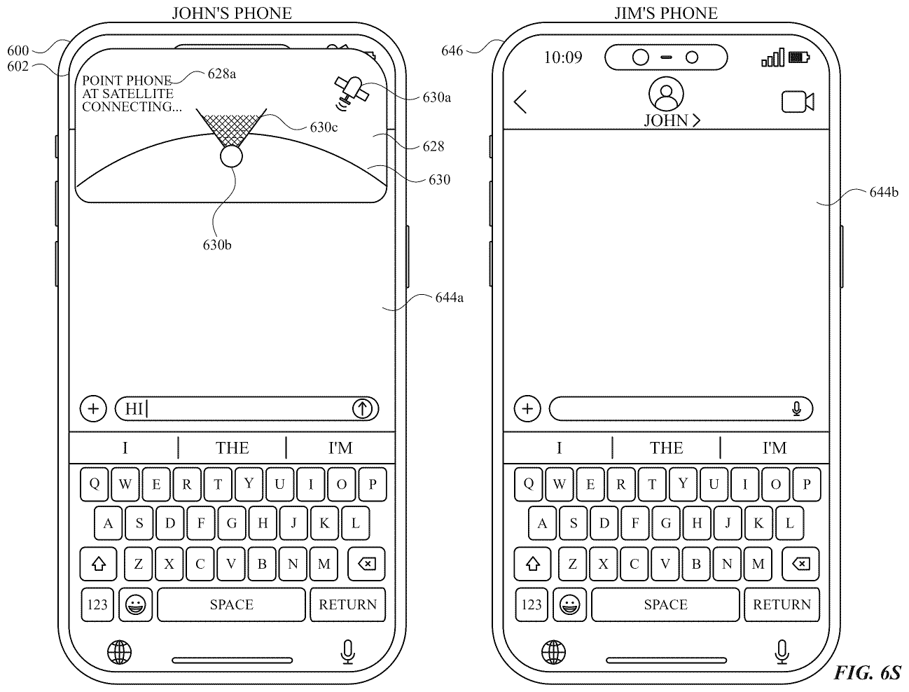

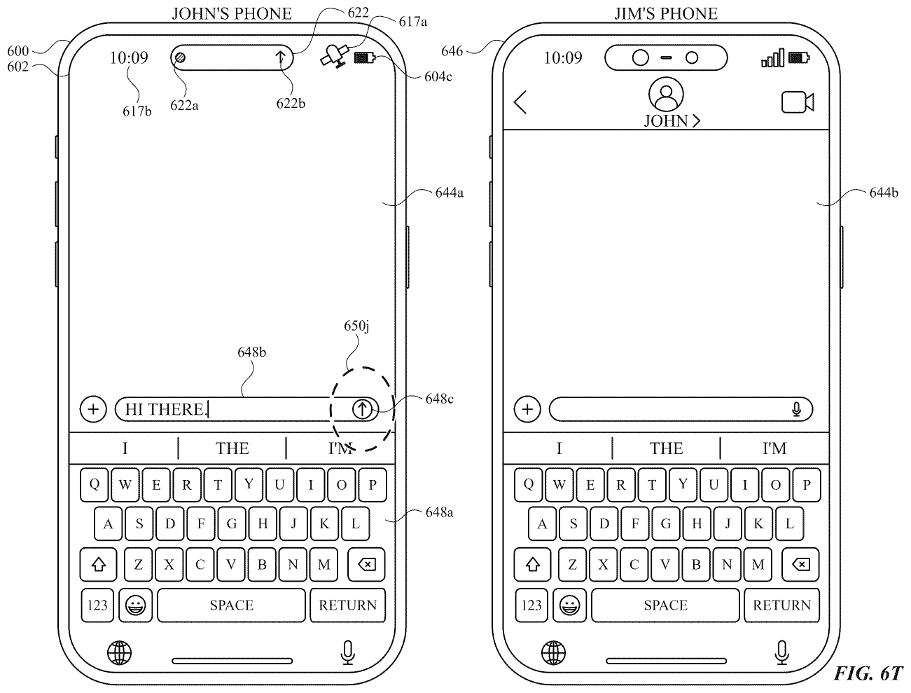

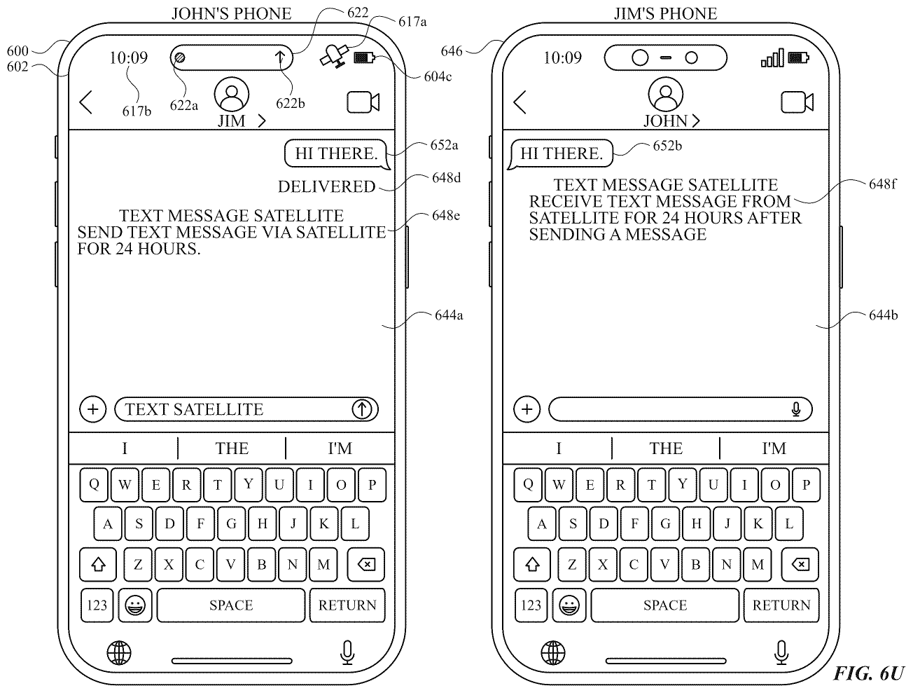

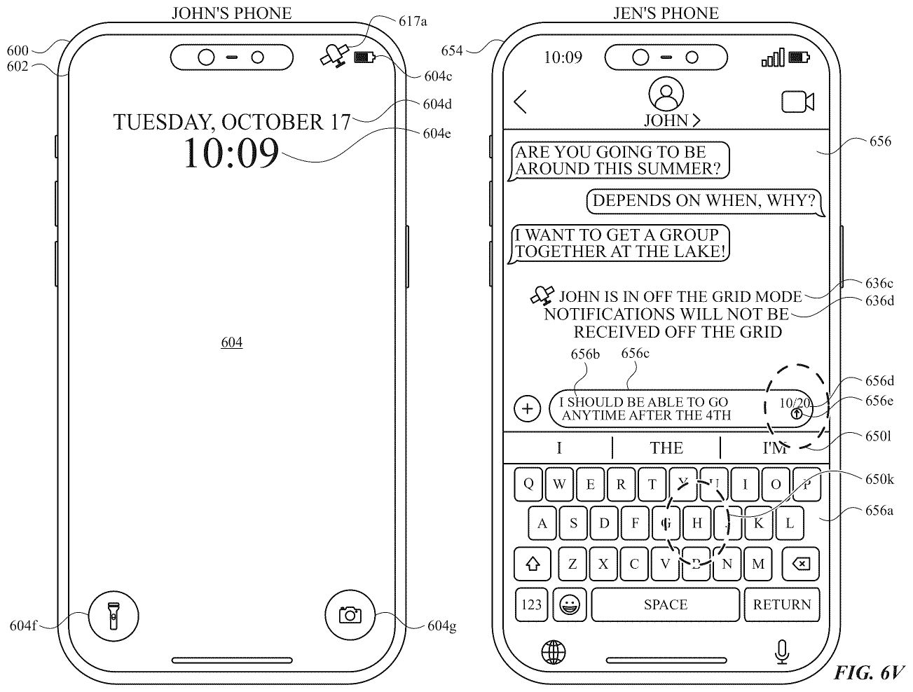

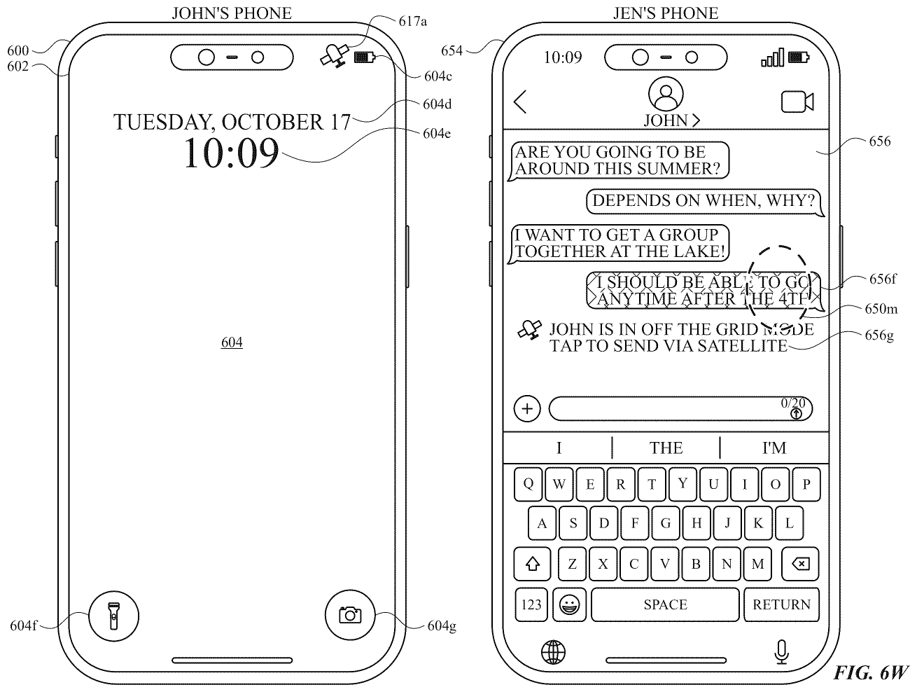

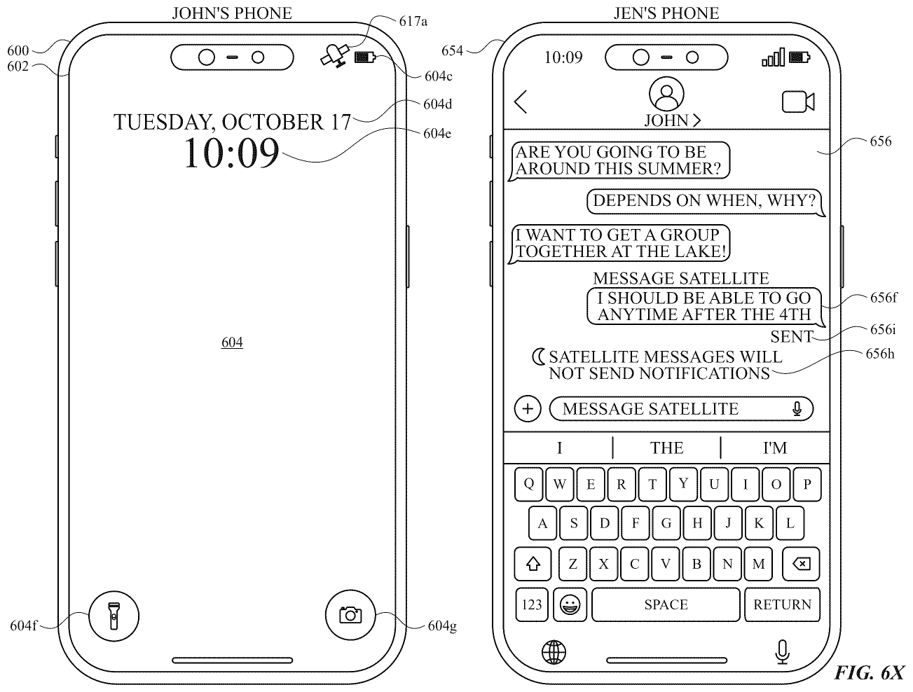

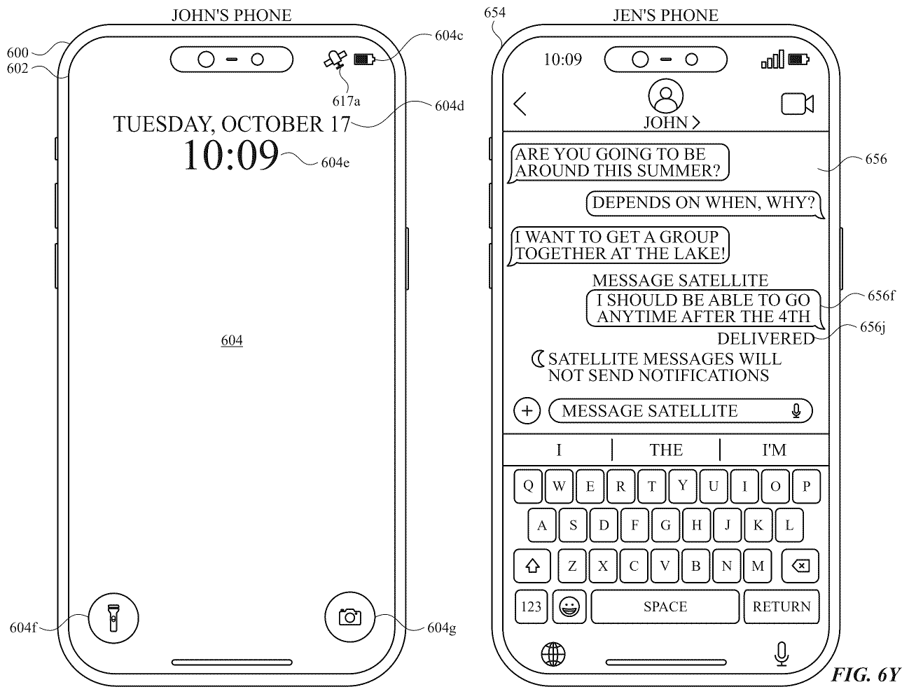

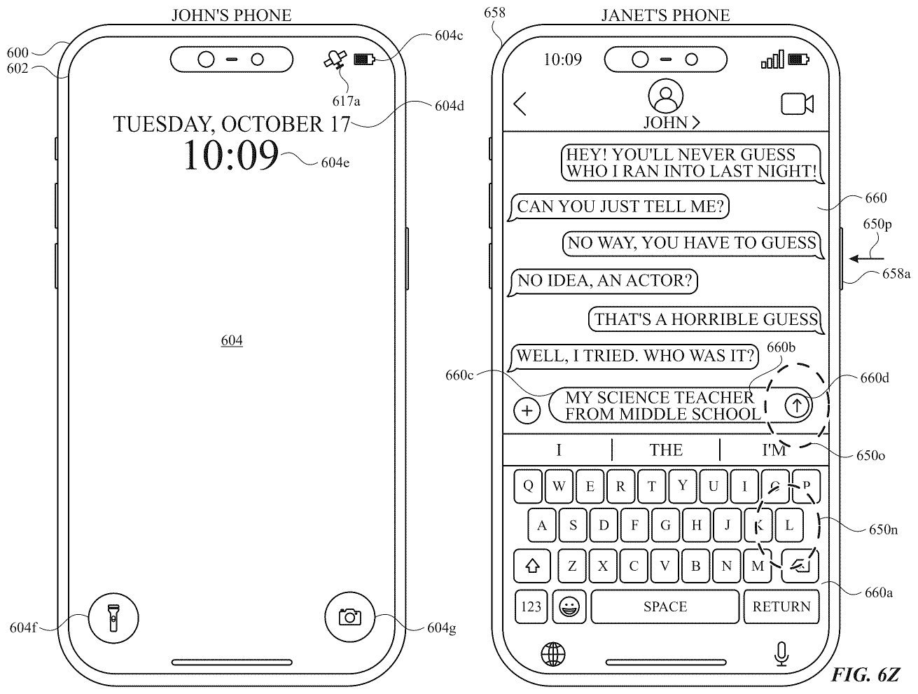

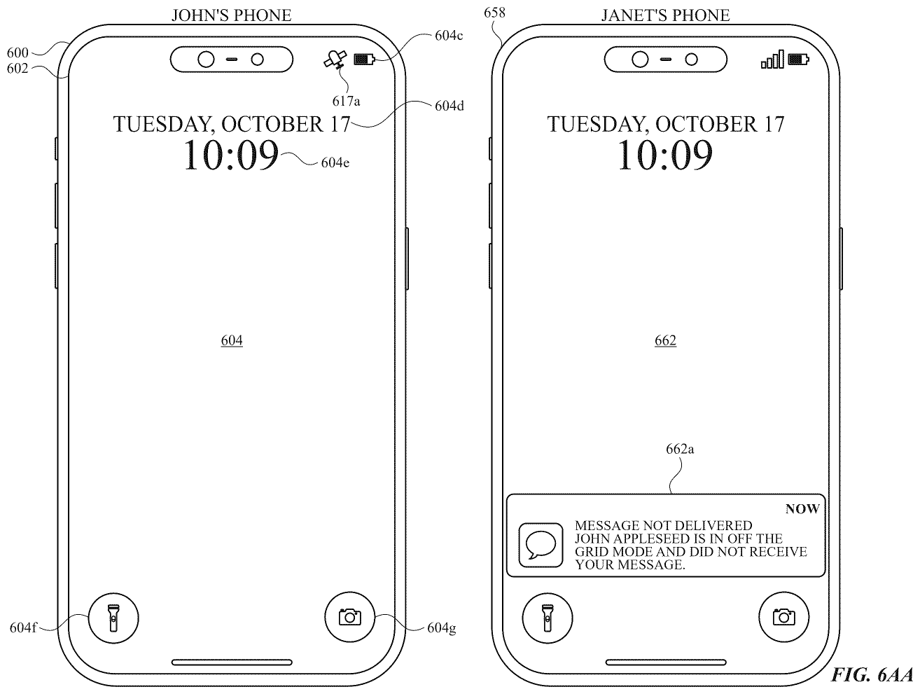

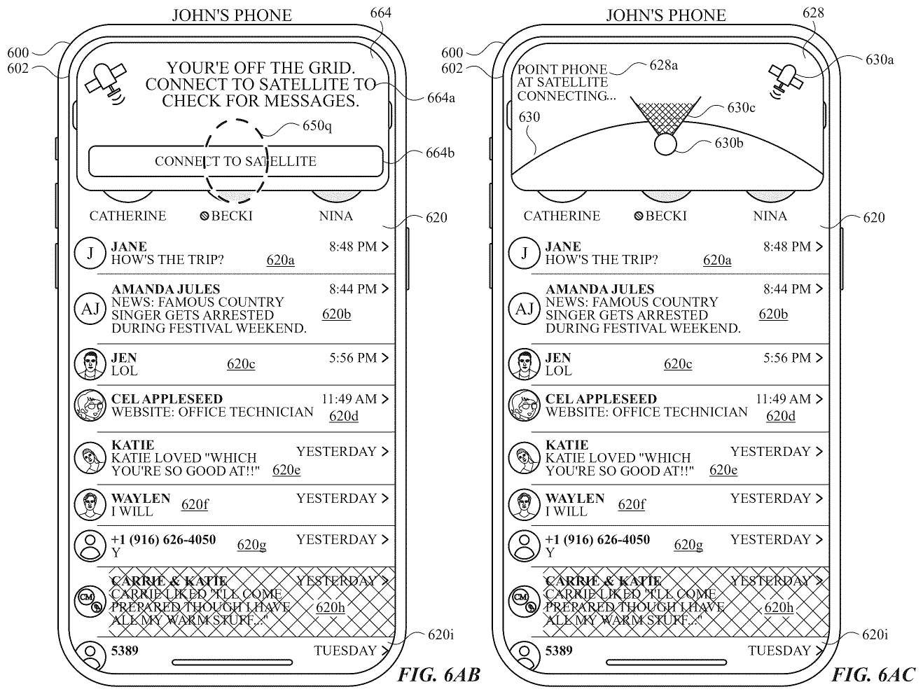

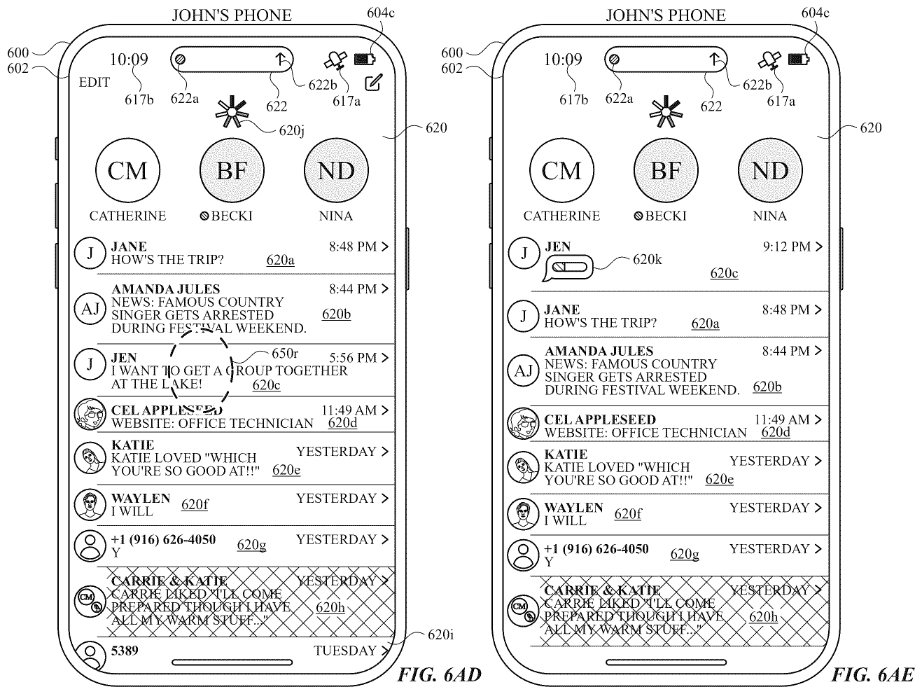

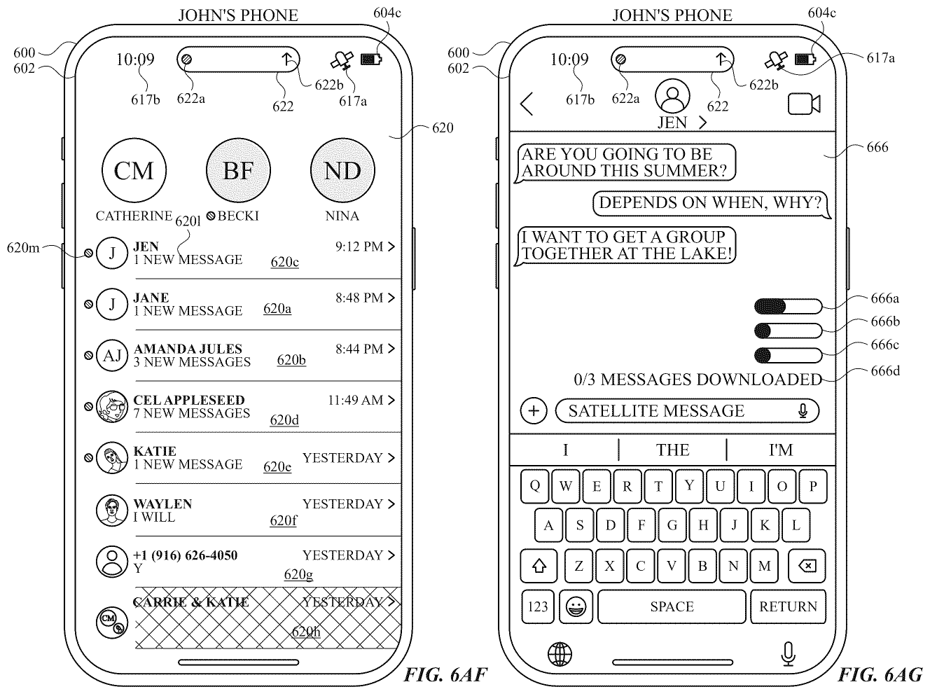

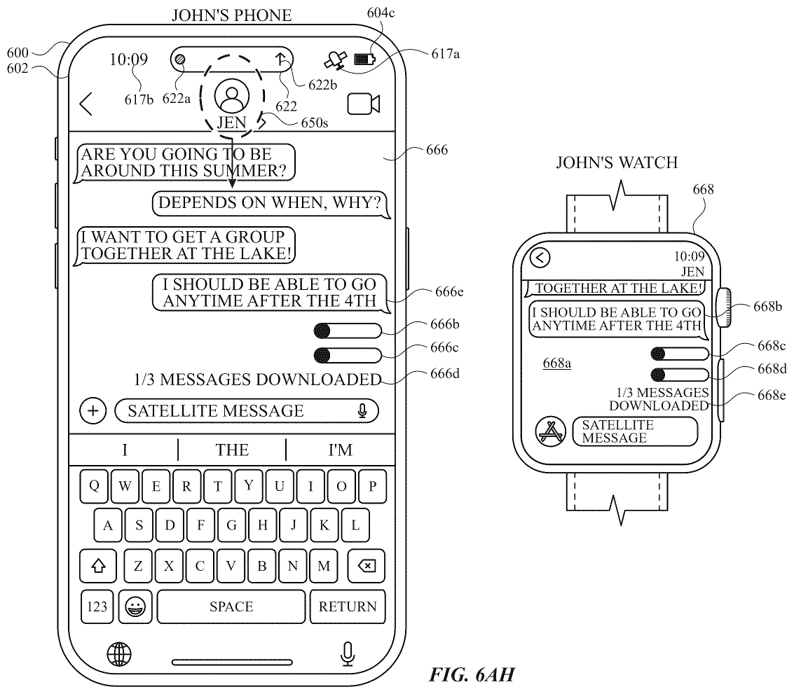

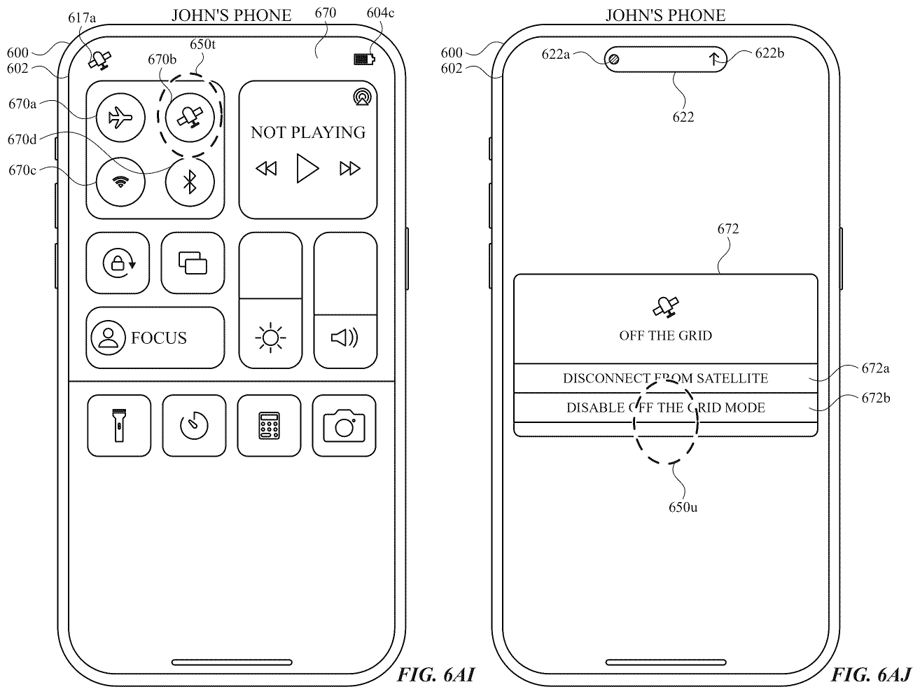

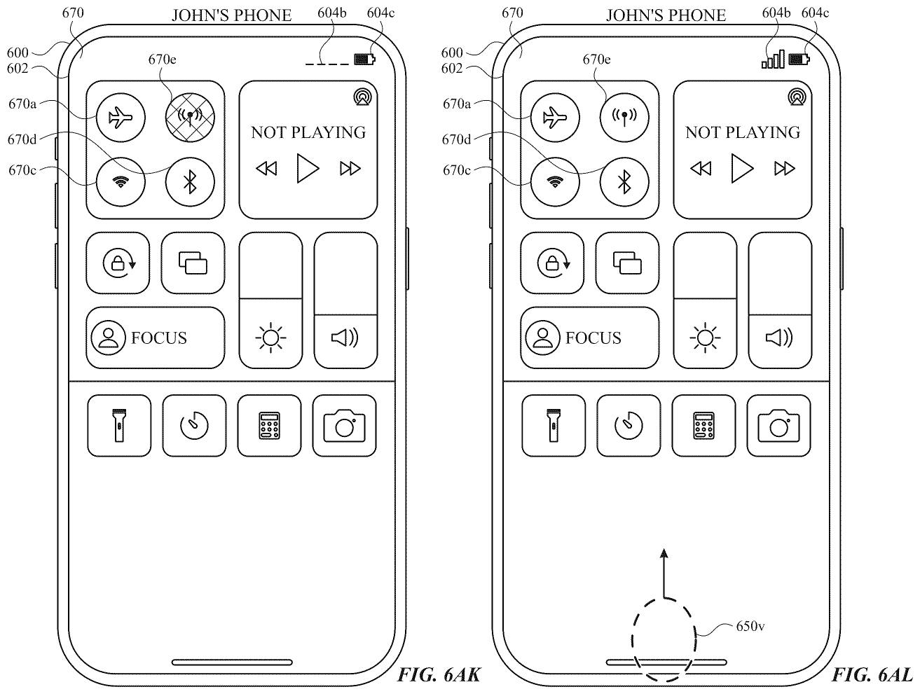

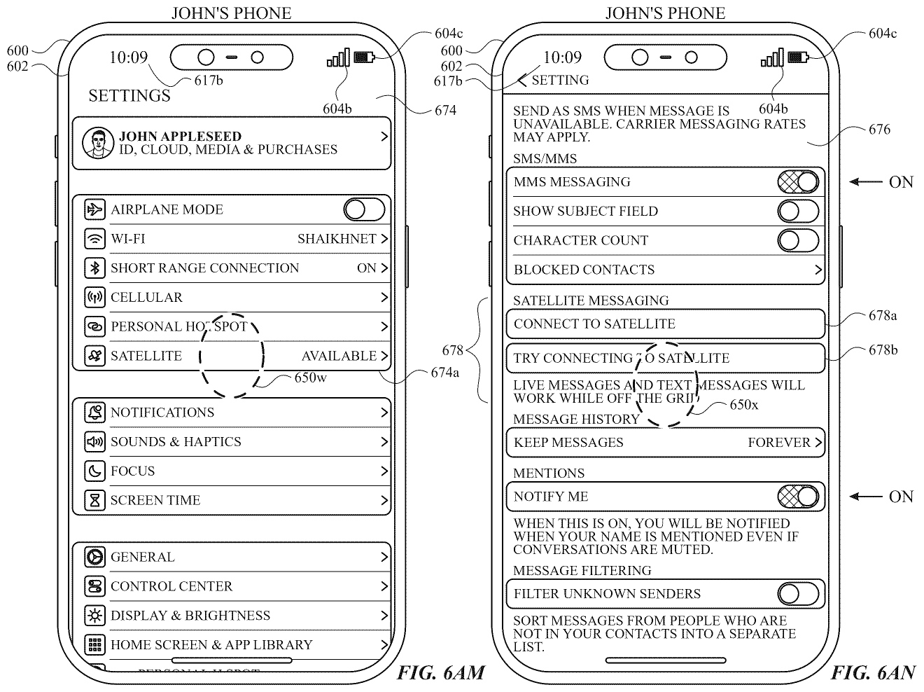

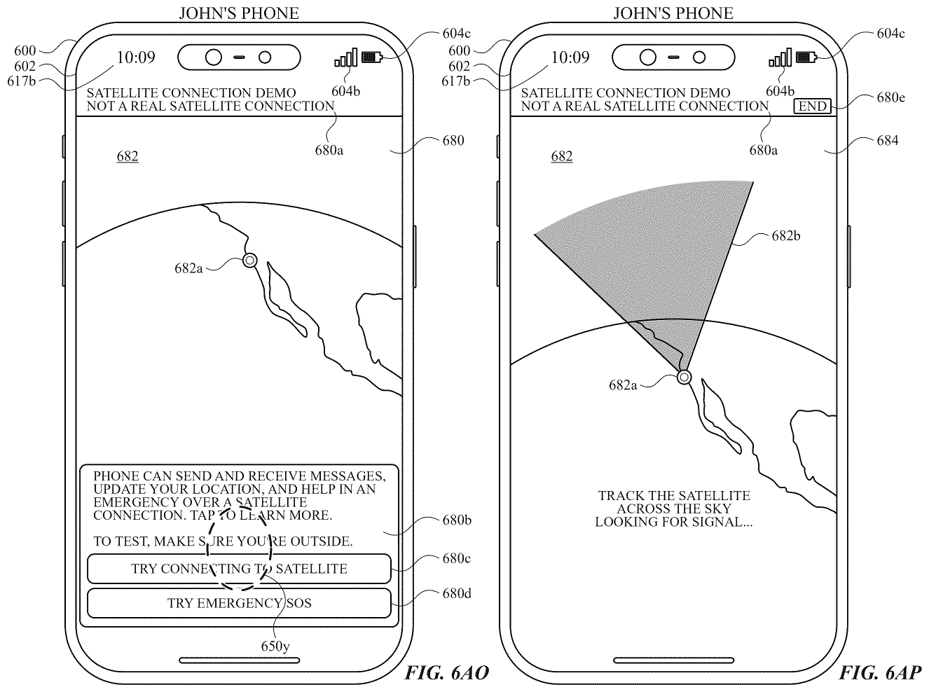

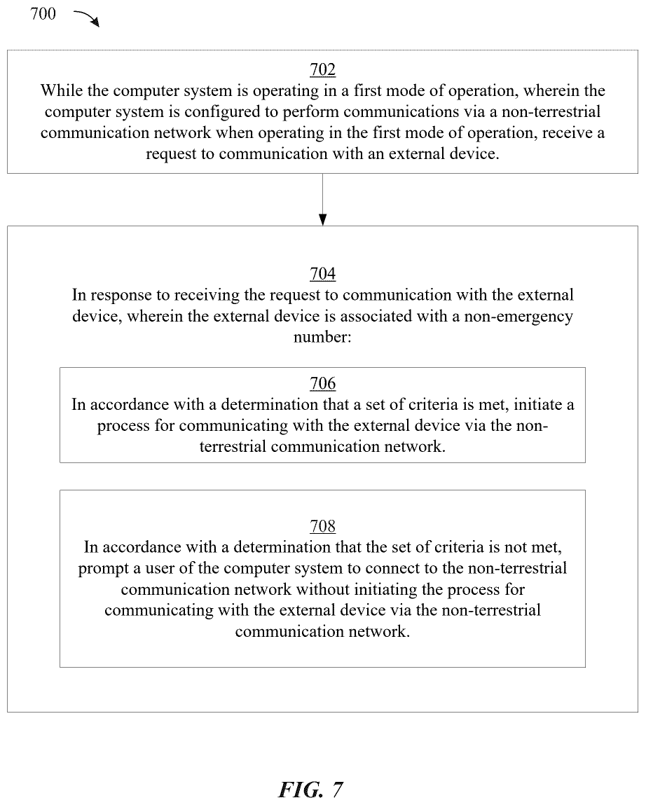

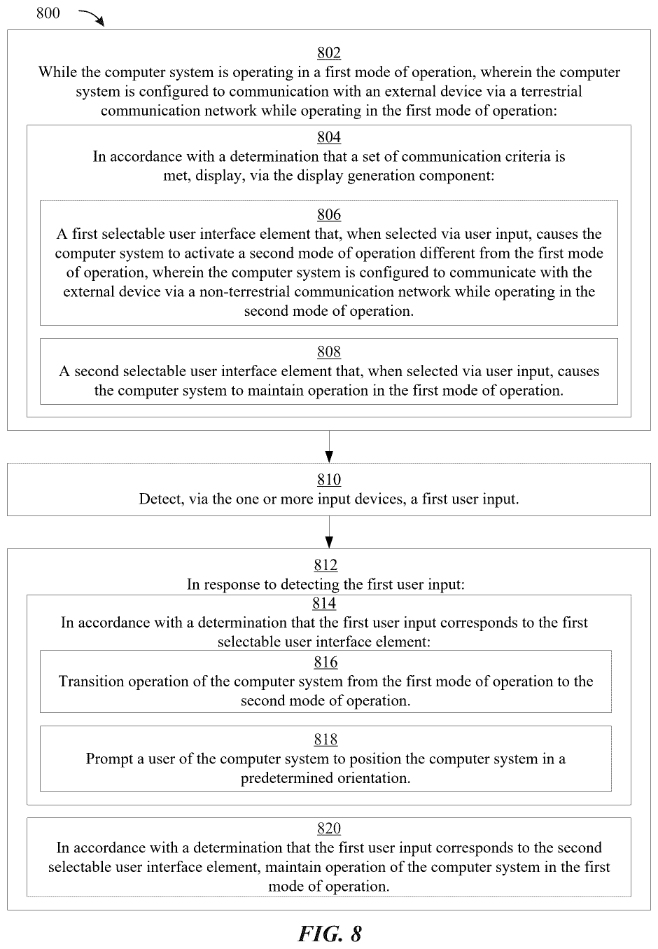

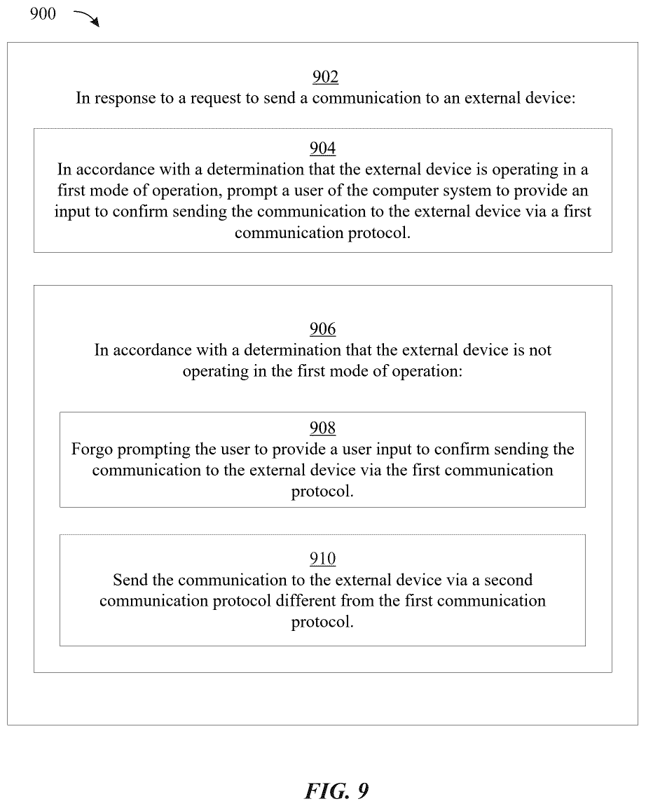

Below, FIGS. 1A-1B, 2, 3A-3G, 4A-4B, and 5A-5B provide a description of exemplary devices for performing the techniques for managing event notifications. FIGS. 6A-6AP illustrate exemplary user interfaces for managing communications. FIG. 7 is a flow diagram illustrating methods of initiating communications via a non-terrestrial network in accordance with some embodiments. FIG. 8 is a flow diagram illustrating methods of transitioning between operating modes in accordance with some embodiments. FIG. 9 is a flow diagram illustrating methods of initiating communications in accordance with some embodiments. The user interfaces in FIGS. 6A-6AP are used to illustrate the processes described below, including the processes in FIGS. 7-9.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently. Reducing the number of inputs needed to perform an operation and providing clear feedback to the user enable the user to use the device more quickly and efficiently, which is particularly important in situations where terrestrial communication networks are not available for several reasons. Using a device efficiently conserves battery life, which is important in situations where terrestrial communication networks are not available because some communication features use satellite communications that can use significant energy (e.g., more energy than cellular communications) and because opportunities to recharge the device may be limited (e.g., because a user is in a remote location where a power source is not available).

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device or component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display system 112 is sometimes called a “touch screen” or “touch screen display” for convenience and is sometimes known as or called a “touch-sensitive display.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

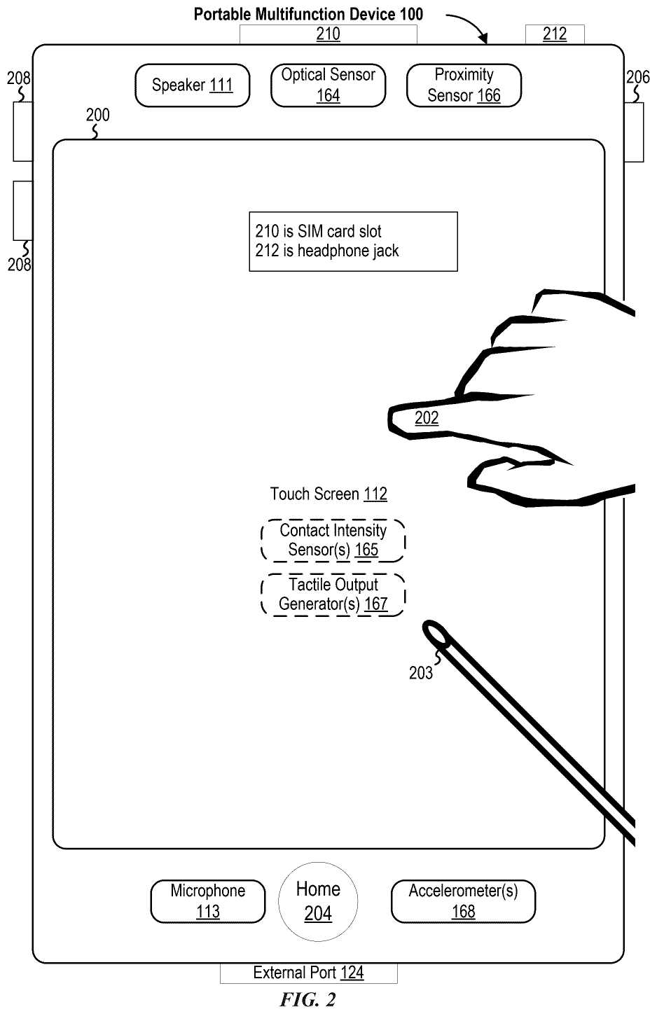

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes secure element 163 for securely storing information. In some embodiments, secure element 163 is a hardware component (e.g., a secure microcontroller chip) configured to securely store data or an algorithm. In some embodiments, secure element 163 provides (e.g., releases) secure information (e.g., payment information (e.g., an account number and/or a transaction-specific dynamic security code), identification information (e.g., credentials of a state-approved digital identification), and/or authentication information (e.g., data generated using a cryptography engine and/or by performing asymmetric cryptography operations)). In some embodiments, secure element 163 provides (or releases) the secure information in response to device 100 receiving authorization, such as a user authentication (e.g., fingerprint authentication; passcode authentication; detecting double-press of a hardware button when device 100 is in an unlocked state, and optionally, while device 100 has been continuously on a user's wrist since device 100 was unlocked by providing authentication credentials to device 100, where the continuous presence of device 100 on the user's wrist is determined by periodically checking that the device is in contact with the user's skin). For example, device 100 detects a fingerprint at a fingerprint sensor (e.g., a fingerprint sensor integrated into a button) of device 100. Device 100 determines whether the detected fingerprint is consistent with an enrolled fingerprint. In accordance with a determination that the fingerprint is consistent with the enrolled fingerprint, secure element 163 provides (e.g., releases) the secure information. In accordance with a determination that the fingerprint is not consistent with the enrolled fingerprint, secure element 163 forgoes providing (e.g., releasing) the secure information.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

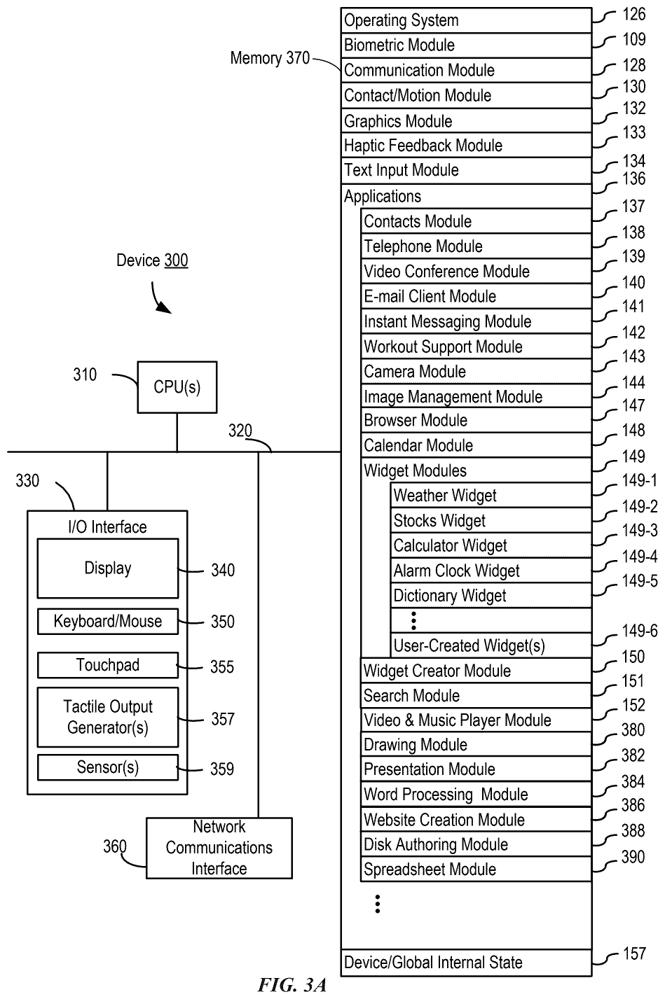

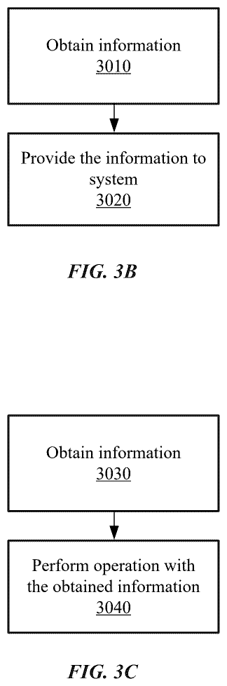

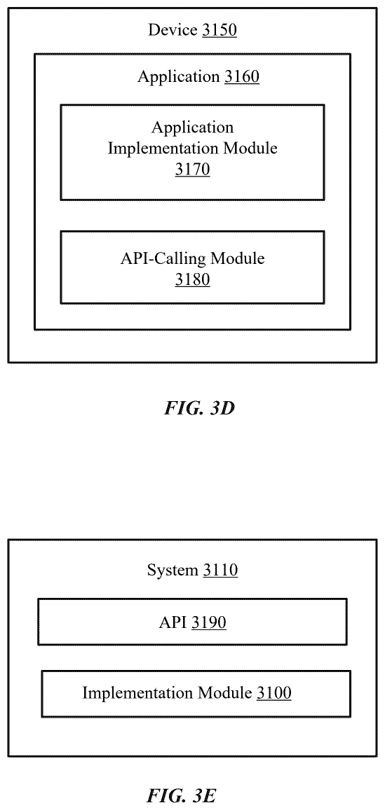

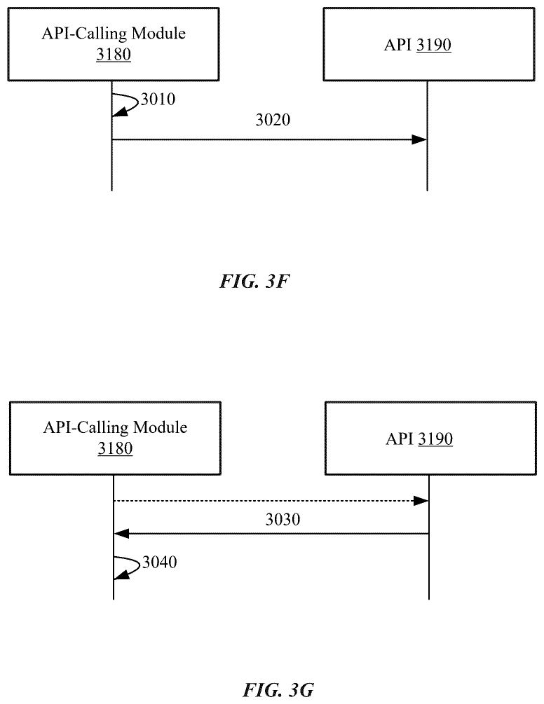

In some embodiments, the software components stored in memory 102 include operating system 126, biometric module 109, communication module (or set of instructions) 128, contact/motion module (or set of instructions) 130, graphics module (or set of instructions) 132, text input module (or set of instructions) 134, Global Positioning System (GPS) module (or set of instructions) 135, authentication module 105, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Biometric module 109 optionally stores information about one or more enrolled biometric features (e.g., fingerprint feature information, facial recognition feature information, eye and/or iris feature information) for use to verify whether received biometric information matches the enrolled biometric features. In some embodiments, the information stored about the one or more enrolled biometric features includes data that enables the comparison between the stored information and received biometric information without including enough information to reproduce the enrolled biometric features. In some embodiments, biometric module 109 stores the information about the enrolled biometric features in association with a user account of device 100. In some embodiments, biometric module 109 compares the received biometric information to an enrolled biometric feature to determine whether the received biometric information matches the enrolled biometric feature.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Authentication module 105 determines whether a requested operation (e.g., requested by an application of applications 136) is authorized to be performed. In some embodiments, authentication module 105 receives for an operation to be perform that optionally requires authentication. Authentication module 105 determines whether the operation is authorized to be performed, such as based on a series of factors, including the lock status of device 100, the location of device 100, whether a security delay has elapsed, whether received biometric information matches enrolled biometric features, and/or other factors. Once authentication module 105 determines that the operation is authorized to be performed, authentication module 105 triggers performance of the operation.

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform methods 700, 800, and/or 900 (FIGS. 7, 8, and/or 9) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

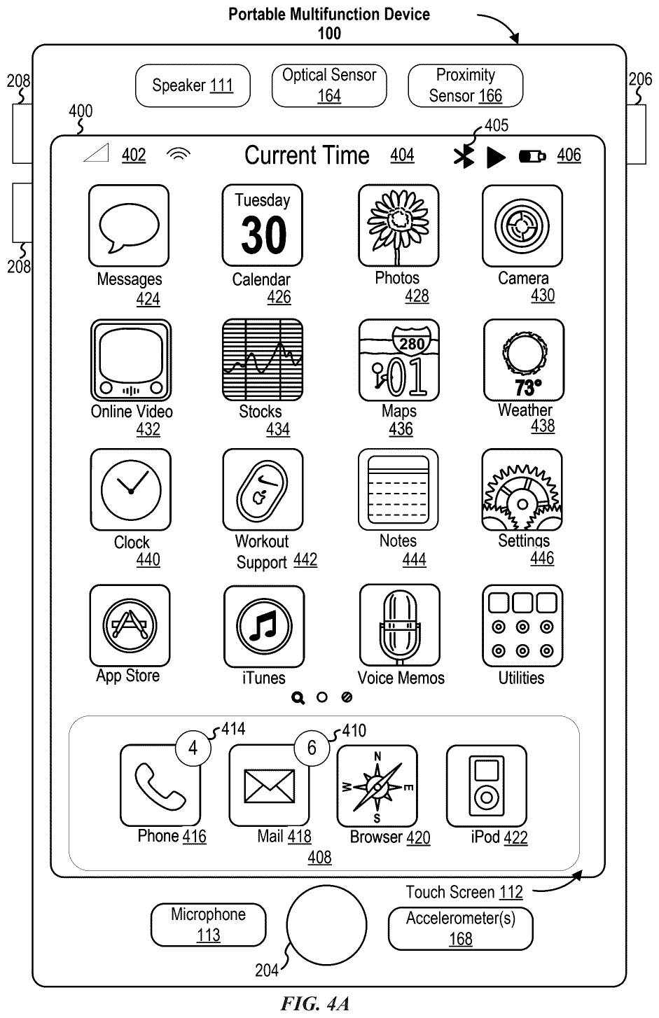

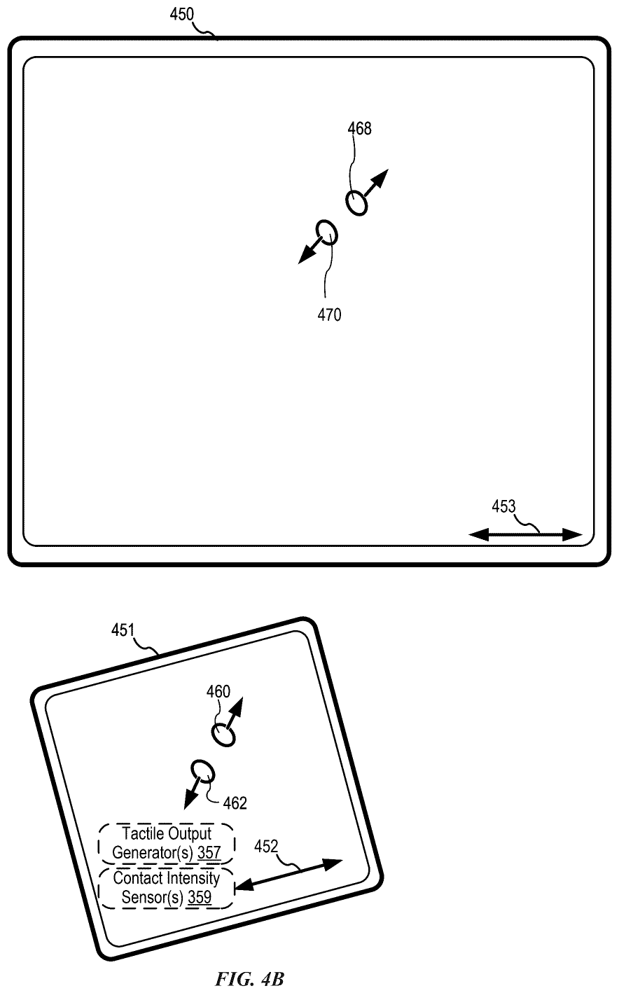

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

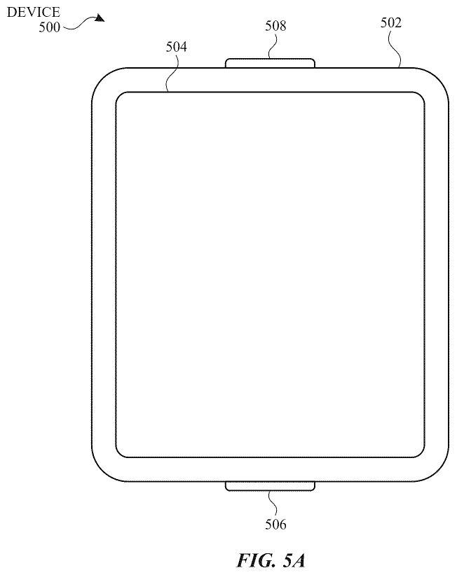

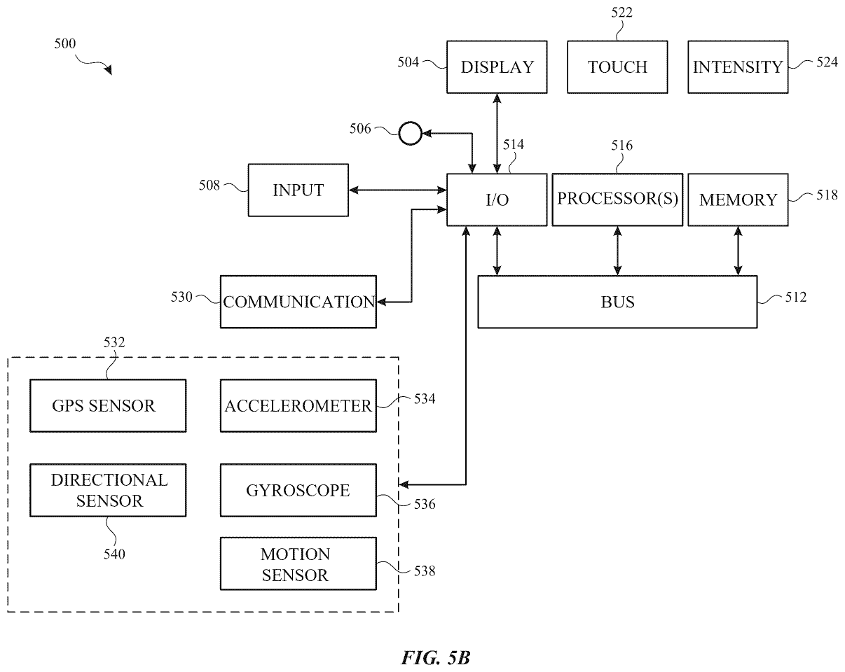

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A. Device 500 has bus 512 that operatively couples I/O section 514 with one or more computer processors 516 and memory 518. I/O section 514 can be connected to display screen 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700, 800, and 900 (FIGS. 7-9). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments, the computer system is in a locked state or an unlocked state. In the locked state, the computer system is powered on and operational but is prevented from performing a predefined set of operations in response to user input. The predefined set of operations optionally includes navigation between user interfaces, activation or deactivation of a predefined set of functions, and activation or deactivation of certain applications. The locked state can be used to prevent unintentional or unauthorized use of some functionality of the computer system or activation or deactivation of some functions on the computer system. In some embodiments, in the unlocked state, the computer system is powered on and operational and is not prevented from performing at least a portion of the predefined set of operations that cannot be performed while in the locked state. When the computer system is in the locked state, the computer system is said to be locked. When the computer system is in the unlocked state, the computer is said to be unlocked. In some embodiments, the computer system in the locked state optionally responds to a limited set of user inputs, including input that corresponds to an attempt to transition the computer system to the unlocked state or input that corresponds to powering the computer system off.

Attention is now directed towards embodiments of user interfaces (“UI”) and associated processes that are implemented on an electronic device, such as portable multifunction device 100, device 300, or device 500.

FIGS. 6A-6AP illustrate exemplary user interfaces for managing communications, in accordance with some embodiments. The user interfaces in these figures are used to illustrate the processes described below, including the processes in FIGS. 7-9.

FIG. 6A illustrates computer system 600 displaying, via display 602, lock screen user interface 604. At FIG. 6A, lock screen user interface includes first connection indicator 604a, second connection indicator 604b, battery indicator 604c, date indicator 604d, time indicator 604e, flashlight user interface object 604f, and camera user interface object 604g. First connection indicator 604a provides a visual indication that computer system 600 is connected to and/or otherwise in communication with a WiFi communication network (e.g., a first terrestrial communication network). Second connection indicator 604b indicates that computer system 600 is connected to and/or otherwise in communication with a cellular network (e.g., a second terrestrial communication network).

In some embodiments, the size and/or appearance of first connection indicator 604a and/or second connection indicator 604b indicate a strength of a connection between computer system 600 and the respective communication network. For instance, in some embodiments, when computer system 600 has a relatively strong connection to the WiFi network, first connection indicator 604a includes a first number of waves and/or symbols (e.g., displayed and/or filled in waves and/or symbols). In some embodiments, when computer system 600 has a relatively weak connection to the WiFi network, first connection indicator 604a includes a second number of waves and/or symbols that is less than the first number of waves and/or symbols. Similarly, in some embodiments, when computer system 600 has a relatively strong connection to the cellular network, second connection indicator 604b includes a first number of bars and/or symbols (e.g., displayed and/or filled in bars and/or symbols). In some embodiments, when computer system 600 has a relatively weak connection to the cellular network, second connection indicator 604b includes a second number of bars and/or symbols that is less than the first number of bars and/or symbols.

At FIG. 6B, computer system 600 is disconnected from, not connected to, and/or is not receiving a signal from the WiFi network and the cellular network. For example, first connection indicator 604a is not displayed on lock screen user interface 604 indicating that computer system 600 is not connected to the WiFi network. At FIG. 6B, second connection indicator 604b is displayed on lock screen user interface 604 as four dashed lines indicating that computer system 600 is not receiving a signal from and/or is otherwise disconnected from the cellular network.

At FIG. 6B, computer system 600 displays notification 606 on lock screen user interface 604 based at least in part on computer system 600 being disconnected from, not connected to, and/or not receiving a signal from the WiFi network and the cellular network. In some embodiments, computer system 600 displays notification 606 when a set of criteria is met. In some embodiments, the set of criteria includes a first criterion that is met when computer system 600 is not connected to a WiFi network, a second criterion that is met when computer system 600 is not connected to and/or receiving a signal from a cellular network, and/or a third criterion that is met when computer system 600 is receiving a signal from Global Positioning System (“GPS”).

At FIG. 6B, notification 606 provides an option for a user to transition computer system 600 between a first mode of operation and a second mode of operation. In some embodiments, the first mode of operation includes a default and/or normal mode of operation in which computer system 600 initiates communications, such as phone calls, text messages, emails, and/or data communications, via one or more terrestrial communication networks (e.g., a WiFi communication network and/or a cellular communication network). In some embodiments, the second mode of operation is an operating mode in which computer system 600 is configured to initiate communications via a non-terrestrial communication network, such as a satellite communication network. At FIG. 6B, notification 606 includes information region 606a, dismiss user interface object 606b, and activation user interface object 606c. Information region 606a includes text and/or graphical user interface objects indicating that computer system 600 cannot connect to a WiFi and/or a cellular communication network, but that computer system 600 can initiate communications via a non-terrestrial communication network upon activating the second mode of operation.

At FIG. 6B, computer system 600 detects user input 650a corresponding to selection of dismiss user interface object 606b. In response to detecting user input 650a, computer system 600 dismisses and/or stops displaying notification 606 without transitioning operation of computer system 600 from the first mode of operation to the second mode of operation. In some embodiments, after detecting user input 650a and dismissing notification 606 in response to detecting user input 650a, computer system 600 determines that the set of criteria is satisfied a second time (e.g., the set of criteria is satisfied again after a predetermined amount of time has passed since detecting user input 650a). In some embodiments, in response to detecting that the set of criteria is satisfied a second time, computer system 600 displays (e.g., re-displays) notification 606.

Additionally or alternatively to detecting user input 650a, computer system 600 detects user input 650b corresponding to activation user interface object 606c. In response to detecting user input 650b, computer system 600 displays activation user interface 608, as shown at FIG. 6C.

At FIG. 6C, activation user interface 608 includes initiation user interface object 608a and functions region 610. As set forth below, in response to detecting user input (e.g., user input 650d) corresponding to selection of initiation user interface object 608a, computer system 600 transitions from operating in the first mode of operation to operating in the second mode of operation. In some embodiments, computer system 600 is unable to perform certain functions when computer system 600 is not connected to a WiFi network and is not receiving a signal from and/or is otherwise disconnected from the cellular network. At FIG. 6C, functions region 610 includes information and/or user interface objects related to the different functions that computer system 600 is configured to perform while operating in the second mode of operation. At FIG. 6C, function region 610 includes first function option 610a and second function option 610b, which correspond to respective functions that computer system 600 is configured to perform while operating in the second mode of operation. For example, first function option 610a corresponds to a messaging function (e.g., for sending and/or receiving text messages) and second function option 610b corresponds to a location function (e.g., for locating computer system 600 and/or other computer systems associated with a same user or account associated with computer system 600). In some embodiments, functions region 610 includes additional functions options. At FIG. 6C, computer system 600 detects user input 650c on activation user interface 608. In response to detecting user input 650c, computer system 600 displays more of activation user interface 608, where functions region 610 of activation user interface 608 includes third function option 610c and fourth function option 610d, as shown at FIG. 6D.

At FIG. 6D, third function option 610c corresponds to a roadside assistance function (e.g., for contacting and/or communicating with a roadside assistance provider) and fourth function option 610d corresponds to an emergency assistance function (e.g., for contacting and/or communicating with an emergency services provider). In some embodiments, in response to detecting user input corresponding to one of function options 610a-610d, computer system 600 initiates the second mode of operation and/or launches an application associated with the respective function. Activation user interface 608 provides the user of computer system 600 with additional information about the functions available while computer system 600 operates in the second mode of operation.

At FIG. 6D, computer system 600 detects user input 650d corresponding to selection of initiation user interface object 608a. In response to detecting user input 650d, computer system 600 initiates a process for activating the second mode of operation and displays connection user interface 612, as shown at FIG. 6E.

At FIG. 6E, connection user interface 612 provides assistance and/or guidance to a user of computer system 600 for connecting to a satellite of a non-terrestrial communication network. As set forth above, the second mode of operation of computer system 600 enables computer system 600 to initiate communications via a non-terrestrial communication network. At FIG. 6E, the non-terrestrial communication network includes a satellite communication network. In some embodiments, computer system 600 is configured to connect to a satellite of the satellite communication network when computer system 600 is positioned at a particular orientation relative to the satellite. For instance, in some embodiments, computer system 600 includes and/or is in communication with one or more antennae that enable computer system 600 to send and/or receive information to and/or from the satellite. In some embodiments, the one or more antennae enable computer system 600 to initiate communications via the satellite communication network when aligned at a particular azimuth and/or elevation. As used herein, azimuth is a direction and/or rotation of computer system 600 relative to a reference point, such as the ground and/or the satellite. As used herein, elevation is a pitch and/or angle at which computer system 600 is facing relative to the reference point (e.g., pointing up or pointing down).

At FIG. 6E, connection user interface 612 provides guidance to a user of computer system 600 for positioning computer system 600 at an orientation that enables computer system 600 to establish a connection with a satellite of the satellite communication network. Connection user interface 612 includes map representation 614 and prompt 612a. Map representation 614 includes satellite representation 614a, computer system representation 614b, and alignment element 614c. Satellite representation 614a includes an indication of a location of a satellite of the satellite communication network (e.g., relative to a location of computer system 600 and/or a geographic reference point). Computer system representation 614b includes an indication of a location of computer system 600 relative to a geographical map, as represented by map representation 614. Alignment element 614c includes an indication of an area and/or zone in which computer system 600 is configured to connect to a satellite. For instance, computer system 600 is configured to connect to a satellite of the satellite communication network when computer system 600 is positioned at an orientation that causes satellite representation 614a to be displayed within alignment element 614c. In some embodiments, computer system 600 updates, changes, and/or modifies respective positions of satellite representation 614a, computer system representation 614b, and/or alignment element 614c displayed on connection user interface 612 based on changes in an orientation of computer system 600.

At FIG. 6E, satellite representation 614a is displayed outside of alignment element 614c, such that computer system 600 cannot connect to the satellite of the satellite communication network. Prompt 612a includes a textual indication and/or guidance to a user of computer system 600 to position computer system 600 at an orientation that causes satellite representation 614a to be displayed within alignment element 614c. In some embodiments, prompt 612a includes text and/or symbols (e.g., arrows and/or other graphics) prompting the user of computer system 600 to move computer system 600 to the left in order to align computer system 600 with the satellite of the satellite communication network. As the user moves computer system 600, computer system 600 updates display of connection user interface 612 so that the relative positions of satellite representation 614a, computer system representation 614b, and/or alignment element 614c represent the movement and/or current state of computer system 600.

At FIG. 6F, computer system 600 determines and/or detects a change in orientation of computer system 600 relative to the orientation of computer system 600 at FIG. 6E. In some embodiments, computer system 600 determines and/or detects a change in orientation based on a change in position of one or more antennae of computer system 600 that enable computer system 600 to connect to a satellite of the satellite communication network. In some embodiments, computer system 600 determines and/or detects a change in orientation based on receiving information that computer system 600 has moved (e.g., information received from an accelerometer and/or gyroscope). In response to determining and/or detecting the change in orientation of computer system 600, computer system 600 updates display of connection user interface 612, as shown at FIG. 6F. At FIG. 6F, satellite representation 614a is displayed within alignment element 614c indicating that computer system 600 is configured to initiate a connection with a satellite of the satellite communication network. Prompt 612a includes text prompting the user of computer system 600 to maintain the orientation of computer system 600 so that computer system 600 can establish the connection with the satellite. In some embodiments, computer system 600 initiates establishing the connection with the satellite by sending one or more communication signals to the satellite and/or receiving one or more communication signals from the satellite.

At FIG. 6G, computer system 600 has established the connection with the satellite. Based on determining that the connection with the satellite is established, computer system 600 updates connection user interface 612. At FIG. 6G, connection user interface 612 includes signal indicator 614d (e.g., hatching within alignment element 614c) indicating that the connection between computer system 600 and the satellite has been established and/or initiated. In some embodiments, computer system 600 animates signal indicator 614d so that display of signal indicator 614d moves over time, as indicated by arrows 616. In some embodiments, animating signal indicator 614d includes changing a color of a respective portion of alignment element 614c over time so that the respective portion of alignment element 614c changes in size over time. In some embodiments, animating signal indicator 614d includes displaying signal indicator 614d moving between satellite representation 614a and computer system representation 614b within alignment element 614c over time.

Based on a determination that computer system 600 has established the connection with the satellite, computer system 600 displays third connection indicator 617a to provide visual confirmation that the connection with the satellite has been established. At FIG. 6G, third connection indicator 617a includes an image, icon, symbol, and/or graphical representation of a satellite to indicate to the user of computer system 600 that computer system 600 is connected to the satellite communication network. Computer system 600 also displays battery indicator 604b indicating a current and/or estimated amount of remaining battery power of a battery of computer system 600. Computer system 600 further displays time indicator 617b indicating a current time of day.

At FIG. 6G, after computer system 600 establishes the connection with the satellite, computer system 600 displays function user interface objects 618a-618d, which correspond to functions options 610a-610b described above with reference to FIGS. 6C and 6D. Function user interface objects 618a-618d are selectable user interface objects that, when selected via user input, cause computer system 600 to initiate a function corresponding to the selected function user interface object. Therefore, after computer system 600 establishes the connection with the satellite, computer system 600 displays function user interface objects 618a-618d so that a user can quickly perform a desired function without having to provide additional user input to navigate to another user interface.

At FIG. 6G, function user interface object 618a corresponds to a messaging function, where computer system 600 is configured to send and/or receive message communications from one or more external devices via the satellite communication network. Function user interface object 618b corresponds to a location function, where computer system 600 is configured to provide location information of computer system 600 to one or more external devices via the satellite communication network. Function user interface object 618c corresponds to a roadside assistance function, which enables computer system 600 to initiate a process for communicating with a roadside assistance entity and/or service via the satellite communication network. Function user interface object 618d corresponds to an emergency function, which enables computer system 600 to initiate a process for communicating with an emergency entity and/or service via the satellite communication network.

At FIG. 6G, computer system 600 detects user input 650e corresponding to selection of function user interface object 618a corresponding to the messaging function. In response to detecting user input 650e, computer system 600 displays messaging user interface 620, as shown at FIG. 6H.

At FIG. 6H, messaging user interface 620 enables the user of computer system 600 to send and/or receive message communications via computer system 600, which is connected to the satellite communication network. As shown at FIG. 6H, computer system 600 displays connection indicator 622 at first region 624 of display 602. In some embodiments, first region 624 of display 602 includes a region that is designated for displaying information about ongoing and/or active operations being performed by computer system 600. In some embodiments, first region 624 of display 602 includes a portion of display 602 between time indicator 617b and third connection indicator 617a. In some embodiments, computer system 600 adjusts and/or modifies a size of first region 624 and/or content displayed within first region 624 based on context. For example, in some embodiments, computer system 600 enlarges first region 624 and/or content displayed within first region 624 to display additional information in response to user input corresponding to selection of first region 624 and/or content displayed within first region 624. In some embodiments, computer system 600 enlarges first region 624 and/or content displayed within first region 624 to display additional information based on a determination that a signal strength between computer system 600 and the satellite of the satellite communication network has fallen below a signal strength threshold and/or based on a determination that communication between computer system 600 and the satellite is disconnected.

At FIG. 6H, connection indicator 622 includes signal indicator 622a and orientation indicator 622b. Signal indicator 622a indicates a signal strength between computer system 600 and the satellite of the satellite communication network. At FIG. 6H, signal indicator 622a includes a first appearance, as indicated by first hatching at FIG. 6H. As set forth below, computer system 600 updates and/or changes an appearance of signal indicator 622a based on a determination that the signal strength between computer system 600 and the satellite falls below one or more signal strength threshold values. Orientation indicator 622b provides visual guidance about an orientation of computer system 600 that allows computer system 600 to maintain, establish, and/or reestablish a connection with a satellite of the satellite communication network that includes a signal strength above a signal strength threshold. At FIG. 6H, orientation indicator 622b includes an arrow pointing upward (e.g., relative to a display orientation of display 602) indicating that the user of computer system 600 should maintain a current position and/or orientation of computer system 600. As set forth below, computer system 600 updates and/or adjusts an appearance of orientation indicator 622b based on a determination that a satellite of the satellite communication network has moved relative to the orientation of computer system 600 and/or based on a signal strength between computer system 600 and the satellite of the satellite communication network. Orientation indicator 622 therefore provides guidance to the user of computer system 600 to maintain or update the orientation of computer system 600 so that the connection between computer system 600 and the satellite communication network is maintained and/or is maintained above a signal strength threshold.

While FIGS. 6A-6H describe that computer system 600 can transition from the first mode of operation to the second mode of operation based on detecting user input 650b corresponding to notification 606 displayed on lock screen user interface 604, computer system 600 is also configured to transition to the second mode of operation while displaying other user interfaces. For example, computer system 600 can initiate a connection and/or initiate establishing a connection with the satellite communication network while displaying a user interface that is different from lock screen user interface 604, as described above with reference to FIGS. 6A-6H. For instance, at FIG. 6I, computer system 600 displays messaging user interface 620 while computer system 600 is connected to one or more terrestrial communication networks. At FIG. 6I, computer system 600 displays first connection indicator 604a and second connection indicator 604b. First connection indicator 604a provides a visual indication that computer system 600 is connected to and/or otherwise in communication with a WiFi communication network (e.g., a first terrestrial communication network). Second connection indicator 604b indicates that computer system 600 is connected to and/or otherwise in communication with a cellular network (e.g., a second terrestrial communication network).

At FIG. 6I, while computer system 600 displays messaging user interface 620 and while computer system 600 is connected to the WiFi communication network and/or the cellular communication network, computer system 600 is configured to send and/or receive message communications between computer system 600 and one or more external devices via at least one of the WiFi communication network and/or the cellular communication network. In some embodiments, computer system 600 is configured to send and/or receive group message communications while connected to the WiFi communication network and/or the cellular communication network. For instance, in some embodiments, computer system 600 can send a message communication (e.g., a single message communication) to multiple different external devices and/or accounts while connected to the WiFi communication network and/or the cellular communication network. As shown at FIG. 6I, message user interface object 620h corresponding to a group message conversation includes the same appearance as message user interface objects 620a-620g and 620i, which do not correspond to group message conversations. As such, computer system 600 provides a visual indication of which types of message communications are available while computer system 600 is operating in a respective mode of operation. As set forth below, in some embodiments, computer system 600 is not configured and/or not able to send group communications when connected to a non-terrestrial communication network, such as the satellite communication network.

At FIG. 6J, computer system 600 is disconnected from, not connected to, and/or is not receiving a signal from the WiFi network and the cellular network. For example, first connection indicator 604a is not displayed on messaging user interface 620 indicating that computer system 600 is not connected to the WiFi network. At FIG. 6J, second connection indicator 604b is displayed on messaging user interface 620 as four dashed lines indicating that computer system 600 is not receiving a signal from and/or is otherwise disconnected from the cellular network. Based on a determination that computer system 600 is not connected to the WiFi communication network and the cellular communication network (and, optionally, based on a determination that computer system 600 is displaying messaging user interface 620), computer system 600 displays connection user interface object 626, as shown at FIG. 6K.

At FIG. 6K, connection user interface object 626 is overlaid on messaging user interface 620 at first region 624 of display 602 but is displayed at a size that is larger than the size of connection indicator 622. The larger size of connection user interface object 626 provides improved feedback to the user of computer system 600 that computer system 600 is not connected to the WiFi communication network and the cellular communication network. The larger size of connection user interface object 626 further allows computer system 600 to display additional information and/or prompts to the user so that the user can perform one or more actions to cause computer system 600 to connect to a non-terrestrial communication network.

At FIG. 6K, connection user interface object 626 includes information region 626a, activation user interface object 626b, and dismiss user interface object 626c. Information region 626a includes text and/or graphical user interface objects indicating that computer system 600 cannot connect to a WiFi and/or cellular communication network, but that computer system 600 can initiate communications via a non-terrestrial communication network upon activating the second mode of operation.

At FIG. 6K, computer system 600 detects user input 650f corresponding to selection of activation user interface object 626b. In response to detecting user input 650f, computer system 600 initiates a process for activating the second mode of operation and displays connection user interface object 628, as shown at FIG. 6L.

At FIG. 6L, connection user interface object 628 provides assistance to a user of computer system 600 for connecting to a satellite of a non-terrestrial communication network. As set forth above, the second mode of operation of computer system 600 includes computer system 600 initiating communications via a non-terrestrial communication network. As set forth above, the non-terrestrial communication network includes a satellite communication network.

At FIG. 6L, connection user interface object 628 provides guidance to a user of computer system 600 for positioning computer system 600 at an orientation that enables computer system 600 to establish a connection with a satellite of the satellite communication network. Connection user interface object 628 includes map representation 630 and prompt 628a. Map representation 630 includes satellite representation 630a, computer system representation 630b, and alignment element 630c. Satellite representation 630a includes an indication of a location of a satellite of the satellite communication network. Computer system representation 630b includes an indication of a location of computer system 600 relative to a geographical map, as indicated by map representation 630. Alignment element 630c includes an indication of an area and/or zone in which computer system 600 is configured to connect to a satellite. For instance, computer system 600 is configured to connect to a satellite of the satellite communication network when computer system 600 is positioned at an orientation that causes satellite representation 630a to be displayed within alignment element 630c. In some embodiments, computer system 600 updates, changes, and/or modifies respective positions of satellite representation 630a, computer system representation 630b, and/or alignment element 630c displayed on connection user interface object 628 based on changes in an orientation of computer system 600.

At FIG. 6L, satellite representation 630a is displayed outside of alignment element 630c, such that computer system 600 cannot connect to the satellite of the satellite communication network. Prompt 628a includes a textual indication and/or guidance to a user of computer system 600 to position computer system 600 at an orientation that causes satellite representation 630a to be displayed within alignment element 630c. For instance, as the user moves computer system 600, computer system 600 updates display of connection user interface object 628 so that the relative positions of satellite representation 630a, computer system representation 630b, and/or alignment element 630c represent the movement and/or current position of computer system 600.

At FIG. 6M, computer system 600 determines and/or detects a change in orientation of computer system 600 relative to the orientation of computer system 600 at FIG. 6L. In some embodiments, computer system 600 determines and/or detects a change in orientation based on a change in position of one or more antennae of computer system 600 that enables computer system 600 to connect to a satellite of the satellite communication network. In some embodiments, computer system 600 determines and/or detects a change in orientation based on receiving information that computer system 600 has moved (e.g., information received from an accelerometer and/or gyroscope). In response to determining and/or detecting the change in orientation of computer system 600, computer system 600 updates display of connection user interface object 628, as shown at FIG. 6M. At FIG. 6M, satellite representation 630a is displayed within alignment element 630c indicating that computer system 600 is configured to initiate a connection with a satellite of the satellite communication network. Prompt 628a includes text prompting the user of computer system 600 to maintain the orientation of computer system 600 so that computer system 600 can establish the connection with the satellite. In some embodiments, computer system 600 initiates establishing the connection with the satellite by sending one or more communication signals to the satellite and/or receiving one or more communication signals from the satellite.

At FIG. 6N, computer system 600 has established the connection with the satellite. Based on determining that the connection with the satellite is established, computer system 600 updates connection user interface object 628. At FIG. 6G, connection user interface object 628 includes signal indicator 630d indicating that the connection between computer system 600 and the satellite has been established and/or initiated. In some embodiments, computer system 600 animates signal indicator 630d so that display of signal indicator 630d moves over time. In some embodiments, animating signal indicator 630d includes changing a color of a respective portion of alignment element 630c over time so that the respective portion of alignment element 630c changes in size over time. In some embodiments, animating signal indicator 630d includes displaying signal indicator 630d moving between satellite representation 630a and computer system representation 630b within alignment element 630c over time.

In some embodiments, based on a determination that computer system 600 has established the connection with the satellite, computer system 600 ceases and/or removes display of connection user interface object 628 and displays connection indicator 622, as shown at FIG. 6O. In some embodiments, computer system 600 ceases and/or removes display of connection user interface object 628 by collapsing and/or shrinking connection user interface object 628 so that connection user interface object 628 transforms and/or transitions into display of connection indicator 622. For example, in some embodiments, computer system 600 initiates an animation of connection user interface object 628 shrinking and/or transitioning into connection indicator 622 based on a determination that computer system 600 has established the connection with the satellite.

At FIG. 6O, computer system 600 displays third connection indicator 617a based on determining that the connection has been established with the satellite. As set forth above, third connection indicator 617a provides a visual confirmation that the connection with the satellite has been established. At FIG. 6O, third connection indicator 617a includes an image, icon, symbol, and/or graphical representation of a satellite to indicate to the user of computer system 600 that computer system 600 is connected to the satellite communication network. Computer system 600 also displays battery indicator 604c indicating a current and/or estimated amount of remaining battery power of a battery of computer system 600. Computer system 600 further displays time indicator 617b indicating a current time of day.

At FIG. 6O, connection indicator 622 includes signal indicator 622a and orientation indicator 622b. Signal indicator 622a indicates a signal strength between computer system 600 and the satellite of the satellite communication network. As set forth below, computer system 600 updates and/or changes an appearance of signal indicator 622a based on a determination that the signal strength between computer system 600 and the satellite falls below one or more threshold signal strength values. Orientation indicator 622b provides visual guidance about an orientation of computer system 600 that allows computer system 600 to maintain and/or establish a connection with a satellite of the satellite communication network that includes a signal strength above a signal strength threshold. At FIG. 6O, orientation indicator 622b includes an arrow pointing upward (e.g., relative to a display orientation of display 602) indicating that the user of computer system 600 should maintain a position and/or orientation of computer system 600. As set forth below, computer system 600 updates and/or adjusts an appearance of orientation indicator 622b to provide guidance to the user of computer system 600 to update the orientation of computer system 600.

At FIG. 6O, computer system 600 displays messaging user interface 620 after connecting to the satellite communication network. As shown at FIG. 6O, computer system 600 displays message user interface object 620h with a different appearance when compared to messaging user interface shown at FIG. 6H. For instance, message user interface object 620h includes hatching, which indicates that computer system 600 is not configured to send and/or receive group communications. As set forth above, message user interface object 620h corresponds to a group message conversation between computer system 600 and two or more different external devices and/or accounts (e.g., devices and/or accounts associated with “Carrie” and “Katie”). Because computer system 600 is connected to the satellite communication networks, computer system 600 is not configured to send and/or receive group communications. As such, computer system 600 displays message user interface object 620h with a different appearance to indicate to the user that such messages and/or communications are unavailable. In some embodiments, computer system 600 is configured to send and/or receive group communications while computer system 600 is connected to the satellite communication network. In some such embodiments, computer system 600 displays message user interface object 620h with the appearance shown at FIG. 6H.

In some embodiments, computer system 600 is configured to send different types of messages and/or communications to a respective external device and/or account based on an amount of time that has elapsed since computer system 600 last communicated with the respective external device and/or account (e.g., sent a communication to and/or received a communication from the respective external device). In some embodiments, computer system 600 sends a message of a first type (e.g., an encrypted message) when computer system 600 last communicated with a respective external device within a threshold amount of time (e.g., within 10 days, within 14 days, within 21 days, or within 30 days) and/or when the respective external device is configured to receive messages of the first type. In some embodiments, computer system 600 sends a message of a second type (e.g., a non-encrypted message), different from the message of the first type, when computer system 600 last communicated with the respective external device more than the threshold amount of time and regardless of whether the external device is configured to receive messages of the first type. In some embodiments, computer system 600 displays message user interface objects 620a-620i with a different appearance based on the amount of time that has elapsed since computer system 600 last communicated with an external device corresponding to message user interface objects 620a-620i. For instance, in some embodiments, computer system 600 displays one or more message user interface objects 620a-620i with a first appearance (e.g., a first color, a first shading, a first shape, and/or a first size) when computer system 600 last communicated with a respective external device corresponding to the one or more message user interface objects within the threshold amount of time. In some embodiments, computer system 600 displays one or more message user interface objects 620a-620i with a second appearance (e.g., a second color, a second shading, a second shape, and/or a second size) that is different from the first appearance when computer system 600 last communicated with a respective external device corresponding to the one or more message user interface objects more than the threshold amount of time.

At FIG. 6O, computer system 600 detects user input 650g corresponding to selection of message user interface object 620a. In response to detecting user input 650g, computer system displays message conversation user interface 632a, as shown at FIG. 6P.

At FIGS. 6A-6O, computer system 600 is associated with user John, as indicated by the label “JOHN'S PHONE” at FIGS. 6A-6O. FIG. 6P illustrates examples of both computer system 600 associated with user John and computer system 634 associated with user Jane, labeled “JANE'S PHONE.” Computer system 600 displays message conversation user interface 632a and computer system 634 displays corresponding message conversation user interface 634b. At FIG. 6P, computer system 600 displays first notification 636a indicating that computer system 600 is operating in the second mode of operation (e.g., computer system 600 is configured to send and/or receive communications via the satellite communication network). Computer system 600 also displays second notification 636b indicating that computer system 600 forgoes displaying and/or outputting notifications related to received communications while computer system 600 operates in the second mode of operation. In some embodiments, computer system 600 forgoes displaying and/or outputting notifications related to received and/or incoming communications while operating in the second mode of operation to conserve power. For instance, in some embodiments, computer system 600 operates in the second mode of operation while computer system 600 is located in an area where cellular communication networks are not available. Thus, to conserve power for initiating communications via the satellite communication network, computer system 600 forgoes outputting notifications corresponding to received and/or incoming communications.

In some embodiments, computer system 600 and/or computer system 634 display different types of indications and/or notifications based on the operating mode of computer system 600. In some embodiments, the type of indication and/or notifications displayed by computer system 600 and/or computer system 634 are based on types of communications that computer system 634 is configured to receive. In some embodiments, computer system 634 is configured to receive messages of a first type (e.g., encrypted messages and/or secure messages) from computer system 600. In some such embodiments, computer system 634 is configured to send communications to computer system 600 while computer system 600 is operating in the second mode of operation before receiving a communication from computer system 600. In some embodiments, computer system 634 is not configured to receive messages of a first type (e.g., encrypted messages and/or secure messages) from computer system 600. In some such embodiments, computer system 634 is configured to send a communication to computer system 600 only after receiving a communication from computer system 600 (e.g., within a threshold amount of time after receiving a communication from computer system 600).

At FIG. 6P, computer system 634 is configured to receive messages of the first type from computer system 600. At FIG. 6P, computer system 634 displays notification 636c indicating that computer system 600 is operating in the second mode of operation. Computer system 634 displays notification 636c so that the user of computer system 634 is notified that computer system 600 is operating in the second mode of operation and can determine whether sending a message to computer system 600 is warranted. In some embodiments, computer system 634 displays notification 636c based on a determination that the user of computer system 600 is a designated contact (e.g., a contact designated by a user of computer system 634, a top contact, and/or a preferred contact) of computer system 634. In some embodiments, computer system 634 forgoes displaying notification 634c when computer system 634 determines that the user of computer system 600 is not a designated contact of computer system 634. In some embodiments, computer system 634 displays notification 634c after computer system 634 sends a communication to computer system 600 when computer system 634 determines that the user of computer system 600 is not a designated contact of computer system 634. In some embodiments, computer system 634 forgoes and/or does not display notification 634c based on a determination that computer system 600 is operating in the first mode of operation. In some embodiments, computer system 634 transitions from not displaying notification 634c to displaying notification 634c based on a determination that computer system 600 transitioned from operating in the first mode of operation to the second mode of operation.

In addition, computer system 634 displays notification 636d indicating that computer system 600 will not output and/or display a notification corresponding to a received and/or incoming communication. The user of computer system 634 can therefore be notified that the user of computer system 600 may not be aware that a message was received and/or that a response from the user of computer system 600 may be delayed.

At FIG. 6P, computer system 600 detects one or more user inputs 650h corresponding to keyboard 638a of message conversation user interface 632a. In some embodiments, computer system 600 displays one or more characters (e.g., alphanumeric characters and/or symbols) in composition region 638b of message conversation user interface 632a in response to detecting one or more user inputs 650h. The user of computer system 600 can therefore edit and/or modify a draft message before sending a communication to an external device, such as computer system 634. After detecting one or more user inputs 650h, computer system 600 detects user input 650i corresponding to send user interface object 638c of message conversation user interface 632a. In response to detecting user input 650i, computer system 600 initiates a process for sending the message to computer system 634. In some embodiments, computer system 600 initiates the process for sending the message to computer system 634 by sending data and/or information to a satellite of the satellite communication network. In some embodiments, the satellite then transmits data and/or information related to the message to computer system 634, either directly and/or indirectly via a component of a terrestrial communication network.

At FIG. 6Q, computer system 600 displays message 640a corresponding to the message sent by computer system 600 in response to detecting user input 650i. Computer system 600 also displays indication 638d indicating that the message was delivered. In some embodiments, computer system 600 displays indication 638d based on a determination that a satellite of the satellite communication network received the data and/or information transmitted by computer system 600. For instance, in some embodiments, computer system 600 receives a confirmation signal and/or transmission from the satellite confirming that the satellite received the data and/or information sent by computer system 600. In some embodiments, computer system 600 displays indication 638d based on a determination that computer system 634 received the message. In some embodiments, the satellite receives confirmation that computer system 634 received the message and/or that the message was delivered to computer system 634 and the satellite sends a confirmation signal and/or transmission to computer system 600.

At FIG. 6Q, computer system 634 displays message 640b corresponding to the message sent by computer system 600 and received at computer system 634. FIG. 6Q further illustrates external device 642 associated with the user of computer system 634 (e.g., Jane as indicated by the label “JANE'S WATCH”). In some embodiments, external device 642 is in communication with (e.g., paired to) computer system 634, such that computer system 634 and external device 642 communicate data and/or information between one another. External device 642 displays message conversation user interface 632c, which corresponds to message conversation user interface 632b displayed at computer system 634. Message conversation user interface 632c includes message 640c corresponding to the message sent by computer system 600. Thus, computer system 634 communicates data and/or information to external device 642 so that external device 642 can display message 640c and the user of computer system 634 and external device 642 can view the message on one or both devices.

As set forth above, computer system 600 updates connection indicator 622 based on an orientation of computer system 600 (e.g., relative to a satellite of the satellite communication network), a signal strength between computer system 600 and the satellite communication network, and/or availability of one or more satellites of the satellite communication network. At FIG. 6R, computer system 600 (e.g., “JOHN'S PHONE”) displays message conversation user interface 644a corresponding to a message conversation with a user that is different from the user of computer system 634. Message conversation user interface 644a corresponds to a message conversation with a user (e.g., Jim) associated with computer system 646, which is different from computer system 634. As shown at FIG. 6R, computer system 646 is labeled “JIM'S PHONE” to indicate that computer system 646 is associated with the user Jim. As set forth below, computer system 646 is not configured to receive messages of the first type (e.g., encrypted messages and/or secure messages). At FIG. 6R, computer system 646 displays message conversation user interface 644b, which corresponds to a message conversation with the user of computer system 600 (e.g., John). However, computer system 646 does not display notification 636c and/or notification 636d on message conversation user interface 644b because computer system 646 is not configured to receive messages of the first type. In some embodiments, computer system 646 is not configured to and/or unable to send communications to computer system 600 while computer system 600 is operating in the second mode of operation and/or prior to receiving a communication from computer system 600 while computer system 600 operates in the second mode of operation.

At FIG. 6R, signal indicator 622a of connection indicator 622 includes a second appearance, which is different from the appearance of signal indicator 622a shown at FIGS. 6O-6Q. For instance, at FIG. 6R, signal indicator 622a includes second hatching that is different from the first hatching shown at FIGS. 6O-6Q. The appearance of signal indicator 622a at FIG. 6R indicates that the signal strength between computer system 600 and a satellite of the satellite communication network has fallen below a threshold signal strength (e.g., a first threshold signal strength). In some embodiments, the signal strength between computer system 600 and the satellite weakens as the satellite orbits Earth and changes position and/or orientation relative to computer system 600. At FIG. 6R, orientation indicator 622b of connection indicator 622 includes an arrow pointing to the left prompting the user of computer system 600 to move and/or re-orient computer system 600 toward the left. In some embodiments, the satellite of the satellite communication network has moved while an orientation of computer system 600 has been maintained (e.g., relative to the ground and/or relative to the user). Computer system 600 displays orientation indicator 622b with the arrow pointing to the left to guide the user of computer system 600 to orient computer system 600, such that computer system 600 can establish and/or re-establish a signal strength above the threshold signal strength.

At FIG. 6S, computer system 600 has lost the connection with the satellite of the satellite communication network. In some embodiments, computer system 600 determines that the connection with the satellite has been lost when the signal strength between computer system 600 and the satellite falls below a second threshold signal strength, that is less than the threshold signal strength (e.g., the first threshold signal strength). In some embodiments, computer system 600 determines that the connection with the satellite has been lost when there is no signal between computer system 600 and the satellite. Based on the determination that the connection with the satellite has been lost, computer system 600 displays connection user interface object 628, as shown at FIG. 6S. In some embodiments, computer system 600 displays connection user interface object 628 by enlarging connection indicator 622 and/or transitioning display of connection indicator 622 into connection user interface object 628. In some embodiments, computer system 600 displays an animation of connection indicator 622 moving, transforming, and/or enlarging into connection user interface object 628.

At FIG. 6S, connection user interface object 628 indicates that the connection between computer system 600 and the satellite has been lost. In addition, connection user interface object 628 includes prompts to guide the user of computer system 600 in establishing and/or re-establishing a connection between computer system 600 and the satellite and/or another satellite of the satellite communication network. For instance, connection user interface object 628 includes map representation 630 and prompt 628a. Map representation 630 includes satellite representation 630a, computer system representation 630b, and alignment element 630c.

At FIG. 6S, satellite representation 630a is displayed outside of alignment element 630c, such that computer system 600 cannot connect to the satellite of the satellite communication network. Prompt 628a includes a textual indication and/or guidance to a user of computer system 600 to position computer system 600 at an orientation that causes satellite representation 630a to be displayed within alignment element 630c. For instance, as the user moves computer system 600, computer system 600 updates display of connection user interface object 628 so that the relative positions of satellite representation 630a, computer system representation 630b, and/or alignment element 630c change based on the movement of computer system 600.

At FIG. 6T, computer system 600 has detected a change in orientation of computer system 600 and/or otherwise established (e.g., re-established) the connection with a satellite of the satellite communication network. Based on determining that the connection with the satellite is established, computer system 600 ceases and/or removes display of connection user interface object 628 and displays connection indicator 622, as shown at FIG. 6T. In some embodiments, computer system 600 ceases and/or removes display of connection user interface object 628 by collapsing and/or shrinking connection user interface object 628 so that connection user interface object 628 transforms and/or transitions into display of connection indicator 622. For example, in some embodiments, computer system 600 initiates an animation of connection user interface object 628 shrinking and/or transitioning into connection indicator 622 based on a determination that computer system 600 has established the connection with the satellite. At FIG. 6T, signal indicator 622a of connection indicator 622 includes the first appearance (e.g., the appearance shown at FIGS. 6O-6Q) indicating that the connection between computer system 600 and the satellite of the satellite communication network is above the threshold signal strength. Orientation indicator 622b of connection indicator 622 includes an arrow pointing upward indicating that the user of computer system 600 should maintain an orientation of computer system 600 to maintain the connection between computer system 600 and the satellite.

At FIG. 6T, computer system 600 has detected one or more user inputs corresponding to keyboard 648a of message conversation user interface 644a. For instance, at FIG. 6T, computer system 600 displays one or more characters (e.g., alphanumeric characters and/or symbols) in composition region 648b of message conversation user interface 644a in response to detecting the one or more user inputs. The user of computer system 600 can therefore edit and/or modify a draft message before sending a communication to an external device, such as computer system 646. After detecting the one or more user inputs, computer system 600 detects user input 650j corresponding to send user interface object 648c of message conversation user interface 644a. In response to detecting user input 650j, computer system 600 initiates a process for sending the message to computer system 646. In some embodiments, computer system 600 initiates the process for sending the message to computer system 646 by sending data and/or information to a satellite of the satellite communication network. In some embodiments, the satellite then transmits data and/or information related to the message to computer system 646, either directly and/or indirectly via a component of a terrestrial communication network.

At FIG. 6U, computer system 600 displays message 652a corresponding to the message sent by computer system 600 in response to detecting user input 650j. Computer system 600 also displays indication 648d indicating that the message was delivered. In some embodiments, computer system 600 displays indication 648d based on a determination that a satellite of the satellite communication network received the data and/or information transmitted by computer system 600. For instance, in some embodiments, computer system 600 receives a confirmation signal and/or transmission from the satellite confirming that the satellite received the data and/or information sent by computer system 600. In some embodiments, computer system 600 displays indication 648d based on a determination that computer system 646 received the message. In some embodiments, the satellite receives confirmation that computer system 646 received the message and/or that the message was delivered to computer system 646 and the satellite sends a confirmation signal and/or transmission to computer system 600.

Computer system 600 also displays notification 648e on message conversation user interface 644a after detecting user input 650j. At FIG. 6U, notification 648e indicates that the message sent to computer system 646 via the satellite communication network was a text message. Notification 648e also indicates that sending the text message to computer system 646 enables computer system 646 to respond and/or send additional text messages to computer system 600 for a predetermined amount of time, such as, e.g., 24 hours. Computer system 600 displays notification 648e based on a determination that computer system 646 cannot send and/or receive communications of the first type. As such, computer system 600 displays additional information on message conversation user interface 644a to provide visual feedback and/or information to the user of computer system 600.

At FIG. 6U, computer system 646 displays message 652b corresponding to the message sent by computer system 600 and received at computer system 646. Computer system 600 also displays notification 648f after and/or in response to receiving message 652b from computer system 600 while computer system 600 operates in the second mode of operation. For instance, in some embodiments, the communication received at computer system 646 includes information corresponding to message 652b and information corresponding to the state and/or mode of operation of computer system 600. Because computer system 646 is not configured to send and/or receive communications of the first type, computer system 646 is not able to initiate communications with computer system 600 while computer system 600 operates in the second mode of operation. However, upon receiving communication from computer system 600 while computer system 600 operates in the second mode of operation, computer system 646 is able to send communications (e.g., text messages) to computer system 600 for a predetermined period of time. For example, computer system 600 initiates a predetermined amount of time during which computer system 646 can send communications to computer system 600 while computer system 600 is operating in the second mode of operation in response to sending the communication (e.g., message 652a and/or message 652b) to computer system 646. Notification 648f includes information that notifies the user of computer system 646 that the user can send communications to computer system 600 for the predetermined amount of time. In some embodiments, the predetermined amount of time starts and/or begins elapsing in response to receiving user input 650j. In some embodiments, the predetermined amount of time starts and/or begins elapsing when computer system 600 receives confirmation that the communication was delivered to a satellite of the satellite communication network. In some embodiments, the predetermined amount of time starts and/or begins elapsing when computer system 646 receives the communication.

As set forth above, computer system 600 does not display and/or output notifications corresponding to incoming and/or received communications while computer system 600 operates in the second mode of operation. At FIG. 6V, computer system 600 is operating in the second mode of operation and is in a locked state. For instance, computer system 600 is displaying lock screen user interface 604 indicating that the user of computer system 600 is not currently interacting with computer system 600. In some embodiments, computer system 600 transitions to the locked state in response to detecting user input requesting that computer system 600 transition to and/or operate in the locked state. In some embodiments, computer system 600 transitions to the locked state based on an absence of user input and/or user interaction with computer system 600 for a predetermined amount of time. In some embodiments, computer system 600 disconnects from a satellite of the satellite communication network (e.g., while continuing to operate in the second mode of operation) after and/or in response to transitioning to the locked state. In some embodiments, computer system 600 disconnects from a satellite of the satellite communication network (e.g., while continuing to operate in the second mode of operation) after and/or in response to detecting an absence of user input and/or user interaction with computer system 600 for a predetermined amount of time.

FIG. 6V illustrates computer system 654, which is associated with a user that is different from the users associated with computer system 634 and computer system 646. Computer system 654 includes the label “JEN'S PHONE” indicating that computer system 654 is associated with the user Jen, who is different from Jane and Jim described above.

At FIG. 6V, computer system 654 displays message conversation user interface 656 corresponding to a message conversation between the user associated with computer system 654 (e.g., Jen) and the user associated with computer system 600 (e.g., John). At FIG. 6V, computer system 654 is configured to send and/or receive communications of the first type (e.g., encrypted messages and/or secure messages). Computer system 654 displays notification 636c on message conversation user interface 656 indicating that computer system 600 is operating in the second mode of operation. Computer system 654 displays notification 636c so that the user of computer system 654 is notified that computer system 600 is operating in the second mode of operation and can determine whether sending a message to computer system 600 is warranted. In addition, computer system 654 displays notification 636d indicating that computer system 600 will not output and/or display a notification corresponding to a received and/or incoming communication. The user of computer system 654 can therefore be notified that the user of computer system 600 may not be aware that a message was received and/or that a response from the user of computer system 600 may be delayed.

At FIG. 6V, computer system 654 detects one or more user inputs 650k corresponding to keyboard 656a of message conversation user interface 656. In response to detecting one or more user inputs 650k, computer system 654 displays characters 656b in message composition region 656c of message conversation user interface 656. At FIG. 6V, computer system 600 displays word count indicator 656d on message conversation user interface 656. Word count indicator 656d notifies and/or informs the user of computer system 654 that an amount of content included in a communication to computer system 600 while computer system 600 operates in the second mode of operation is limited. For instance, at FIG. 6V, word count indicator 656d indicates that the message currently includes 10 words out of a total of 20 words that can be included in the communication. In some embodiments, communications sent to computer system 600 while computer system 600 operates in the second mode of operation by external devices is not limited to a particular number of words, and thus, computer system 654 does not display word count indicator 656d. In some embodiments, communications sent to computer system 600 while computer system 600 operates in the second mode of operation by external devices is limited to a number of characters (e.g., 150 characters, 200 characters, or 500 characters). In some embodiments, communications sent to computer system 600 while computer system 600 operates in the second mode of operation by external devices is limited to a number of words that is different from 20 words (e.g., 25 words, 30 words, or 50 words). In some embodiments, the amount of information and/or content included in communications to computer system 600 while computer system 600 operates in the second mode of operation is limited to reduce an amount of data transmitted via the satellite communication network so that communications are sent to and/or received by computer system 600 more quickly (e.g., as compared to communications with large amounts of information and/or content).

At FIG. 6V, computer system 654 detects user input 650l corresponding to send user interface object 656e of message conversation user interface 656. In response to detecting user input 650l, computer system 654 initiates a process for sending the communication (e.g., the text shown in message composition region 656c of message conversation user interface 656) to computer system 600.

At FIG. 6W, prior to sending the communication, computer system 654 displays message indicator 656f on message conversation user interface 656 having an appearance that is different from a sent message, as indicated by hatching at FIG. 6W. Computer system 654 also displays prompt 656g on message conversation user interface 656 prompting the user of computer system 654 to provide user input to confirm sending the communication. Prompt 656g provides guidance to the user of computer system 654 about how to send the communication and/or confirms that the user of computer system 654 intends to send the communication while computer system 600 operates in the second mode of operation. At FIG. 6W, computer system 654 detects user input 650m corresponding to selection of message indicator 656f. In response to detecting user input 650m, computer system 654 initiates sending the communication to computer system 600.

In some embodiments, computer system 654 is configured to send subsequent communications to computer system 600 (e.g., communications sent after detecting user input 650m) without displaying a message indicator with the appearance shown at FIG. 6W and without prompting the user to provide additional input to confirm sending the subsequent communication. For instance, in some embodiments, computer system 654 prompts the user to confirm sending the first communication to computer system 600 while computer system 600 is operating in the second mode of operation, but does not prompt the user to send subsequent communications after the first communication is sent to computer system 600 while computer system 600 continues to operate in the second mode of operation.

At FIG. 6X, computer system 654 has sent the communication to computer system 600 via the satellite communication network (and, optionally, via a terrestrial network). At FIG. 6X, computer system 654 displays message indicator 656f with an appearance that is the same as an appearance of a sent message and different from the appearance shown at FIG. 6W, as indicated by no hatching at FIG. 6X. Computer system 654 displays notification 656h indicating that computer system 600 will not display and/or output notifications corresponding to the communication. In some embodiments, computer system 654 displays notification 656h so that the user of computer system 654 is notified that the user of computer system 600 may not have received the message. Computer system 654 also displays sent indicator 656i on message conversation user interface 656 to indicate that computer system 654 has sent the communication. However, computer system 656 has not yet received confirmation that the communication has been delivered either to a satellite of the satellite communication network and/or computer system 600.

At FIG. 6Y, computer system 654 receives confirmation that the communication was delivered and displays delivered indicator 656j on message conversation user interface 656. In some embodiments, computer system 654 displays delivered indicator 656j based on receiving confirmation that a satellite of the satellite communication network received the communication, but not based on confirmation that computer system 600 received the communication. In some embodiments, because computer system 600 does not output and/or display notifications associated with incoming and/or received communications (e.g., while operating in the second mode of operation), delivered indicator 656j is displayed when the satellite receives the communication. In some embodiments, computer system 600 is configured to disconnect from a satellite of the satellite communication network while continuing to operate in the second mode of operation, such that computer system 600 does not receive the communication until establishing communication with a satellite of the communication network. In some embodiments, computer system 654 displays delivered indicator 656j based on receiving confirmation that computer system 600 received the communication.

As set forth above, external devices that are not configured to send and/or receive communications and/or messages of the first type (e.g., encrypted messages and/or secure messages) cannot send communications to computer system 600 while computer system 600 operates in the second mode of operation and/or prior to receiving a communication from computer system 600. At FIG. 6Z, computer system 600 is operating in the second mode of operation and is in a locked state. For instance, computer system 600 is displaying lock screen user interface 604. FIG. 6Z illustrates computer system 658, which is associated with a user that is different from the users associated with computer system 634, computer system 646, and computer system 654. Computer system 658 includes the label “JANET'S PHONE” indicating that computer system 658 is associated with the user Janet, who is different from Jane, Jim, and Jen described above.

At FIG. 6Z, computer system 658 is not configured to receive communications and/or messages of the first type (e.g., encrypted messages and/or secure messages). At FIG. 6Z, computer system 658 displays message conversation user interface 660, which corresponds to a message conversation with the user of computer system 600 (e.g., John). However, computer system 658 does not display notification 636c and/or notification 636d on message conversation user interface 660 because computer system 658 is not configured to send and/or receive messages of the first type. In some embodiments, computer system 658 is not configured to and/or unable to send communications to computer system 600 while computer system 600 is operating in the second mode of operation and/or prior to receiving a communication from computer system 600 while computer system 600 operates in the second mode of operation.

At FIG. 6Z, computer system 658 detects one or more user inputs 650n corresponding to keyboard 660a of message conversation user interface 660. In response to detecting one or more user inputs 650n, computer system 658 displays characters 660b in message composition region 660c of message conversation user interface 660. After detecting one or more user inputs 650n, computer system 600 detects user input 6500 corresponding to send user interface object 660d of message conversation user interface 660. After detecting user input 6500, computer system 658 detects user input 650p corresponding to lock button 658a of computer system 658. In response to detecting user input 650p, computer system 658 transitions to a locked state and displays lock user interface 662, as shown at FIG. 6AA.

In some embodiments, computer system 658 initiates a process for sending a communication to computer system 600 in response to detecting user input 6500. In some embodiments, computer system 658 determines that computer system 600 is operating in the second mode of operation and that computer system 658 has not received a communication from computer system 600 while computer system 600 is operating in the second mode of operation. At FIG. 6AA, computer system 658 determines (e.g., receives information indicating) that computer system 600 is operating in the second mode of operation and/or that computer system 658 has not received a communication from computer system 600 while computer system 600 is operating in the second mode of operation. Based on the determination that computer system 600 is operating in the second mode of operation and/or that computer system 658 has not received a communication from computer system 600 while computer system 600 operates in the second mode of operation, computer system 658 displays error notification 662a on lock screen user interface 662, as shown at FIG. 6AA. Error notification 662a includes text, graphics, symbols, objects, and/or images indicating that the communication cannot be sent and/or delivered to computer system 600. Error notification 662a includes information that computer system 600 is operating in the second mode of operation and that computer system 600 will not receive the communication. In some embodiments, computer system 658 displays error notification 662a on message conversation user interface 660, such as when computer system 658 does not transition to the locked state before determining that computer system 600 is operating in the second mode of operation.

As set forth above, computer system 600 does not display and/or output notifications corresponding to incoming and/or received communications while operating in the second mode of operation. In some embodiments, computer system 600 disconnects from a satellite of the satellite communication network while operating in the second mode of operation to conserve battery power. In some such embodiments, computer system 600 cannot download and/or receive any communications while disconnected from the satellite of the satellite communication network. As set forth below with reference to FIGS. 6AB-6AH, computer system 600 is configured to, upon establishing a connection with a satellite of the satellite communication network, receive, download, and/or view communications that were sent to computer system 600 while computer system 600 was disconnected from the satellite of the satellite communication network.

At FIG. 6AB, computer system 600 has been unlocked and is operating in an unlocked state as opposed to the locked state in which computer system 600 operated at FIG. 6AA. In some embodiments, computer system 600 detects one or more user inputs and/or authorization inputs to transition from the locked state to the unlocked state. While computer system 600 operates in the locked state (e.g., the state of computer system at FIGS. 6V-6AA), computer system 600 disconnects from a satellite of the satellite communication network while operating in the second mode of operation (e.g., and while concurrently operating in the locked state). Disconnecting from the satellite of the satellite communication network while computer system 600 is in the locked state conserves battery power, such that computer system 600 can operate for longer periods of time without requiring charging.

In some embodiments, after computer system 600 transitions from the locked state to the unlocked state, computer system 600 receives one or more user inputs requesting to navigate to the messaging user interface 620. At FIG. 6AB, computer system 600 displays messaging user interface 620 while in the unlocked state and while operating in the second mode of operation. However, as set forth above, computer system 600 is not connected to a satellite of the satellite communication network. Computer system 600 displays satellite user interface object 664 prompting the user of computer system 600 to initiate a connection between computer system 600 and a satellite of the satellite communication network. Satellite user interface object 664 includes information region 664a indicating that computer system 600 is not connected to a satellite of the satellite communication network. Satellite user interface object 664 also includes connect user interface object 664b, which, when selected via user input, causes computer system 600 to initiate a process for connecting to a satellite of the satellite communication network. In some embodiments, computer system 600 displays satellite user interface object 664 in response to detecting user input requesting to display messaging user interface 620. In some embodiments, in response to transitioning from the locked state to the unlocked state, computer system 600 displays satellite user interface object 664 (e.g., and, in some embodiments, displays satellite user interface object 664 on a currently displayed user interface).

At FIG. 6AB, computer system 600 detects user input 650q corresponding to selection of connect user interface object 664b of satellite user interface object 664. In response to detecting user input 650q, computer system 600 displays connection user interface object 628, as shown at FIG. 6AC.

At FIG. 6AC, computer system 600 displays connection user interface object 628, which provides guidance to the user of computer system 600 for establishing a connection between computer system 600 and a satellite of the satellite communication system. For instance, connection user interface 628 prompts the user to orient computer system 600 at a particular orientation that allows computer system 600 to connect to a satellite of the satellite communication system. In some embodiments, computer system 600 updates an appearance of connection user interface object 628 based on movement of computer system 600, as set forth above with reference to FIGS. 6M-6O.

At FIG. 6AD, computer system 600 is connected to and/or in communication with a satellite of the satellite communication network, as indicated by connection indicator 622. Signal indicator 622a of connection indicator 622 includes the first appearance indicating that the signal strength between computer system 600 and the satellite of the satellite communication network is above a signal strength threshold. Orientation indicator 622b indicates that the position and/or orientation of computer system 600 should be maintained so that the connection between computer system 600 and the satellite can continue.

At FIG. 6AD, after computer system 600 has connected to and/or established communication with the satellite of the satellite communication network, computer system 600 initiates a process for downloading and/or receiving messages that were sent to computer system 600 while computer system 600 was disconnected from a satellite of the satellite communication network (e.g., while computer system 600 was operating in the second mode of operation and in the locked state). At FIG. 6AD, computer system 600 displays messaging user interface 620, which includes indicator 620j to notify the user of computer system 600 that computer system 600 is downloading and/or receiving communications via the satellite communication network.

At FIG. 6AD, computer system 600 detects user input 650r corresponding to message user interface object 620c. In response to detecting user input 650r, computer system 600 displays messaging conversation user interface 666, as shown at FIG. 6AG.

In some embodiments, prior to detecting user input 650r, computer system 600 displays messaging user interface 620, as shown at FIG. 6AE. At FIG. 6AE, computer system 600 has started to download and/or receive communications via the satellite communication network. For instance, at FIG. 6AE, computer system 600 is downloading and/or receiving a communication from the user Jen and displays progress indicator 620k in message user interface object 620c. At FIG. 6AE, computer system 600 rearranges and/or otherwise displays message user interface objects 620a-620i in a different order based on computer system 600 downloading and/or receiving communications from respective users associated with user interface objects 620a-620i. Computer system 600 begins downloading and/or receiving a communication from the user Jen, who is associated with message user interface object 620c. Computer system 600 moves and/or displays message user interface object 620c above user interface objects 620a, 620b, and 620d-620i so that the attention of the user of computer system 600 is drawn to a new communication that computer system 600 is downloading and/or receiving.

Progress indicator 620k includes a progress bar indicating an amount of progress toward downloading and/or receiving the communication from the user Jen. As computer system 600 receives additional information and/or data from the satellite of the satellite communication network corresponding to the communication from the user Jen, computer system 600 updates progress indicator 620k so that the progress bar continues to fill from the left to the right. Based on a determination that downloading and/or receiving the communication from the user Jen has completed, computer system 600 updates display of message user interface object 620c, as shown at FIG. 6AF.

At FIG. 6AF, computer system 600 has completed the download and/or receipt of the communication from the user Jen and displays message user interface object 620c with new message indicator 620l and indicator 620m. New message indicator 620l indicates that one new message and/or communication was downloaded and/or received from an external device (e.g., computer system 654) associated with the user Jen. Indicator 620m provides further visual feedback that the communication and/or message associated with the user Jen has not been read and/or otherwise viewed by the user of computer system 600 (e.g., computer system 600 has not displayed messaging conversation user interface 666 that includes display of the communication).

At FIG. 6AF, computer system 600 has also completed downloading and/or receiving messages and/or communications from additional external devices. Computer system 600 rearranges the order of and/or displays message user interface objects 620a-620i based on a determination that communications and/or messages were downloaded and/or received from external devices corresponding to one or more of message user interface objects 620a-620i. At FIG. 6AF, computer system 600 displays message user interface objects 620a-620i for which communications and/or messages have been received above message user interface objects 620a-620i for which communications and/or messages have not been received. In some embodiments, computer system 600 arranges message user interface objects 620a-620i based on a time at which the message was downloaded and/or received by computer system 600 (e.g., message user interface objects for which messages were downloaded and/or received more recently are displayed above message user interface objects for which messages were downloaded at an earlier time). In some embodiments, computer system 600 arranges message user interface objects 620a-620i based on a time stamp associated with the message (e.g., messages having an earlier time stamp are displayed below messages having a more recent time stamp).

As set forth above, in response to detecting user input 650r at FIG. 6AD, computer system 600 displays messaging conversation user interface 666, as shown at FIG. 6AG. At FIG. 6AG, computer system 600 has not yet downloaded and/or received messages and/or communications received from the external device associated with the user Jen. Messaging conversation user interface 666 includes message status indicators 666a-666c indicating that computer system 600 is downloading and/or receiving three messages via the satellite of the satellite communication network. Computer system 600 also displays total progress indicator 666d indicating that zero out of the three messages have been downloaded and/or received by computer system 600. At FIG. 6AG, message status indicators 666a-666c indicate an amount of progress toward downloading and/or receiving data corresponding to separate messages that were sent to computer system 600 by an external device associated with the user Jen (e.g., computer system 654). In some embodiments, computer system 600 animates and/or updates display of message status indicators 666a-666c as computer system 600 receives data and/or information corresponding to the respective messages and/or communications. For instance, in some embodiments, computer system 600 displays message status indicators 666a-666c with an amount of fill that corresponds to a percentage of the data downloaded and/or received for a respective message and/or communication.

Based on a determination that computer system 600 has downloaded and/or received all of the data for a respective message corresponding to message status indicator 666a, computer system 600 displays message indicator 666e, as shown at FIG. 6AH. In some embodiments, computer system 600 displays an animation of message status indicator 666a transitioning into and/or transforming into message indicator 666e. At FIG. 6AH, computer system 600 updates display of total progress indicator 666d to indicate that one message out of three total messages has been downloaded and/or received by computer system 600. Computer system 600 displays message status indicators 666b and 666c because computer system 600 has not downloaded and/or received all of the data corresponding to the respective messages for message status indicators 666b and 666c. In some embodiments, computer system 600 animates message status indicators 666b and 666c and/or replaces display of message status indicators 666b and 666c to display respective message indicators when computer system 600 finishes downloading and/or receiving the data for the respective messages and/or communications.

FIG. 6AH further illustrates external device 668, which is in communication with computer system 600. In some embodiments, external device 668 is paired to and/or otherwise in communication with computer system 600, such that information is transmitted between computer system 600 and external device 668 over a short range communication protocol. In some embodiments, external device 668 is not configured to connect to a satellite of the satellite communication network and/or is not able to connect to the satellite communication network at all. In some such embodiments, external device 668 cannot send communications (e.g., directly send communications without communicating with computer system 600) via the satellite communication network. However, external device 668 is configured to display communications that are sent and/or received by computer system 600 via the satellite communication network. In some embodiments, external device 668 receives data and/or information about communications and/or messages sent and/or received by computer system 600 via a short range communication protocol established with computer system 600. Thus, at FIG. 6AH, external device 668 displays a corresponding messaging conversation user interface 668a that includes message indicator 668b corresponding to message indicator 666e, message status indicators 668c and 668d corresponding to message status indicators 666b and 666c, and total progress indicator 668e corresponding to total progress indicator 666d.

At FIG. 6AH, computer system 600 detects user input 650s corresponding to a request to display control user interface 670. In response to detecting user input 650s, computer system 600 displays control user interface 670, as shown at FIG. 6AI.

At FIG. 6AI, control user interface 670 includes various user interface objects for controlling operations and/or settings of computer system 600. For instance, at FIG. 6AI, control user interface 670 includes airplane mode user interface object 670a for transitioning an operating mode of computer system 600 between an airplane mode and a normal mode. Control user interface 670 also includes second mode user interface object 670b for adjusting operation of computer system 600 while in the second mode of operation. Displaying second mode user interface object 670b on control user interface 670 indicates to a user of computer system 600 that computer system 600 is currently operating in the second mode of operation and that the user can adjust the operation of computer system 600 via selection of second mode user interface object 670b. In some embodiments, second mode user interface object 670b includes an indication of a connection status of computer system 600 with the satellite communication network. For instance, in some embodiments, second mode user interface object 670b includes text, objects, icons, and/or graphical elements that indicate whether the second mode of operation is available or not, whether computer system 600 is connected to and/or connecting to a satellite of the satellite communication network, and/or whether computer system 600 is disconnected to and/or disconnecting from a satellite of the satellite communication network. In some embodiments, the function and/or operation in which computer system 600 performs in response to detecting user input corresponding to second mode user interface object 670b is different based on the connection status of computer system 600 and the satellite communication network. For instance, in some embodiments, in response to detecting user input corresponding to second mode user interface object 670b while computer system 600 is connected to and/or in communication with a satellite of satellite communication network, computer system 600 enables and/or disables a function for receiving communications via the satellite communication network, disconnects from the satellite of the satellite communication network, and/or activates the first mode of operation. In some embodiments, in response to detecting user input corresponding to second mode user interface object 670b while computer is not connected and/or in communication with a satellite of satellite communication network, computer system 600 initiates a process for connecting to a satellite of the satellite communication network, activates the first mode of operation, and/or enables or disables a function for receiving communications via the satellite communication network.

Control user interface 670 also includes WiFi user interface object 670c and Bluetooth user interface object 670d, which are configured to adjust and/or control operation of computer system 600 with respect to WiFi and Bluetooth, respectively. In some embodiments, control user interface 670 includes a demo mode user interface object that causes computer system 600 to operate in a test mode for the second mode of operation. The demo mode and/or test mode of the second mode of operation is described below with reference to FIGS. 6AN-6AP.

At FIG. 6AI, computer system 600 detects user input 650t corresponding to second mode user interface object 670b. In response to detecting user input 650t, computer system 600 displays second mode user interface 672, as shown at FIG. 6AJ.

At FIG. 6AJ, second mode user interface 672 includes satellite disconnect user interface object 672a and second mode disconnect user interface object 672b. In some embodiments, in response to detecting user input corresponding to satellite disconnect user interface object 672a, computer system 600 disconnects from a satellite of the satellite communication network while continuing to operate in the second mode of operation. For example, computer system 600 continues to operate in the second mode of operation, but cannot send and/or receive communications without connecting to and/or re-connecting to a satellite of the satellite communication network. At FIG. 6AJ, computer system 600 detects user input 650u corresponding to second mode disconnect user interface object 672b. In response to detecting user input 650u, computer system 600 transitions from operating in the second mode of operation to operating in the first mode of operation. In some embodiments, computer system 600 disconnects from a satellite of the satellite communication network in response to detecting user input 650u. In some embodiments, computer system 600 initiates a process for connecting and/or attempting to connect to a terrestrial communication network in response to detecting user input 650u.

In some embodiments, computer system 600 is configured to transition from the second mode of operation to the first mode of operation without detecting user input. For instance, in some embodiments, computer system 600 transitions from operating in the second mode of operation to the first mode of operation based on a determination that a terrestrial communication network is available (e.g., a detected signal strength of a WiFi communication network and/or a cellular communication network is above a threshold signal strength) for a predetermined amount of time (e.g., 30 minutes, one hour, or two hours). In some embodiments, computer system 600 transitions from operating in the second mode of operation to the first mode of operation based on a determination that a terrestrial communication network is available and that computer system 600 is displaying messaging user interface 620. In some embodiments, computer system 600 transitions from operating in the second mode of operation to the first mode of operation based on a determination that a terrestrial communication network is available and in response to detecting user input requesting to send a communication.

At FIG. 6AK, after detecting user input 650u (and/or otherwise after computer system 600 transitions from operating in the second mode of operation to the first mode of operation), computer system 600 displays (e.g., re-displays) control user interface 670. At FIG. 6AK, second mode user interface object 670b is no longer displayed on control user interface 670 because computer system 600 has transitioned from operating in the second mode of operation to operating in the first mode of operation. While computer system 600 operates in the first mode of operation, computer system 600 displays first mode user interface object 670e, as shown at FIG. 6AK. In some embodiments, computer system 600 displays second mode user interface object 670b and first mode user interface object 670e at the same position and/or location of control user interface 670 based on whether computer system 600 is operating in the second mode of operation or the first mode of operation. In some embodiments, computer system 600 replaces display of second mode user interface object 670b with display of first mode user interface object 670e based on a determination that computer system 600 has transitioned from the second mode of operation to the first mode of operation. In some embodiments, computer system 600 replaces display of first mode user interface object 670e with second mode user interface object 670b based on a determination that computer system 600 has transitioned from the first mode of operation to the second mode of operation.

At FIG. 6AK, computer system 600 displays first mode user interface object 670e with a first appearance, as indicated by hatching at FIG. 6AK. Computer system 600 displays first mode user interface object 670e with the first appearance because computer system 600 is not connected to a terrestrial communication network, such as a WiFi network and/or a cellular network. For instance, at FIG. 6AK, computer system 600 is not connected to and/or is not receiving a signal from a WiFi network and/or a cellular network. For example, first connection indicator 604a is not displayed indicating that computer system 600 is not connected to the WiFi network. At FIG. 6AK, second connection indicator 604b is displayed as four dashed lines indicating that computer system 600 is not receiving a signal from and/or is otherwise disconnected from the cellular network.

At FIG. 6AL, computer system 600 is connected to and/or is receiving a signal from the cellular network. For instance, computer system 600 displays second connection indicator 604b with bars instead of dashed lines, thereby indicating that computer system 600 is receiving a signal from and/or is otherwise connected to the cellular network. Based on a determination that computer system 600 is connected to and/or receiving a signal from the cellular network, computer system 600 displays first mode user interface object 670e with a second appearance, as indicated by no hatching at FIG. 6AL. Thus, the user of computer system 600 can quickly determine whether computer system 600 is connected to the cellular network and/or another terrestrial network based on the displayed appearance of first mode user interface object 670c.

At FIG. 6AL, computer system 600 detects user input 650v requesting to display settings user interface 674. After detecting user input 650v, computer system 600 displays settings user interface 674, as shown at FIG. 6AM.

At FIG. 6AM, settings user interface 674 includes various user interface objects for adjusting, modifying, and/or controlling settings and/or operation of computer system 600. For instance, at FIG. 6AM, settings user interface 674 includes satellite user interface object 674a corresponding to settings and/or control of the second mode of operation of computer system 600. In some embodiments, satellite user interface object 674a is displayed at a different position on settings user interface 674. In some embodiments, satellite user interface object 674a is displayed on a different page and/or screen of setting user interface 674. At FIG. 6AM, computer system 600 detects user input 650w corresponding to selection of satellite user interface object 674a. After (e.g., in response to) detecting user input 650w, computer system 600 displays additional settings user interface 676, as shown at FIG. 6AN.

At FIG. 6AN, additional settings user interface 676 includes various user interface objects for adjusting, modifying, and/or controlling communication settings and/or operations of computer system 600. Settings user interface 676 includes second mode region 678 corresponding to settings and/or controls for the second mode of operation of computer system 600. For instance, at FIG. 6AN, second mode region 678 includes connection user interface object 678a and demo mode user interface object 678b. In some embodiments, in response to detecting user input corresponding to connection user interface object 678b, computer system 600 initiates a process for transitioning from the first mode of operation to the second mode of operation. In some embodiments, computer system 600 initiates the process for transitioning from the first mode of operation to the second mode of operation by displaying connection user interface 612 and/or connection user interface object 628, as described above with reference to FIGS. 6E-6O. In some embodiments, computer system 600 displays connection user interface object 678a with a first appearance indicating that the second mode of operation is not available when computer system 600 is connected to a terrestrial network (e.g., a signal strength between computer system 600 and a WiFi network and/or a cellular network is above a threshold signal strength). In some embodiments, computer system 600 displays connection user interface object 678a with a second appearance indicating that the second mode of operation is available when computer system 600 is not connected to and/or is not receiving a signal from a terrestrial network (e.g., any terrestrial network). In some embodiments, computer system 600 displays connection user interface object 678a with the second appearance indicating that the second mode of operation is available regardless of whether computer system 600 is connected to a terrestrial network.

At FIG. 6AN, demo mode user interface object 678b corresponds to a demo mode of operation of computer system 600 that enables computer system 600 to simulate and/or otherwise reproduce the second mode of operation without actually transitioning to the second mode of operation. For example, while operating in the demo mode of operation, computer system 600 continues to operate in the first mode of operation but allows a user to test the functionality of the second mode of operation. At FIG. 6AN, computer system 600 detects user input 650x corresponding to selection of demo mode user interface object 678b. In response to detecting user input 650x, computer system 600 initiates a demo mode for the second mode of operation and displays demo mode introduction user interface 680, as shown at FIG. 6AO.

At FIG. 6AO, demo mode introduction user interface 680 includes banner 680a, map representation 682, information region 680b, first activation user interface object 680c, and second activation user interface object 680d. While computer system 600 is operating in the demo mode for the second mode of operation, computer system 600 displays banner 680a so that the user of computer system 600 is notified that computer system 600 is not actually operating in the second mode of operation. For instance, banner 680a includes text, symbols, objects, images, and/or graphical representations indicating that computer system 600 is operating in a demo mode for the second mode of operation and/or that computer system 600 is not actually operating in the second mode of operation. Information region 680b includes additional information notifying user that activating a test mode of the demo mode does not cause computer system 600 to transition from the first mode of operation to the second mode of operation. At FIG. 6AO, computer system 600 displays map representation 682 before initiating a test mode of the demo mode of the second mode of operation. In some embodiments, map representation 682 corresponds to map representation 614, which is displayed when computer system 600 operates in the second mode of operation. In some embodiments, map representation 682 includes computer system representation 682a, which indicates a current geographical location of computer system 600.

At FIG. 6AO, first activation user interface object 680c corresponds to activating a test mode for the second mode of operation, such that a user can test and/or experience how computer system 600 operates and/or connects to a satellite during the second mode of operation. Second activation user interface object 680d corresponds to activating a test mode for a third mode of operation, that is different from the first mode of operation and the second mode of operation. In some embodiments, the third mode of operation enables computer system 600 to send and/or receive communications via a non-terrestrial communication network (e.g., a satellite communication network), but the communications are limited to emergency numbers and/or emergency services.

At FIG. 6AO, computer system 600 detects user input 650y corresponding to selection of first activation user interface object 680c. In response to detecting user input 650y, computer system 600 displays test connection user interface 684, as shown at FIG. 6AP.

At FIG. 6AP, test connection interface 684 includes map representation 682, computer system representation 682a, and alignment element 682b. In some embodiments, test connection user interface 684 includes a satellite representation of a simulated satellite (e.g., not a real and/or detected satellite of a satellite communication network). In some embodiments, computer system 600 displays test connection interface 684 in the same manner as connection user interface 612, as described above with reference to FIGS. 6E-6G. As such, the user of computer system 600 can test and/or try connecting to the simulated satellite before computer system 600 operates in the second mode of operation. At FIG. 6AP, test connection interface 684 includes banner 680a indicating that computer system 600 is operating in a demo mode for the second mode of operation and/or that computer system 600 is not actually operating in the second mode of operation. Thus, the user of computer system 600 is notified that computer system 600 is not actually operating in the second mode of operation and/or connecting to a satellite of the satellite communication network. At FIG. 6AP, banner 680a includes end user interface object 680c. In some embodiments, in response to detecting user input corresponding to end user interface object 680c, computer system 600 stops operating in the demo mode for the second mode of operation and/or displays additional settings user interface 676, as shown at FIG. 6AN.

FIG. 7 is a flow diagram illustrating a method for initiating communications via a non-terrestrial network using a computer system in accordance with some embodiments. Method 700 is performed at a computer system (e.g., 100, 300, 500, 600, 634, 646, 654, and/or 658) (e.g., a smart phone, a smart watch, a tablet computer, a laptop computer, a desktop computer, a wearable device, and/or head-mounted device). In some embodiments, the computer system (e.g., 100, 300, 500, 600, 634, 646, 654, and/or 658) is in communication with (e.g., includes and/or is connected to) a display generation component (e.g., 602) (e.g., a display, touch-screen display, a monitor, a holographic display system, and/or a head-mounted display system) and/or one or more input devices (e.g., 602 and/or 658a) (e.g., a touch-sensitive surface (e.g., a touch-sensitive display); a mouse; a keyboard; a remote control; a visual input device (e.g., one or more cameras such as, e.g., an infrared camera, a depth camera, a visible light camera, and/or a gaze tracking camera); an audio input device (e.g., a microphone); a biometric sensor (e.g., a fingerprint sensor, a face identification sensor, a gaze tracking sensor, and/or an iris identification sensor); and/or one or more mechanical input devices (e.g., a depressible input mechanism; a button; a rotatable input mechanism; a crown; and/or a dial)). Some operations in method 700 are, optionally, combined, the orders of some operations are, optionally, changed, and some operations are, optionally, omitted.

As described below, method 700 provides an intuitive way for initiating communications via a non-terrestrial network. The method reduces the cognitive burden on a user for initiating communications via a non-terrestrial network, thereby creating a more efficient human-machine interface. For battery-operated computing devices, enabling a user to initiate communications via a non-terrestrial network faster and more efficiently conserves power and increases the time between battery charges.

While the computer system (e.g., 100, 300, 500, 600, 634, 646, 654, and/or 658) is operating in a first mode of operation (e.g., the mode of operation of computer system 600 shown at FIGS. 6G, 6H, and 6O-6AJ) (e.g., a mode of operation in which the computer system is configured to and/or enabled to perform communications via a non-terrestrial communication network (e.g., via a satellite network), a mode of operation in which the computer system attempts to initiate and/or initiates communication with a non-terrestrial communication network, a mode of operation in which the computer system is unable to connect to a cellular network, a mode of operation in which the computer system is unable to connect to a WiFi network, and/or a mode of operation in which the computer system is in connection with and/or receiving a signal from a Global Positioning System (GPS)), wherein the computer system (e.g., 100, 300, 500, 600, 634, 646, 654, and/or 658) is configured to perform communications (e.g., send and/or receive communications from one or more external devices) via a non-terrestrial communication network (e.g., a satellite communication network) when operating in the first mode of operation, the computer system (e.g., 100, 300, 500, 600, 634, 646, 654, and/or 658) receives (702) a request to communicate (e.g., 650i and/or 650j) (e.g., a request to send an electronic message, such as a text message, a photo message, an audio message, and/or a video message, and/or initiate a real-time communication, such as a phone call, an audio call, and/or a video call, over a communication network, such as a cellular communication network, a WiFi communication network, and/or a satellite communication network) with an external device (e.g., 634, 646, 654, and/or 658) (e.g., the computer system receives one or more user inputs, via one or more input devices of the computer system, requesting to launch a communication application, such as a telephone application and/or a messages application, to draft a communication, to initiate transmission of a communication, and/or to send a communication to an external device).

In response to receiving the request to communicate (e.g., 650i and/or 650j) with the external device (704) (e.g., 634, 646, 654, and/or 658), wherein the external device (e.g., 634, 646, 654, and/or 658) is associated with a non-emergency number (e.g., the external device is associated with a contactable entity (e.g., a contact of a user of the computer system such as a person, agency, and/or business), where the contactable entity is not an emergency contact, is not associated with an emergency service, such as 911, and/or is not otherwise associated with providing emergency assistance as a primary function) and in accordance with a determination that a set of criteria is met (e.g., the computer system is aligned with and in communication with one or more satellites, a signal between the computer system and the one or more satellites is above a threshold signal strength, and/or the computer system is able to send and/or receive communications via the one or more satellites), the computer system (e.g., 100, 300, 500, 600, 634, 646, 654, and/or 658) initiates (706) a process for communicating with the external device (e.g., 634, 646, 654, and/or 658) via the non-terrestrial communication network (e.g., the computer system performs communication with the external device via the non-terrestrial communication network, such as a satellite communication network, attempts to perform communication with the external device via the non-terrestrial communication network, and/or sends information to a device of the non-terrestrial communication network).

In response to receiving the request to communicate (e.g., 650i and/or 650j) with the external device (704) (e.g., 634, 646, 654, and/or 658), wherein the external device (e.g., 634, 646, 654, and/or 658) is associated with a non-emergency number (e.g., the external device is associated with a contactable entity (e.g., a contact of a user of the computer system such as a person, agency, and/or business), where the contactable entity is not an emergency contact, is not associated with an emergency service, such as 911, and/or is not otherwise associated with providing emergency assistance as a primary function) and in accordance with a determination that the set of criteria is not met (e.g., the computer system is not in communication with a satellite (e.g., any satellite), the computer system is not properly aligned with a satellite (e.g., any satellite), a signal between the computer system and a satellite (e.g., any satellite) is below a threshold signal strength, and/or the computer system is unable to send and/or receive communications via a satellite (e.g., any satellite)), the computer system (e.g., 100, 300, 500, 600, 634, 646, 654, and/or 658) prompts (708) (e.g., 628 as shown at FIG. 6R) (e.g., the computer system outputs (such as by displaying a user interface object and/or a user interface, via a display generation component of the computer system, outputs speech and/or audio, via a speaker of the computer system, and/or outputs haptic feedback, via one or more haptic output devices of the computer system) that includes guidance to a user of the computer system about how to satisfy the set of criteria, such as how to properly align the computer system with a satellite so that the computer system is in communication with the satellite) a user of the computer system (e.g., 100, 300, 500, 600, 634, 646, 654, and/or 658) to connect to the non-terrestrial communication network (e.g., the computer system outputs guidance (such as visual guidance, audio guidance, and/or haptic guidance) indicating actions that the user of the computer system can take to connect to the non-terrestrial communication network, such as positioning the computer system in a predetermined orientation with respect to a satellite of the non-terrestrial communication network) without initiating the process for communicating with the external device (e.g., 634, 646, 654, and/or 658) via the non-terrestrial communication network (e.g., without the computer system performing communication with the external device via the non-terrestrial communication network, such as a satellite communication network, and/or without sending information to a device of the non-terrestrial communication network).

Initiating a process for communicating with the external device via the non-terrestrial communication or prompting the user of the computer system to connect to the non-terrestrial communication network based on a set of criteria enables the user to quickly communicate with an entity associated with the external device when the set of criteria is met and allows the user to recognize that action should be taken to connect to the non-terrestrial communication network when the set of criteria is not met, thereby providing improved visual feedback to the user, reducing the number of inputs needed to perform an operation, and/or performing an operation when a set of conditions has been met without requiring further user input.

In some embodiments, while (or, in some embodiments, in accordance with a determination that) the computer system (e.g., 100, 300, 500, 600, 634, 646, 654, and/or 658) is operating in the first mode of operation (e.g., the mode of operation of computer system 600 shown at FIGS. 6G, 6H, and 6O-6AJ), the computer system (e.g., 100, 300, 500, 600, 634, 646, 654, and/or 658) displays, via a display generation component (e.g., 602) (e.g., a display, touch-screen display, a monitor, a holographic display system, and/or a head-mounted display system) that is configured to communicate with the computer system (e.g., 100, 300, 500, 600, 634, 646, 654, and/or 658), a user interface element (e.g., 636b) (e.g., text, symbols, objects, and/or visual elements) (in some embodiments, the computer system displays the user interface element on a messaging user interface of a messaging application, such as within a conversation region of the messaging user interface) indicating (e.g., indicating via the text, symbols, objects, and/or other visual elements) that the computer system (e.g., 100, 300, 500, 600, 634, 646, 654, and/or 658) forgoes (e.g., does not) outputting notifications (e.g., visual notifications, audio notification, and/or haptic notifications) in response to receiving incoming communications (e.g., incoming text messages, photo messages, voice messages, and/or video messages) (in some embodiments, the computer system receives the incoming communications via the non-terrestrial communication network (e.g., transmitted to the computer system via a satellite of the non-terrestrial communication network)) while the computer system (e.g., 100, 300, 500, 600, 634, 646, 654, and/or 658) operates in the first mode of operation (e.g., the computer system silences and/or otherwise does not output notifications while operating in the first mode of operation). In some embodiments, the computer system forgoes displaying the user interface element in accordance with a determination that the computer system is not operating in the first mode of operation and/or in accordance with a determination that the computer system is operating in a second mode of operation that is different from the first mode of operation, such as a normal mode of operation where the computer system is configured to perform communications via a terrestrial communication network. Displaying the user interface element indicating that the computer system forgoes outputting notifications in response to receiving incoming communications while the computer system operates in the first mode of operation allows the user to recognize that they will not be alerted to incoming communications while the computer system operates in the first mode of operation, thereby providing improved visual feedback to the user.

In some embodiments, in accordance with the determination that the set of criteria is met (and, optionally, when the computer system is displaying a messaging user interface), the computer system (e.g., 100, 300, 500, 600, 634, 646, 654, and/or 658) displays, via a display generation component (e.g., 602) (e.g., a display, touch-screen display, a monitor, a holographic display system, and/or a head-mounted display system) that is configured to communicate with the computer system (e.g., 100, 300, 500, 600, 634, 646, 654, and/or 658), an indication (e.g., 620j, 620k, and/or 666a-666d) (e.g., a progress bar, a progress circle, and/or a textual indication of that M-out-of-N messages have been loaded and/or received) that the computer system (e.g., 100, 300, 500, 600, 634, 646, 654, and/or 658) is loading (e.g., downloading and/or receiving) incoming communications (e.g., incoming communications transmitted to the computer system from an external device via the non-terrestrial communication network and/or incoming communications received by the computer system via the non-terrestrial communication network). Displaying an indication that the computer system is loading incoming communications allows the user to recognize that incoming communications have been received and that the computer system is in the process of receiving the incoming communications, thereby providing improved visual feedback to the user.

In some embodiments, the computer system (e.g., 100, 300, 500, 600, 634, 646, 654, and/or 658) receives the incoming communication via the non-terrestrial communication network (e.g., the computer system receives data related to the incoming communications from a device, such as a satellite, of the non-terrestrial communication network). In response to receiving the incoming communication via the non-terrestrial communication network, the computer system (e.g., 100, 300, 500, 600, 634, 646, 654, and/or 658) displays, via the display generation component (e.g., 602), a message indicator (e.g., 620l and/or 666e) (e.g., a message, text, and/or a graphical element that includes content of the incoming communication), wherein displaying the message indicator (e.g., 620l and/or 666c) includes replacing display of the indication (e.g., 620j, 620k, and/or 666a-666d) with the message indicator (e.g., 620l and/or 666c) (e.g., the computer system ceases display of the indication at a first location of the display generation component and displays the message indicator at the first location of the display generation component). Replacing display of the indication with the message indicator allows the user to quickly view the incoming communication and recognize that the incoming communication has been received by the computer system without requiring further input from the user, thereby providing improved visual feedback to the user, reducing the number of inputs needed to perform an operation, and/or performing an operation when a set of conditions has been met without requiring further user input.

In some embodiments, while (or, in some embodiments, in accordance with a determination that) the computer system (e.g., 100, 300, 500, 600, 634, 646, 654, and/or 658) is operating in the first mode of operation (e.g., the mode of operation of computer system 600 shown at FIGS. 6G, 6H, and 6O-6AJ), the computer system (e.g., 100, 300, 500, 600, 634, 646, 654, and/or 658) displays, via a display generation component (e.g., 602) (e.g., a display, touch-screen display, a monitor, a holographic display system, and/or a head-mounted display system) that is configured to communicate with the computer system (e.g., 100, 300, 500, 600, 634, 646, 654, and/or 658), a messaging user interface (e.g., 620) (e.g., a user interface that includes one or more user interface elements corresponding to sent and/or received communications between the computer system and one or more external devices and/or includes one or more graphical user interface elements, such as a keyboard and/or a composition region, that enable the user of the computer system to input and view content of a communication configured to be sent from the computer system to one or more external devices). While the computer system (e.g., 100, 300, 500, 600, 634, 646, 654, and/or 658) is displaying the messaging user interface (e.g., 620), in accordance with a determination that a second set of criteria is met (e.g., the computer system is positioned at an orientation that causes the computer system to lose communication with a satellite of the non-terrestrial communication network and/or to cause a signal between the computer system and the satellite to have a strength that is below a threshold strength), the computer system (e.g., 100, 300, 500, 600, 634, 646, 654, and/or 658) displays, via the display generation component (e.g., 602), a prompt (e.g., 622, 622a, 622b, and/or 628) (e.g., the computer system displays a user interface object and/or a user interface, via a display generation component of the computer system that includes guidance to a user of the computer system about how to satisfy the second set of criteria, such as how to properly align the computer system with a satellite so that the computer system is in communication with the satellite) indicating that the computer system (e.g., 100, 300, 500, 600, 634, 646, 654, and/or 658) is not aligned (e.g., oriented and/or positioned with respect to the external device so that an azimuth and/or elevation of the computer system enables communication between the computer system and the external device) with an element (e.g., a satellite and/or antenna) of the non-terrestrial communication network. Displaying the prompt indicating that the computer system is not aligned with the element of the non-terrestrial communication network when a second set of criteria is met enables the user of the computer system take action to strengthen a signal between the computer system and the non-terrestrial communication network, thereby providing improved visual feedback to the user and/or performing an operation when a set of conditions has been met without requiring further user input.

In some embodiments, the prompt (e.g., 622, 622a, 622b, and/or 628) indicating that the computer system (e.g., 100, 300, 500, 600, 634, 646, 654, and/or 658) is not aligned with the element of the non-terrestrial communication network is displayed in a dynamic region (e.g., 624) (e.g., a region of the user interface that changes size and/or position relative to the display generation component over time) of the display generation component (e.g., 602). Displaying the prompt indicating that the computer system is not aligned with the element of the non-terrestrial communication network in a dynamic region of the display generation component allows the user to recognize that action should be taken to strengthen a connection with the non-terrestrial communication network, thereby providing improved visual feedback to the user.

In some embodiments, the prompt (e.g., 622, 622a, 622b, and/or 628) indicating that the computer system (e.g., 100, 300, 500, 600, 634, 646, 654, and/or 658) is not aligned with the element of the non-terrestrial communication network is displayed at a first size (e.g., the size of connection indicator 622) (e.g., a first size relative to an overall size of the display generation component) in the dynamic region (e.g., 624) of the display generation component (e.g., 602). In accordance with a determination that a third set of criteria is met (e.g., the computer system and the external device of the non-terrestrial communication network are no longer connected and/or in communication with one another), the computer system (e.g., 100, 300, 500, 600, 634, 646, 654, and/or 658) displays, via the display generation component (e.g., 602) of the computer system (e.g., 100, 300, 500, 600, 634, 646, 654, and/or 658), the prompt (e.g., 622, 622a, 622b, and/or 628) indicating that the computer system (e.g., 100, 300, 500, 600, 634, 646, 654, and/or 658) is not aligned with the element of the non-terrestrial communication network at a second size (e.g., the size of connection user interface object 628) in the dynamic region (e.g., 624) (e.g., a second size relative to the overall size of the display generation component), wherein the second size is larger than the first size (e.g., the prompt is displayed at a larger size and/or with additional information to further alert and/or inform the user of the computer system that the third set of criteria is met) (in some embodiments, the dynamic region occupies a first portion of the display generation component while displaying the prompt at the first size and the dynamic region occupies a second portion of the display generation component while displaying the prompt at the second size, where the second portion of the display generation component is larger than the first portion of the display generation component relative to an overall area of the display generation component) (in some embodiments, displaying the prompt at the second size includes changing an appearance of the prompt and/or changing information included in the prompt as compared to displaying the prompt at the first size) (in some embodiments, the prompt displayed at the second size includes additional information and/or context, such as additional guidance and/or information about how to connect to the non-terrestrial communication network, as compared to the prompt displayed at the first size). Displaying the prompt indicating that the computer system is not aligned with the element of the non-terrestrial communication network at a second size that is larger than the first size when a third set of criteria is met further alerts the user that action should be taken to connect to the non-terrestrial communication network, thereby providing improved visual feedback to the user.

In some embodiments, in response to establishing communication with the non-terrestrial communication network (e.g., a signal between the computer system and an external device, such as a satellite, of the non-terrestrial communication network is above a threshold signal strength that enables communication between the computer system and the external device), the computer system (e.g., 100, 300, 500, 600, 634, 646, 654, and/or 658) initiates a process for sending a communication (e.g., a text message, an audio message, a voice message, a video message, and/or an image) via the non-terrestrial communication network. After initiating the process for sending the communication via the non-terrestrial communication network, the computer system (e.g., 100, 300, 500, 600, 634, 646, 654, and/or 658) receives (e.g., from the second element and/or another device of the non-terrestrial communication network) a confirmation indication (e.g., 638d and/or 648d) that a second element (e.g., a satellite and/or antenna) of the non-terrestrial communication network received the communication (e.g., data indicating that the second element of the non-terrestrial communication network received the communication). In response to receiving the confirmation indication (e.g., 638d and/or 648d) that the second element received the communication, the computer system (e.g., 100, 300, 500, 600, 634, 646, 654, and/or 658) displays, via a display generation component (e.g., 602) (e.g., a display, touch-screen display, a monitor, a holographic display system, and/or a head-mounted display system) that is configured to communicate with the computer system (e.g., 100, 300, 500, 600, 634, 646, 654, and/or 658), a confirmation user interface element (e.g., 638d and/or 648d) (e.g., text, an image, an object, and/or a graphical element) confirming that the second element received the communication. Displaying the confirmation user interface element confirming that the second element received the communication allows the user to quickly recognize that the communication was received by the second element and/or that no additional action is required by the user to send the communication, thereby providing improved visual feedback to the user.

In some embodiments, the second element of the non-terrestrial communication network is a satellite of the non-terrestrial communication network, and the confirmation user interface element (e.g., 638d and/or 648d) confirming that the second element received the communication is displayed regardless of whether or not an external device (e.g., 634, 646, 654, and/or 658) (e.g., a smart phone, a smart watch, a tablet computer, a laptop computer, a desktop computer, a wearable device, and/or head-mounted device) associated with a recipient of the communication (e.g., a contact of the user of the computer system in which the user of the computer system intended to communicate) received the communication (e.g., the confirmation user interface element confirms that the communication was received by the satellite, but does not include confirmation as to whether the communication was delivered to and/or received by the external device) (in some embodiments, the confirmation user interface element does not include an indication that the external device associated with the recipient of the communication received the communication, but does include an indication that the second element of the non-terrestrial communication network received the communication). Displaying the confirmation user interface element regardless of whether or not the external device associated with a recipient of the communication received the communication allows the user to recognize that the communication may not be received by the recipient right away and/or that the communication may be received by the recipient after additional time from the communication being received by the second element, thereby providing improved visual feedback to the user.

In some embodiments, after initiating the process for communicating with the external device (e.g., 634, 646, 654, and/or 658) via the non-terrestrial communication network, the computer system (e.g., 100, 300, 500, 600, 634, 646, 654, and/or 658) transmits a communication (e.g., a text message, an audio message, a voice message, a video message, and/or an image) via the non-terrestrial communication network (e.g., sending the communication to an external device, such as a satellite, of the non-terrestrial communication network so that the non-terrestrial communication network can deliver and/or cause delivery of the communication to a recipient device). After transmitting the communication via the non-terrestrial communication network and in accordance with a determination that the communication is a first type of communication (e.g., a short messaging system message and/or a text message), the computer system (e.g., 100, 300, 500, 600, 634, 646, 654, and/or 658) initiates a process for enabling the computer system (e.g., 100, 300, 500, 600, 634, 646, 654, and/or 658) to receive one or more second communications from the external device (e.g., 634, 646, 654, and/or 658) (e.g., initiating a process to enable and/or configure the computer system to receive communications from the external device and/or initiating a process to enable and/or configure the external device to send communications to the computer system via the non-terrestrial communication network) for a predetermined amount of time (e.g., one day and/or 24 hours from the time at which the communication was transmitted from the computer system and/or from the time at which the communication was received by the external device). Initiating a process for enabling communication between the computer system and the external device for a predetermined amount of time in accordance with the determination that the communication is a first type of communication allows the user to communicate with a recipient associated with the external device that may not otherwise be able to reach the user, thereby performing an operation when a set of conditions has been met without requiring further user input.

In some embodiments, prior to transmitting the communication via the non-terrestrial communication network, the computer system (e.g., 100, 300, 500, 600, 634, 646, 654, and/or 658) displays, via a display generation component (e.g., 602) (e.g., a display, touch-screen display, a monitor, a holographic display system, and/or a head-mounted display system) that is configured to communicate with the computer system (e.g., 100, 300, 500, 600, 634, 646, 654, and/or 658), a communication indicator (e.g., 648c) (e.g., text, graphical objects, and/or user interface elements that indicate that sending the communication opens and/or activates a time window for the recipient of the communication, such as a device associated with the recipient, to send communications to the computer system via the non-terrestrial communication network) indicating that transmission (e.g., the computer system sending and/or a user input that causes the computer system to send the communication) of the communication initiates a time window (e.g., a predetermined amount of time, such as one day and/or 24 hours, from the time at which the communication is sent from the computer system, the time at which the communication is received by a device, such as a satellite, of the non-terrestrial communication network, and/or the time at which a device associated with a recipient of the communication receives the communication) for the computer system (e.g., 100, 300, 500, 600, 634, 646, 654, and/or 658) to receive (e.g., receive via the non-terrestrial communication network) communications (e.g., text messages, images, audio messages, voice messages, and/or video messages) from the external device (e.g., 634, 646, 654, and/or 658) (e.g., a device associated with a recipient of the communication) for the predetermined amount of time (e.g., the computer system cannot receive communications from the external device after the predetermined amount of time has ended and/or the external device cannot send and/or transmit communications to the computer system after the predetermined amount of time has ended). In some embodiments, after the predetermined amount of time has ended and the computer system transmits another communication to the external device, the external device is configured to transmit communications to the computer system via the non-terrestrial network for the predetermined amount of time. Displaying a communication indicator indicating that the transmission of the communication initiates a time window for the computer system to receive communications from the external device for the predetermined amount of time allows the user to recognize that the recipient associated with the external device can communicate with the user for a limited amount of time, thereby providing improved visual feedback to the user.

In some embodiments, after initiating the process for communicating with the external device (e.g., 634, 646, 654, and/or 658) via the non-terrestrial communication network and in accordance with a determination that the computer system (e.g., 100, 300, 500, 600, 634, 646, 654, and/or 658) is in communication with (e.g., a paired relationship, such as a relationship in which a first type of data is transmitted between the computer system and a second external device) a second external device (e.g., 668) (e.g., a smart phone, a smart watch, a tablet computer, a laptop computer, a desktop computer, a wearable device, and/or head-mounted device), wherein the second external device (e.g., 668) is not configured to establish a connection with the non-terrestrial communication network (e.g., the second external device does not include hardware and/or software that enables the second external device to connect with, send communications via, and/or receive communications via the non-terrestrial communication network) (in some embodiments, the second external device does not include hardware and/or software that enables the second external device to communicate with a cellular communication network), the computer system (e.g., 100, 300, 500, 600, 634, 646, 654, and/or 658) causes (e.g., sending data and/or information to the second external device) the second external device (e.g., 668) to display, via a display generation component (e.g., a display, touch-screen display, a monitor, a holographic display system, and/or a head-mounted display system) of the second external device (e.g., 668), one or more indications (e.g., 668b, 668c, 668d, and/or 668c) (e.g., text, graphical user interface objects, and/or graphical elements) of communications that are sent or received by the computer system (e.g., 100, 300, 500, 600, 634, 646, 654, and/or 658) via the non-terrestrial communication network (e.g., the display generation component of the second external device displays messages and/or indications of messages sent and/or received by the computer system via the non-terrestrial communication network). In some embodiments, the second external device displays the one or more indications related to communications of the computer system that are sent or received via the non-terrestrial communication network, but the second external device cannot, itself, send or receive communications via the non-terrestrial communication network (e.g., the second external device communicates with the computer system and receives data and/or information related to communications that are sent and/or received by the computer system via the non-terrestrial communication network). Causing the second external device to display one or more indications of communications that are sent or received by the computer system via the non-terrestrial communication network allows the user to confirm that communications have been sent and/or received by the computer system using an additional device, thereby providing improved visual feedback to the user.

In some embodiments, in accordance with a determination that the computer system (e.g., 100, 300, 500, 600, 634, 646, 654, and/or 658) has communicated with (e.g., sent communications to and/or received communications from the external device) the external device (e.g., 634, 646, 654, and/or 658) within a predetermined amount of time (e.g., one day, one week, two weeks, three weeks, four weeks, or 30 days from a current time), initiating the process for communicating with the external device (e.g., 634, 646, 654, and/or 658) via the non-terrestrial communication network includes the computer system (e.g., 100, 300, 500, 600, 634, 646, 654, and/or 658) enabling communication (e.g., sending and/or configuring the computer system to send the communication) with the external device (e.g., 634, 646, 654, and/or 658) via a first communication protocol (e.g., short message service, an encrypted messaging service, a short range communication, and/or a direct wireless communication technique). In accordance with a determination that the computer system (e.g., 100, 300, 500, 600, 634, 646, 654, and/or 658) has not communicated with the external device (e.g., 634, 646, 654, and/or 658) within the predetermined amount of time (e.g., the computer system has not sent and/or received communications with the external device within the predetermined amount of time from a current time), initiating the process for communicating with the external device (e.g., 634, 646, 654, and/or 658) via the non-terrestrial communication network includes the computer system (e.g., 100, 300, 500, 600, 634, 646, 654, and/or 658) enabling communication (e.g., sending and/or configuring the computer system to send the communication) with the external device (e.g., 634, 646, 654, and/or 658) via a second communication protocol (e.g., short message service, an encrypted messaging service, a short range communication, and/or a direct wireless communication technique) (in some embodiments, the second communication protocol is different from the first communication protocol). Initiating the process for communicating with the external device via the non-terrestrial communication network including enabling communication with the external device via a first communication protocol or enabling communication with the external device via a second communication protocol based on whether the computer system has communicated with the external device within a predetermined amount of time allows the user to communicate with the external device regardless of when the computer system last communicated with the external device and/or enables the computer system to communicate with the external device via a preferred communication protocol with external devices with which the computer system frequently communicates, thereby providing improved visual feedback to the user, reducing the number of inputs needed to perform an operation, and/or performing an operation when a set of conditions has been met without requiring further user input.

In some embodiments, in accordance with a determination that the request to communicate with the external device (e.g., 634, 646, 654, and/or 658) via the non-terrestrial communication network includes a request to communicate with multiple external devices (e.g., multiple external devices associated with message user interface object 620h) (e.g., the external device and one or more additional external devices that are different from the external device, such as a group message and/or a request to communicate with a group of external devices) via the non-terrestrial communication network and in accordance with the determination that the set of criteria is met, the computer system (e.g., 100, 300, 500, 600, 634, 646, 654, and/or 658) forgoes initiating the process for communicating with the external device (e.g., 634, 646, 654, and/or 658) via the non-terrestrial communication network (e.g., the computer system does not initiate the communication with the external device and the one or more additional external devices via the non-terrestrial communication network because the request to communicate includes a request to communicate with more than one external device). Forgoing initiating the process for communicating with the external device via the non-terrestrial communication network when the request to communicate includes a request to communicate with multiple external devices allows the computer system to conserve data and/or battery power by initiating communications with a single external device at a time, thereby conserving battery life and increasing the amount of time between battery charges.

Note that details of the processes described above with respect to method 700 (e.g., FIG. 7) are also applicable in an analogous manner to the methods described below. For example, methods 800 and 900 optionally include one or more of the characteristics of the various methods described above with reference to method 700. For example, the computer system of method 700 can initiate operation in the first mode of operation via method 800. As another example, the computer system of method 900 can be utilized to communicate with the computer system of method 700. For brevity, these details are not repeated below.

FIG. 8 is a flow diagram illustrating a method for transitioning between operating modes using a computer system in accordance with some embodiments. Method 800 is performed at a computer system (e.g., 100, 300, 500, 600, 634, 646, 654, and/or 658) (e.g., a smart phone, a smart watch, a tablet computer, a laptop computer, a desktop computer, a wearable device, and/or head-mounted device) that is in communication with (e.g., includes and/or is connected to) a display generation component (e.g., 602) (e.g., a display, touch-screen display, a monitor, a holographic display system, and/or a head-mounted display system) and one or more input devices (e.g., 602 and/or 658a) (e.g., a touch-sensitive surface (e.g., a touch-sensitive display); a mouse; a keyboard; a remote control; a visual input device (e.g., one or more cameras such as, e.g., an infrared camera, a depth camera, a visible light camera, and/or a gaze tracking camera); an audio input device (e.g., a microphone); a biometric sensor (e.g., a fingerprint sensor, a face identification sensor, a gaze tracking sensor, and/or an iris identification sensor); and/or one or more mechanical input devices (e.g., a depressible input mechanism; a button; a rotatable input mechanism; a crown; and/or a dial)). Some operations in method 800 are, optionally, combined, the orders of some operations are, optionally, changed, and some operations are, optionally, omitted.

As described below, method 800 provides an intuitive way for transitioning between operating modes. The method reduces the cognitive burden on a user for transitioning between operating modes, thereby creating a more efficient human-machine interface. For battery-operated computing devices, enabling a user to transition between operating modes faster and more efficiently conserves power and increases the time between battery charges.

While the computer system (e.g., 100, 300, 500, 600, 634, 646, 654, and/or 658) is operating in a first mode of operation (802) (e.g., the mode of operation of computer system 600 shown at FIGS. 6A, 6I, and/or 6AL-6AP) (e.g., a normal mode of operation in which the computer system is configured to send and/or receive communications, sends and/or receives communications, and/or attempts to send and/or receive communications via one or more terrestrial communication networks, such as a cellular network and/or a WiFi network), wherein the computer system (e.g., 100, 300, 500, 600, 634, 646, 654, and/or 658) is configured to communicate with an external device (e.g., 634, 646, 654, and/or 658) via a terrestrial communication network (e.g., a cellular network and/or a WiFi network) while operating in the first mode of operation (e.g., the mode of operation of computer system 600 shown at FIGS. 6A, 6I, and/or 6AL-6AP) and in accordance with a determination that a set of communication criteria is met (e.g., the computer system is not receiving a signal from a terrestrial communication network (e.g., a cellular network and/or a WiFi network), the computer system does not have cell service, a signal from a terrestrial communication network does not satisfy a set of connection criteria (e.g., the signal from the terrestrial communication network does not satisfy strength and/or consistency criteria), the computer system is unable to establish a communication connection with a terrestrial communication network, a connection with a terrestrial communication network does not satisfy a set of communication criteria (e.g., the connection between the computer system and the terrestrial communication network does not satisfy strength and/or consistency criteria), and/or the computer system is in communication with a Global Positioning System (GPS)), the computer system (e.g., 100, 300, 500, 600, 634, 646, 654, and/or 658) displays (804), via the display generation component (e.g., 602) a first selectable user interface element (806) (e.g., 606c and/or 626b) (e.g., a first button, selectable icon, affordance, and/or user-interactive user interface element) that, when selected via user input (e.g., a touch input, an air gesture, a voice command, and/or a button press), causes the computer system (e.g., 100, 300, 500, 600, 634, 646, 654, and/or 658) to activate a second mode of operation (e.g., the mode of operation of computer system 600 shown at FIGS. 6G, 6H, and/or 6O-6AJ) (e.g., a mode of operation in which the computer system is configured to and/or enabled to perform communications via a non-terrestrial communication network (e.g., via a satellite communication network), a mode of operation in which the computer system attempts to initiate and/or initiates communication with a non-terrestrial communication network, a mode of operation in which the computer system is unable to connect to a cellular network, a mode of operation in which the computer system is unable to connect to a WiFi network, and/or a mode of operation in which the computer system is in connection with and/or receiving a signal from a Global Positioning System (GPS)) different from the first mode of operation (e.g., the mode of operation of computer system 600 shown at FIGS. 6A, 6I, and/or 6AL-6AP), wherein the computer system (e.g., 100, 300, 500, 600, 634, 646, 654, and/or 658) is configured to communicate with the external device (e.g., 634, 646, 654, and/or 658) via a non-terrestrial communication network (e.g., a satellite network) while operating in the second mode of operation (e.g., the mode of operation of computer system 600 shown at FIGS. 6G, 6H, and/or 6O-6AJ) and a second selectable user interface element (808) (e.g., 606b and/or 626c) (e.g., a second button, selectable icon, affordance, and/or user-interactive user interface element) that, when selected via user input (e.g., a touch input, an air gesture, a voice command, and/or a button press), causes the computer system (e.g., 100, 300, 500, 600, 634, 646, 654, and/or 658) to maintain operation in the first mode of operation (e.g., the mode of operation of computer system 600 shown at FIGS. 6A, 6I, and/or 6AL-6AP) (e.g., forgo activation of the second mode of operation and/or continue to operate in the first mode of operation). In some embodiments, the computer system is not configured to communicate via non-terrestrial communication while operating in the first mode of operation (e.g., the computer system cannot communicate via non-terrestrial communication while operating in the first mode of operation). In some embodiments, the computer system is configured and/or enabled to communicate via the terrestrial communication network while operating in the second mode of operation (e.g., if the terrestrial communication network becomes available).

The computer system (e.g., 100, 300, 500, 600, 634, 646, 654, and/or 658) detects (810), via the one or more input devices (e.g., 602 and/or 658a), a first user input (e.g., 650a, 650b, and/or 650f) (e.g., a touch input, an air gesture, a voice command, and/or a button press).

In response to detecting the first user input (812) (e.g., 650a, 650b, and/or 650f) and in accordance with a determination that the first user input (e.g., 650a, 650b, and/or 650f) corresponds to the first selectable user interface element (e.g., 606c and/or 626b) (e.g., the first user input includes selection of the first selectable user interface element) (814), the computer system (e.g., 100, 300, 500, 600, 634, 646, 654, and/or 658) transitions (816) operation of the computer system (e.g., 100, 300, 500, 600, 634, 646, 654, and/or 658) from the first mode of operation (e.g., the mode of operation of computer system 600 shown at FIGS. 6A, 6I, and/or 6AL-6AP) to the second mode of operation (e.g., the mode of operation of computer system 600 shown at FIGS. 6G, 6H, and/or 6O-6AJ) (e.g., the computer system switches from the first mode of operation to the second mode of operation, changes from the first mode of operation to the second mode of operation, and/or deactivates the first mode of operation and activates the second mode of operation) and the computer system (e.g., 100, 300, 500, 600, 634, 646, 654, and/or 658) prompts (818) (e.g., via 614 and/or 628) (e.g., the computer system outputs (such as by displaying a user interface object and/or a user interface, via a display generation component of the computer system, outputs speech and/or audio, via a speaker of the computer system, and/or outputs haptic feedback, via one or more haptic output devices of the computer system) that includes guidance to a user of the computer system about how to satisfy the set of criteria, such as how to properly align the computer system with a satellite so that the computer system is in communication with the satellite) a user of the computer system (e.g., 100, 300, 500, 600, 634, 646, 654, and/or 658) to position the computer system (e.g., 100, 300, 500, 600, 634, 646, 654, and/or 658) in a predetermined orientation (e.g., a predetermined orientation that facilitates a connection between the computer system and the non-terrestrial communication network and/or enables the computer system to connect to the non-terrestrial communication network) (e.g., the computer system outputs guidance (such as visual guidance, audio guidance, and/or haptic guidance) indicating actions that the user of the computer system can take to position the computer system with respect to a satellite of the non-terrestrial communication network so that the computer system can connect to the non-terrestrial communication network). In some embodiments, the predetermined orientation includes a range of orientations (e.g., a range of angles and/or positions).

In response to detecting the first user input (812) (e.g., 650a, 650b, and/or 650f) and in accordance with a determination that the first user input corresponds to the second selectable user interface element (e.g., 606b and/or 626c) (e.g., the first user input includes selection of the second selectable user interface element), the computer system (e.g., 100, 300, 500, 600, 634, 646, 654, and/or 658) maintains (820) operation of the computer system (e.g., 100, 300, 500, 600, 634, 646, 654, and/or 658) in the first mode of operation (e.g., the mode of operation of computer system 600 shown at FIGS. 6A, 6I, and/or 6AL-6AP) (e.g., the computer system forgoes transitioning operation from the first mode of operation to the second mode of operation and/or continues operation in the first mode of operation).

Displaying the first selectable user interface element and the second selectable user interface element in accordance with the determination that the set of communication criteria is met enables the computer system to notify the user that various communication networks are not available without requiring additional user input, thereby providing improved visual feedback to the user, reducing the number of inputs needed to perform an operation, and/or performing an operation when a set of conditions has been met without requiring further user input. In addition, transitioning operation of the computer system from the first mode of operation to the second mode of operation or maintaining operation of the computer system in the first mode of operation based on selection of the first selectable user interface element or the second selectable user interface element, respectively, allows the user of the computer system to quickly select an option to transition the operation mode of the computer system to send communications, thereby reducing the number of inputs needed to perform an operation.

In some embodiments, the first selectable user interface element (e.g., 606c and/or 626b) and the second selectable user interface element (e.g., 606b and/or 626c) are displayed on a first user interface (e.g., 604) associated with a locked state (e.g., a state in which the computer system requires and/or prompts a user for authentication information, such as a passcode and/or biometric information, in order to provide access to one or more functions of the computer system) of the computer system (e.g., 100, 300, 500, 600, 634, 646, 654, and/or 658) (e.g., a user interface that is displayed while the computer system is in a locked state). Displaying the first selectable user interface element and the second selectable user interface element on a first user interface associated with a locked state of the computer system automatically provides options to the user regarding the operating mode of the computer system and/or notifies the user about the availability of one or more communication networks, thereby providing improved visual feedback to the user, reducing the number of inputs needed to perform an operation, and/or performing an operation when a set of conditions has been met without requiring further user input.

In some embodiments, while (or, in some embodiments, in accordance with a determination that) the computer system (e.g., 100, 300, 500, 600, 634, 646, 654, and/or 658) is operating in the first mode of operation (e.g., the mode of operation of computer system 600 shown at FIGS. 6A, 6I, and/or 6AL-6AP), the computer system (e.g., 100, 300, 500, 600, 634, 646, 654, and/or 658) detects, via the one or more input devices (e.g., 602 and/or 658a), a second user input (e.g., 650s and/or 650w) (e.g., a touch input, an air gesture, a voice command, and/or a button press). In response to detecting the second user input (e.g., 650s and/or 650w) and in accordance with the determination that the set of communication criteria is met, the computer system (e.g., 100, 300, 500, 600, 634, 646, 654, and/or 658) displays, via the display generation component (e.g., 602), a second user interface (e.g., 670, 674, and/or 676) (e.g., a user interface that includes one or more selectable user interface elements that are configured to control, such as adjust, enable, or disable, various functions of the computer system) that includes a third selectable user interface element (e.g., 670b, 674a, and/or 678a) (e.g., a third button, selectable icon, affordance, and/or user-interactive user interface element) that, when selected via user input, causes the computer system (e.g., 100, 300, 500, 600, 634, 646, 654, and/or 658) to activate the second mode of operation (e.g., the mode of operation of computer system 600 shown at FIGS. 6G, 6H, and/or 6O-6AJ) (e.g., transition operation of the computer system from the first mode of operation to the second mode of operation and/or cease operation of the computer system in the first mode of operation and activate operation of the computer system in second mode of operation) (in some embodiments, in response to detecting user input corresponding to selection of the third selectable user interface element, the computer system activates the second mode of operation, deactivates the first mode of operation, and/or transitions operation from the first mode of operation to the second mode of operation). Displaying the second user interface that includes the third selectable user interface element allows the user to quickly navigate between user interfaces to activate the second mode of operation, thereby reducing the number of inputs needed to perform an operation.

In some embodiments, displaying the third selectable user interface element (e.g., 670b) includes the computer system (e.g., 100, 300, 500, 600, 634, 646, 654, and/or 658) displaying the third selectable user interface element (e.g., 670b) at a first location (e.g., the location shown at FIG. 6AI) (e.g., a first position, region, and/or area) of the second user interface (e.g., 670). In response to detecting the second user input (e.g., 650s and/or 650w) and in accordance with the determination that the set of communication criteria is not met, the computer system (e.g., 100, 300, 500, 600, 634, 646, 654, and/or 658) displays, via the display generation component (e.g., 602), the second user interface (e.g., 670) that includes a selectable function-selection user interface element (e.g., 670e) (e.g., a button, selectable icon, affordance, and/or user-interactive user interface element) without displaying the third selectable user interface element (e.g., 670b) (e.g., the computer system does not display the second user interface having the third selectable user interface element when the set of communication criteria is not met), wherein the selectable function-selection user interface element (e.g., 670e) is different from the third selectable user interface element (e.g., 670b) (e.g., selection of the selectable function-selection user interface element causes the computer system to perform a function that is different from activating the second mode of operation of the computer system), and wherein the selectable function-selection user interface element (e.g., 670e) is displayed at the first location (e.g., the location shown at FIGS. 6AK and 6AL) of the second user interface (e.g., 670) (e.g., the selectable function-selection user interface element is displayed at the first location of the second user interface when the set of communication criteria is not met and the third selectable user interface element is displayed at the first location of the second user interface when the set of communication criteria is met). In some embodiments, while the computer system displays the second user interface when the set of communication criteria is not met, the computer system displays the selectable function-selection user interface element at the first location of the second user interface, and while the computer system maintains display of the second user interface and determines that the set of communication criteria is met, the computer system replaces display of the selectable function-selection user interface element with the third selectable user interface element at the first position of the second user interface. Displaying the third selectable user interface element at the first location of the second user interface when the set of communication criteria is met and displaying the selectable function-selection user interface element at the first location of the second user interface when the set of communication criteria is not met provides information to the user about the availability of various communication networks and/or allows the user to quickly control a relevant function of the computer system, thereby providing improved visual feedback to the user, reducing the number of inputs needed to perform an operation, and/or performing an operation when a set of conditions has been met without requiring further user input.

In some embodiments, the third selectable user interface element (e.g., 670b, 674a, and/or 678a) includes an indication (e.g., text, an object, an image, an icon, and/or a graphical element) of a connection status (e.g., whether the computer system is operating in the first mode of operation or the second mode of operation, whether the computer system is enabled to receive communications from one or more external devices while operating in the second mode of operation, whether the computer system is in communication with a terrestrial communication network, and/or whether the computer system is in communication with a satellite of a non-terrestrial communication network) of the computer system (e.g., 100, 300, 500, 600, 634, 646, 654, and/or 658) with respect to the first mode of operation (e.g., the mode of operation of computer system 600 shown at FIGS. 6A, 6I, and/or 6AL-6AP) or the second mode of operation (e.g., the mode of operation of computer system 600 shown at FIGS. 6G, 6H, and/or 6O-6AJ) (e.g., the third selectable user interface object indicates whether the computer system is operating in the first mode of operation or the second mode of operation and/or whether the computer system can transition operation between the first mode of operation and the second mode of operation). In some embodiments, in accordance with a determination that the connection status of the computer system is in a first state, the indication includes a first appearance; and in accordance with a determination that the connection status of the computer system is in a second state that is different from the first state, the indication includes a second appearance that is different from the first appearance. The third selectable user interface element including the indication of the status of the computer system with respect to the first mode of operation or the second mode of operation provides information to the user about the availability of various communication networks and/or allows the user to quickly control a relevant function of the computer system, thereby providing improved visual feedback to the user, reducing the number of inputs needed to perform an operation, and/or performing an operation when a set of conditions has been met without requiring further user input.

In some embodiments, in response to detecting an input (e.g., 650t) corresponding to selection of the third selectable user interface object (e.g., 670b, 674a, and/or 678a) and in accordance with a determination that a first set of connection criteria is met (e.g., the computer system is currently operating in the first mode of operation and/or the set of communication is criteria is met), the computer system (e.g., 100, 300, 500, 600, 634, 646, 654, and/or 658) activates the second mode of operation (e.g., the mode of operation of computer system 600 shown at FIGS. 6G, 6H, and/or 6O-6AJ). In response to detecting an input (e.g., 650t) corresponding to selection of the third selectable user interface object (e.g., 670b, 674a, and/or 678a) and in accordance with a determination that a second set of connection criteria is met (e.g., the computer system is currently operating in the second mode of operation, the set of communication criteria is met, the computer system is in communication with one or more satellites of the non-terrestrial communication network, the computer system is not in communication with one or more satellites of the non-terrestrial communication network, the computer system is configured to receive communications via the non-terrestrial communication network, and/or the computer system is not configured to receive communications via the non-terrestrial communication network), the computer system (e.g., 100, 300, 500, 600, 634, 646, 654, and/or 658) performs a function that is different from activating (e.g., without activating) the second mode of operation (e.g., the mode of operation of computer system 600 shown at FIGS. 6G, 6H, and/or 6O-6AJ) (e.g., the computer system enables and/or disables a function for receiving communications via the non-terrestrial communication network, the computer system connects and/or disconnects from a satellite of the non-terrestrial communication network, the computer system activates the first mode of operation and/or deactivates the second mode of operation, and/or the computer system activates a test mode that enables a user of the computer system to test and/or practice the second mode of operation). Activating the second mode of operation or performing a function that is different from activating the second mode of operation based on whether a first set of connection criteria is met or a second set of connection criteria is met enables the computer system to perform different functions in response to input selecting the third selectable user interface object based on a context of the computer system, thereby reducing the number of inputs needed to perform an operation, and/or performing an operation when a set of conditions has been met without requiring further user input.

In some embodiments, while (or, in some embodiments, in accordance with a determination that) the computer system (e.g., 100, 300, 500, 600, 634, 646, 654, and/or 658) is operating in the first mode of operation (e.g., the mode of operation of computer system 600 shown at FIGS. 6A, 6I, and/or 6AL-6AP) and in accordance with a determination that a set of criteria is met (e.g., the set of communication criteria is not met, the computer system is in an active state and displaying a user interface associated with the active state, the computer system is not in an always on display mode, the computer system is not in a locked state, and/or the computer system is not displaying a user interface associated with the locked state), the computer system (e.g., 100, 300, 500, 600, 634, 646, 654, and/or 658) displays, via the display generation component (e.g., 602), the first selectable user interface element (e.g., 606c and/or 626b) within a dynamic region (e.g., 624) (e.g., a region of the user interface that changes size and/or position relative to the display generation component over time and/or based on context of the computer system) of the display generation component (e.g., 602). Displaying the first selectable user interface element within the dynamic region of the display generation component enables the user to quickly activate the second mode of operation and/or notifies the user about the availability of different communication networks, thereby providing improved visual feedback to the user, reducing the number of inputs needed to perform an operation, and/or performing an operation when a set of conditions has been met without requiring further user input.

In some embodiments, while (or, in some embodiments, in accordance with a determination that) the computer system (e.g., 100, 300, 500, 600, 634, 646, 654, and/or 658) is operating in the first mode of operation (e.g., the mode of operation of computer system 600 shown at FIGS. 6A, 6I, and/or 6AL-6AP), the computer system (e.g., 100, 300, 500, 600, 634, 646, 654, and/or 658) detects, via the one or more input devices (e.g., 602 and/or 658a), one or more third user inputs 650v) (e.g., one or more touch inputs, air gestures, voice commands, and/or button presses) requesting to display a settings user interface (e.g., 674 and/or 676) (e.g., a user interface that includes one or more selectable user interface objects that are configured to control, adjust, enable, and/or disable various functions of the computer system) (in some embodiments, the settings user interface is different from the second user interface). In response to detecting the one or more third user inputs (e.g., 650v), the computer system (e.g., 100, 300, 500, 600, 634, 646, 654, and/or 658) displays the settings user interface (e.g., 674 and/or 676), wherein the settings user interface includes a selectable mode-selection user interface element (e.g., 678a) (e.g., a button, selectable icon, affordance, and/or user-interactive user interface element) that, when selected via one or more user inputs, causes the computer system (e.g., 100, 300, 500, 600, 634, 646, 654, and/or 658) to initiate activation of the second mode of operation (e.g., the mode of operation of computer system 600 shown at FIGS. 6G, 6H, and/or 6O-6AJ) (e.g., transition operation of the computer system from the first mode of operation to the second mode of operation and/or cease operation of the computer system in the first mode of operation and activate operation of the computer system in second mode of operation) (in some embodiments, in response to detecting user input corresponding to selection of the selectable mode-selection user interface element, the computer system initiates a process for activating the second mode of operation, such as deactivating the first mode of operation and initiating the second mode of operation). Displaying the settings user interface that includes the selectable mode-selection user interface object allows the user to quickly navigate to a user interface and activate the second mode of operation, thereby reducing the number of inputs needed to perform an operation.

In some embodiments, the set of communication criteria includes a first criterion (e.g., a cellular service criterion) that is met when the computer system (e.g., 100, 300, 500, 600, 634, 646, 654, and/or 658) is not in communication with a cellular communication network (e.g., as shown at FIG. 6B) (e.g., the computer system is not receiving a signal from a cellular network (e.g., any cellular network), the computer system does not have cell service, a signal from a cellular network does not satisfy a set of connection criteria (e.g., the signal from the cellular network does not satisfy strength and/or consistency criteria), the computer system is unable to establish a communication connection with a cellular network, a connection with a cellular network does not satisfy a set of communication criteria (e.g., the connection between the computer system and the cellular network does not satisfy strength and/or consistency criteria)). The set of communication criteria including a first criterion that is met when the computer system is not in communication with a cellular communication network allows the user to communicate with an external device when cellular communication is not available, thereby providing the computer system with additional functionality and improving an ability of a user of the computer system to communicate under various circumstances.

In some embodiments, the set of communication criteria includes a second criterion (e.g., a WiFi criterion) that is met when the computer system (e.g., 100, 300, 500, 600, 634, 646, 654, and/or 658) is not in communication with a WiFi communication network (e.g., as shown at FIG. 6B) (e.g., the computer system is not receiving a signal from a WiFi network (e.g., any WiFi network), a signal from a WiFi network does not satisfy a set of connection criteria (e.g., the signal from the WiFi network does not satisfy strength and/or consistency criteria), the computer system is unable to establish a communication connection with a WiFi network, a connection with a WiFi network does not satisfy a set of communication criteria (e.g., the connection between the computer system and the WiFi network does not satisfy strength and/or consistency criteria)). The set of communication criteria including a second criterion that is met when the computer system is not in communication with a WiFi communication network allows the user to communicate with an external device when WiFi communication is not available, thereby providing the computer system with additional functionality and improving an ability of a user of the computer system to communicate under various circumstances.

In some embodiments, the set of communication criteria includes a third criterion (e.g., a GPS criterion) that is met when the computer system (e.g., 100, 300, 500, 600, 634, 646, 654, and/or 658) is in communication with a global positioning system (e.g., the computer system is transmitting and/or receiving information from a global positioning system, such as a satellite of a global positioning system). The set of communication criteria including a third criterion that is met when the computer system is in communication with a global positioning system enables the computer system to determine that the computer system is likely outdoors and/or that the user is more likely to activate the second mode of operation, thereby providing the computer system with additional functionality and improving an ability of a user of the computer system to communicate under various circumstances.

In some embodiments, in response to detecting the first user input (e.g., 650a, 650b, and/or 650f), wherein the first user input (e.g., 650a, 650b, and/or 650f) corresponds to selection of the second selectable user interface element (e.g., 606b and/or 626c), the computer system (e.g., 100, 300, 500, 600, 634, 646, 654, and/or 658) ceases to display the first selectable user interface element (e.g., 606c and/or 626b) and the second selectable user interface element (e.g., 606b and/or 626c) (e.g., the computer system removes display of and/or stops displaying the first selectable user interface element and the second selectable user interface element on a user interface displayed on the display generation component of the computer system). After ceasing to display the first selectable user interface element (e.g., 606c and/or 626b) and the second selectable user interface element (e.g., 606b and/or 626c) and in accordance with the determination that the set of communication criteria is met, the computer system (e.g., 100, 300, 500, 600, 634, 646, 654, and/or 658) displays (e.g., re-displaying), via the display generation component (e.g., 602), the first selectable user interface element (e.g., 606c and/or 626b) and the second selectable user interface element (e.g., 606b and/or 626c) (e.g., the computer system re-displays the first selectable user interface element and the second selectable user interface element when the set of communication criteria is met even though the user of the computer system chose to forgo activation of the second mode of operation). In some embodiments, the computer system re-displays the first selectable user interface element and the second selectable user interface element in accordance with the determination that a set of communication criteria is met after the computer system ceased to display the first selectable user interface element and the second selectable user interface element for a predetermined amount of time, such as 1 minute, 5 minutes, 10 minutes, 15 minutes, 30 minutes, or one hour. Displaying the first selectable user interface element and the second selectable user interface element when the set of communication criteria is met for a subsequent time notifies the user about the availability of various communication networks without requiring additional user input and/or allows the user to quickly transition operation of the computer system to the second mode of operation, thereby providing improved visual feedback to the user, reducing the number of inputs needed to perform an operation, and/or performing an operation when a set of conditions has been met without requiring further user input.

In some embodiments, after transitioning operation of the computer system (e.g., 100, 300, 500, 600, 634, 646, 654, and/or 658) from the first mode of operation (e.g., the mode of operation of computer system 600 shown at FIGS. 6A, 6I, and/or 6AL-6AP) to the second mode of operation (e.g., the mode of operation of computer system 600 shown at FIGS. 6G, 6H, and/or 6O-6AJ), the computer system (e.g., 100, 300, 500, 600, 634, 646, 654, and/or 658) displays, via the display generation component (e.g., 602), one or more user interface elements (e.g., 610a-610d and/or 618a-618d) (e.g., one or more buttons, selectable icons, affordances, and/or user-interactive user interface elements) indicating respective available functions of the computer system (e.g., 100, 300, 500, 600, 634, 646, 654, and/or 658) while operating in the second mode of operation (e.g., the mode of operation of computer system 600 shown at FIGS. 6G, 6H, and/or 6O-6AJ) (e.g., the one or more user interface elements indicate which functions, features, and/or operations the computer system is configured to perform while operating in the second mode of operation) (in some embodiments, the computer system is limited as to which functions, features, and/or operations that it can perform while the computer system operates in the second mode of operation). Displaying one or more user interface elements indicating the respective available functions of the computer system while operating in the second mode of operation notifies the user about the capabilities and/or limitations of the computer system while operating in the second mode of operation, thereby providing improved visual feedback to the user.

In some embodiments, the computer system (e.g., 100, 300, 500, 600, 634, 646, 654, and/or 658) detects, via the one or more input devices (e.g., 602 and/or 658a), an input (e.g., 650c) (e.g., a touch input, an air gesture, a voice command, and/or a button press) corresponding to selection of a first user interface element (e.g., 618a) (e.g., a button, selectable icon, affordance, and/or user-interactive user interface element) of the one or more user interface elements (e.g., 610a-610d and/or 618a-618d). In response to detecting the input (e.g., 650c) corresponding to selection of the first user interface element (e.g., 618a), the computer system (e.g., 100, 300, 500, 600, 634, 646, 654, and/or 658) initiates a respective function associated with the first user interface element (e.g., 618a) (e.g., the computer system performs and/or initiates a process to perform a function, feature, and/or operation that is associated with and/or corresponds to the first user interface element, where the function, feature, and/or operation is available to be performed by the computer system while the computer system operates in the second mode of operation). Initiating the respective function associated with the first user interface element in response to detecting the input allows the user of the computer system to efficiently activate an available function of the computer system while the computer system operates in the second mode of operation, thereby reducing the number of inputs needed to perform an operation.

In some embodiments, after transitioning operation of the computer system (e.g., 100, 300, 500, 600, 634, 646, 654, and/or 658) from the first mode of operation (e.g., the mode of operation of computer system 600 shown at FIGS. 6A, 6I, and/or 6AL-6AP) to the second mode of operation (e.g., the mode of operation of computer system 600 shown at FIGS. 6G, 6H, and/or 6O-6AJ), the computer system (e.g., 100, 300, 500, 600, 634, 646, 654, and/or 658) initiates a process for connecting to a satellite of the non-terrestrial communication network (e.g., displaying a user interface and/or one or more user interface elements that guide and/or facilitate a user of the computer system to perform one or more actions that enable the computer system to connect and/or initiate communication with a satellite of the non-terrestrial communication network). In some embodiments, the computer system initiates the process for connecting to the satellite of the non-terrestrial network by prompting the user to position and/or orient the computer system at a predetermined position that is based on a current position of the satellite so that the computer system can establish a connection and/or communication with the satellite. Initiating the process for connecting to the satellite of the non-terrestrial communication network after transitioning from the first mode of operation to the second mode of operation allows the user to more quickly begin communicating via the non-terrestrial network without providing additional user inputs, thereby reducing the number of inputs needed to perform an operation and/or performing an operation when a set of conditions has been met without requiring further user input.

In some embodiments, after transitioning operation of the computer system (e.g., 100, 300, 500, 600, 634, 646, 654, and/or 658) from the first mode of operation (e.g., the mode of operation of computer system 600 shown at FIGS. 6A, 6I, and/or 6AL-6AP) to the second mode of operation (e.g., the mode of operation of computer system 600 shown at FIGS. 6G, 6H, and/or 6O-6AJ) and prior to connecting to the satellite of the non-terrestrial communication network, the computer system (e.g., 100, 300, 500, 600, 634, 646, 654, and/or 658) forgoes receiving communications from an external device (e.g., 634, 646, 654, and/or 658) (e.g., while the computer system is in the second mode of operation, but not connected to the satellite of the non-terrestrial communication network, the computer system does not receive (and/or is not enabled to receive) communications that are sent to the computer system from external devices). Forgoing receiving communications from the external device before connecting to the satellite of the non-terrestrial communication network enables the computer system to conserve battery power, thereby improving battery life and increasing the amount of time between battery charges.

In some embodiments, after connecting to the satellite of the non-terrestrial communication network and in accordance with a determination that a set of inactivity criteria is met (e.g., displaying lock screen user interface 604) (e.g., the computer system determines that user inputs and/or user interaction with the computer system have not been detected for a predetermined amount of time, such as 30 seconds, 1 minute, 2 minutes, 3 minutes, 5 minutes, or 10 minutes), the computer system (e.g., 100, 300, 500, 600, 634, 646, 654, and/or 658) initiates a process for disconnecting from the satellite of the non-terrestrial communication network (e.g., the computer system ceases communication with the satellite of the non-terrestrial network, such as by deactivating a transmitter and/or other hardware component) while maintaining operation of the computer system (e.g., 100, 300, 500, 600, 634, 646, 654, and/or 658) in the second mode of operation (e.g., the mode of operation of computer system 600 shown at FIGS. 6G, 6H, and/or 6O-6AJ) (e.g., the computer system remains in the second mode of operation even though the computer system is disconnected from the satellite, such that the computer system can re-connect to the satellite at another time and/or the computer system does not attempt to initiate communication with a terrestrial communication network). Initiating a process for disconnecting from the satellite of the non-terrestrial communication network when the set of inactivity criteria is met enables the computer system to conserve battery power while operating in the second mode of operation, thereby improving battery life and increasing the amount of time between battery charges.

In some embodiments, after disconnecting from the satellite of the non-terrestrial communication network (and while the computer system is operating in the second mode of operation), the computer system (e.g., 100, 300, 500, 600, 634, 646, 654, and/or 658) detects, via the one or more input devices (e.g., 602 and/or 658a), an input (e.g., an input to display user interface 620) (e.g., a touch input, an air gesture, a voice command, and/or a button press) requesting to display a communication user interface (e.g., 620) (e.g., a messaging user interface, a telephone user interface, a video call user interface, and/or an email user interface). In response to detecting the input requesting to display the communication user interface (e.g., 620), the computer system (e.g., 100, 300, 500, 600, 634, 646, 654, and/or 658) displays, via the display generation component (e.g., 602), the communication user interface (e.g., 620), the computer system (e.g., 100, 300, 500, 600, 634, 646, 654, and/or 658) initiates a process to connect (e.g., re-connect) to the satellite of the non-terrestrial communication network (e.g., the computer system establishes communication with the satellite, such as by activating a transmitter and/or another hardware component) (in some embodiments, the computer system displays a user interface and/or one or more user interface elements that guide and/or facilitate a user of the computer system to perform one or more actions that enable the computer system to connect and/or initiate communication with a satellite of the non-terrestrial communication network), and the computer system (e.g., 100, 300, 500, 600, 634, 646, 654, and/or 658) initiates a process for receiving communications (e.g., text messages, emails, audio messages, images, voice messages, and/or video messages) from one or more external devices (e.g., 634, 646, 654, and/or 658) (e.g., sent and/or transmitted via one or more respective external devices) that were sent to the computer system (e.g., 100, 300, 500, 600, 634, 646, 654, and/or 658) while the computer system (e.g., 100, 300, 500, 600, 634, 646, 654, and/or 658) was disconnected from the satellite of the non-terrestrial communication network (e.g., the computer system receives data and/or information from the satellite related to the communications received while the computer system was not connected to the satellite and displays indications of the received communications in the communication user interface). Initiating a process for connecting to the satellite of the non-terrestrial communication network and initiating a process for receiving communications that were sent to the computer system while the computer system was disconnected from the satellite in response to detecting the user input allows the computer system to receive prior communications while the computer system was conserving battery power while disconnected from the satellite, thereby improving battery life and increasing the amount of time between battery charges.

In some embodiments, after transitioning operation of the computer system (e.g., 100, 300, 500, 600, 634, 646, 654, and/or 658) from the first mode of operation (e.g., the mode of operation of computer system 600 shown at FIGS. 6A, 6I, and/or 6AL-6AP) to the second mode of operation (e.g., the mode of operation of computer system 600 shown at FIGS. 6G, 6H, and/or 6O-6AJ), the computer system (e.g., 100, 300, 500, 600, 634, 646, 654, and/or 658) detects, via the one or more input devices (e.g., 602 and/or 658a), an input (e.g., 650s) corresponding to a request to display a control user interface (e.g., 670) (e.g., a touch input, an air gesture, a voice command, and/or a button press). In response to detecting the input (e.g., 650s) corresponding to the request to display the control user interface (e.g., 670), the computer system (e.g., 100, 300, 500, 600, 634, 646, 654, and/or 658) displays, via the display generation component (e.g., 602), the control user interface (e.g., 670) (e.g., a user interface that includes one or more selectable user interface elements that are configured to control, such as adjust, enable, or disable, various functions of the computer system) (in some embodiments, the control user interface and the second user interface are the same user interface), wherein displaying the control user interface (e.g., 670) includes, in accordance with a determination that the computer system (e.g., 100, 300, 500, 600, 634, 646, 654, and/or 658) is not connected to the satellite of the non-terrestrial communication network (e.g., the computer system is operating in the second mode of operation, but the computer system is not in communication with and/or the computer system is not connected to the satellite of the non-terrestrial communication network), the computer system (e.g., 100, 300, 500, 600, 634, 646, 654, and/or 658) displaying, via the display generation component (e.g., 602), a selectable connection user interface element (e.g., 670b) (e.g., a button, selectable icon, affordance, and/or user-interactive user interface element) that, when selected via user input (e.g., 650t), initiates a process for connecting to the satellite of the non-terrestrial communication network (e.g., the computer system establishes communication with the satellite, such as by activating a transmitter and/or another hardware component) (in some embodiments, the computer system displays a user interface and/or one or more user interface elements that guide and/or facilitate a user of the computer system to perform one or more actions that enable the computer system to connect and/or initiate communication with a satellite of the non-terrestrial communication network) (in some embodiments, in response to detecting user input corresponding to selection of the selectable connection user interface element, the computer system initiates a process for connecting to the satellite of the non-terrestrial communication network). Displaying the selectable connection user interface element of the control user interface when the computer system is not connected to the satellite of the non-terrestrial communication network allows the user to efficiently connect and/or re-connect to the satellite so that the computer system can send and/or receive communications while operating in the second mode of operation, thereby reducing the number of inputs needed to perform an operation.

In some embodiments, after connecting to the satellite of the non-terrestrial communication network (e.g., the computer system is in communication with and/or a signal between the computer system and the satellite of the non-terrestrial communication network is above a threshold signal strength) and in accordance with a determination that a set of locking criteria is met (e.g., computer system 600 displays lock screen user interface 604) (e.g., the computer system detects one or more user inputs corresponding to a request to cause the computer system to activate a locked mode and/or the computer system detects an absence of one or more user inputs for a predetermined amount of time, such that the computer system activates the locked mode), the computer system (e.g., 100, 300, 500, 600, 634, 646, 654, and/or 658) initiates a process to lock the computer system (e.g., 100, 300, 500, 600, 634, 646, 654, and/or 658) (e.g., the computer system activates a locked mode of the computer system, where the locked mode of the computer system requires and/or prompts a user to provide authentication information, such as a passcode and/or biometric information, to enable one or more functions of the computer system) and the computer system (e.g., 100, 300, 500, 600, 634, 646, 654, and/or 658) initiates a process to disconnect from the satellite of the non-terrestrial communication network (e.g., the computer system ceases communication with the satellite of the non-terrestrial network, such as by deactivating a transmitter and/or other hardware component) (in some embodiments, the computer system maintains operation in the second mode of operation while disconnecting and/or after disconnecting from the satellite of the non-terrestrial communication network). Initiating a process to disconnect from the satellite of the non-terrestrial communication network when the set of locking criteria is met enables the computer system to conserve power while operating in the second mode of operation and in the locked state, thereby improving battery life and increasing the amount of time between battery charges.

In some embodiments, while the computer system (e.g., 100, 300, 500, 600, 634, 646, 654, and/or 658) is in communication with the satellite of the non-terrestrial communication network (e.g., the computer system is connected to and/or a signal between the computer system and the satellite of the non-terrestrial communication network is above a threshold signal strength) and in accordance with a determination that a set of alignment criteria is met (e.g., the computer system detects that a position of the computer system relative to the satellite of the non-terrestrial communication network is causing a signal between the computer system and the satellite of the non-terrestrial communication network to fall below a threshold signal strength), the computer system (e.g., 100, 300, 500, 600, 634, 646, 654, and/or 658) displays, via the display generation component (e.g., 602), an alignment user interface (e.g., 612, 614, and/or 628) (e.g., a user interface that includes one or more user interface elements, such as text and/or graphical objects, that provide guidance to a user of the computer system about how to position and/or orient the computer system so that the signal between the computer system and the satellite of the non-terrestrial communication network can increase to and/or above the threshold signal strength) that includes an indication (e.g., 612a and/or 628a) (e.g., text and/or graphical user interface objects) prompting the user to adjust a position of the computer system (e.g., 100, 300, 500, 600, 634, 646, 654, and/or 658) (e.g., physically move the computer system in a predetermined direction and/or directions), wherein the alignment user interface (e.g., 612, 614, and/or 628) is displayed in a dynamic region (e.g., 624) (e.g., a region of the user interface that changes size and/or position relative to the display generation component over time and/or based on context of the computer system) of the display generation component (e.g., 602). Displaying the alignment user interface that includes an indication prompting the user to adjust the position of the computer system when the set of alignment criteria is met, where the alignment user interface is displayed in a dynamic region of the display generation component, notifies the user that a connection and/or signal between the computer system and the satellite is below a threshold level and/or allows the user to quickly increase the connection and/or signal strength between the computer system and the satellite, thereby providing improved visual feedback to the user, reducing the number of inputs needed to perform an operation, and/or performing an operation when a set of conditions has been met without requiring further user input.

In some embodiments, while the computer system (e.g., 100, 300, 500, 600, 634, 646, 654, and/or 658) is operating in the second mode of operation (e.g., the mode of operation of computer system 600 shown at FIGS. 6G, 6H, and/or 6O-6AJ) and in accordance with a determination that the set of communication criteria has not been met for a predetermined amount of time (e.g., a continuous and/or uninterrupted time period that occurs while the computer system is operating in the second mode of operation, such as 30 minutes, 1 hour, or 2 hours), the computer system (e.g., 100, 300, 500, 600, 634, 646, 654, and/or 658) initiates a process to transition the computer system (e.g., 100, 300, 500, 600, 634, 646, 654, and/or 658) from operation in the second mode of operation (e.g., the mode of operation of computer system 600 shown at FIGS. 6G, 6H, and/or 6O-6AJ) to operation in the first mode of operation (e.g., the mode of operation of computer system 600 shown at FIGS. 6A, 6I, and/or 6AL-6AP) (e.g., cease operation of the computer system in the second mode of operation and activate operation of the computer system in the first mode of operation; and/or the computer system transitions from operation in the second mode of operation to operation in the first mode of operation). Initiating the process to transition the computer system from the second mode of operation to the first mode of operation when the set of communication criteria has not been met for a predetermined amount of time enables the computer system to automatically change an operation mode of the computer system that provides the most efficient and/or effective way to send and/or receive communications without requiring additional user input, thereby reducing the number of inputs needed to perform an operation and/or performing an operation when a set of conditions has been met without requiring further user input.

In some embodiments, while the computer system (e.g., 100, 300, 500, 600, 634, 646, 654, and/or 658) is operating in the second mode of operation (e.g., the mode of operation of computer system 600 shown at FIGS. 6G, 6H, and/or 6O-6AJ), the computer system (e.g., 100, 300, 500, 600, 634, 646, 654, and/or 658) detects, via the one or more input devices (e.g., 602 and/or 658a), an input (e.g., and input to display messaging user interface 620) (e.g., a touch input, an air gesture, a voice command, and/or a button press) requesting to launch a communications application (e.g., an application associated with messaging user interface 620) (e.g., a messaging application, an email application, a telephone application, and/or a video call application). In response to detecting the input requesting to launch the communications application (e.g., an application associated with messaging user interface 620), the computer system (e.g., 100, 300, 500, 600, 634, 646, 654, and/or 658) displays, via the display generation component (e.g., 602), a communications user interface (e.g., 620) (e.g., a messaging user interface, an email user interface, a telephone user interface, and/or a video call user interface) of the communications application (e.g., an application associated with messaging user interface). In response to detecting an input (e.g., 650i and/or 650j) (e.g., a touch input, an air gesture, a voice command, and/or a button press) requesting to send or receive a communication (e.g., a text message, an image, an email, a voice message, an audio message, and/or a video message) via the communications application (e.g., a request to transmit a communication to an external device, such as a user input corresponding to a send button and/or a call button in the communications user interface of the communication application) and in accordance with a determination that the set of communication criteria is not met, the computer system (e.g., 100, 300, 500, 600, 634, 646, 654, and/or 658) initiates a process to transition the computer system (e.g., 100, 300, 500, 600, 634, 646, 654, and/or 658) from operation in the second mode of operation (e.g., the mode of operation of computer system 600 shown at FIGS. 6G, 6H, and/or 6O-6AJ) to operation in the first mode of operation (e.g., the mode of operation of computer system 600 shown at FIGS. 6A, 6I, and/or 6AL-6AP) (e.g., cease operation of the computer system in the second mode of operation and activate operation of the computer system in first mode of operation). Initiating the process to transition the computer system from the second mode of operation to the first mode of operation in response to the input and in accordance with the determination that the set of communication criteria is not met allows the computer system to automatically change the operating mode of the computer system to the most efficient and/or effective mode of operation for sending and/or receiving communications without requiring additional user input, thereby reducing the number of inputs needed to perform an operation and/or performing an operation when a set of conditions has been met without requiring further user input.

In some embodiments, while the computer system (e.g., 100, 300, 500, 600, 634, 646, 654, and/or 658) is operating in the second mode of operation (e.g., the mode of operation of computer system 600 shown at FIGS. 6G, 6H, and/or 6O-6AJ), the computer system (e.g., 100, 300, 500, 600, 634, 646, 654, and/or 658) displays, via the display generation component (e.g., 602), a selectable configuration user interface element (e.g., 670b) (e.g., a button, selectable icon, affordance, and/or user-interactive user interface element). In response to detecting, via the one or more input devices (e.g., 602 and/or 658a), an input (e.g., 650t) (e.g., a touch input, an air gesture, a voice command, and/or a button press) corresponding to selection of the selectable configuration user interface element (e.g., 670b), the computer system (e.g., 100, 300, 500, 600, 634, 646, 654, and/or 658) displays, via the display generation component (e.g., 602), a selectable deactivation user interface element (e.g., 672b) (e.g., a button, selectable icon, affordance, and/or user-interactive user interface element) that, when selected via user input (e.g., 650u), initiates a process to deactivate the second mode of operation (e.g., the mode of operation of computer system 600 shown at FIGS. 6G, 6H, and/or 6O-6AJ) (e.g., transition operation of the computer system from the second mode of operation to the first mode of operation and/or cease operation of the computer system in the second mode of operation and activate operation of the computer system in first mode of operation) (in some embodiments, in response to detecting user input corresponding to selection of the selectable deactivation user interface element, the computer system deactivates the second mode of operation and/or initiates the first mode of operation), and a selectable satellite user interface element (e.g., 672a) (e.g., a button, selectable icon, affordance, and/or user-interactive user interface element) that, when selected via user input, initiates a process to disconnect the computer system (e.g., 100, 300, 500, 600, 634, 646, 654, and/or 658) from a satellite of the non-terrestrial communication network (e.g., the computer system ceases communication with the satellite of the non-terrestrial network, such as by deactivating a transmitter and/or other hardware component) and maintain operation of the computer system (e.g., 100, 300, 500, 600, 634, 646, 654, and/or 658) in the second mode of operation (e.g., the mode of operation of computer system 600 shown at FIGS. 6G, 6H, and/or 6O-6AJ) (e.g., the computer system remains in the second mode of operation even though the computer system is disconnected from the satellite, such that the computer system can re-connect to the satellite at another time and/or the computer system does not attempt to initiate communication with a terrestrial communication network) (in some embodiments, in response to detecting user input corresponding to selection of the selectable satellite user interface element, the computer system initiates a process for disconnecting the computer system from the satellite of the non-terrestrial communication network and maintains operation of the computer system in the second mode of operation). Displaying the selectable deactivation user interface element and the selectable satellite user interface element in response to detecting the input allows the user to determine whether to completely deactivate the second mode of operation or to maintain operation of the computer system in the second mode of operation and disconnect from the satellite of the non-terrestrial communication network without requiring additional user input, thereby reducing the number of inputs needed to perform an operation.

In some embodiments, while the computer system (e.g., 100, 300, 500, 600, 634, 646, 654, and/or 658) is operating in the first mode of operation (e.g., the mode of operation of computer system 600 shown at FIGS. 6A, 6I, and/or 6AL-6AP), the computer system (e.g., 100, 300, 500, 600, 634, 646, 654, and/or 658) detects, via the one or more input devices (e.g., 602 and/or 658a), an input (e.g., 650x and/or 650y) (e.g., a touch input, an air gesture, a voice command, and/or a button press) corresponding to a request to activate a test mode. In response to detecting the input (e.g., 650x and/or 650y) corresponding to a request to activate the test mode and in accordance with a determination that the set of communication criteria is not met, the computer system (e.g., 100, 300, 500, 600, 634, 646, 654, and/or 658) initiates a process to activate the test mode, wherein initiating the process to activate the test mode includes prompting (e.g., displaying user interface 684) the user of the computer system (e.g., 100, 300, 500, 600, 634, 646, 654, and/or 658) to position the computer system (e.g., 100, 300, 500, 600, 634, 646, 654, and/or 658) in a second predetermined orientation (e.g., the computer system initiates and/or activates a mode of operation of the computer system that simulates and/or enables a user of the computer system to test the second mode of operation of the computer system while the computer system is not operating in the second mode of operation, such as while the computer system is connected to a terrestrial communication network). In some embodiments, the test mode of the second mode of operation of the computer system includes the computer system displaying one or more user interfaces that prompt the user of the computer system to position and/or orient the computer system in a predetermined orientation to simulate a connection between the computer system and a satellite of the non-terrestrial communication network in a way that the computer system would prompt the user while the computer system is operating in the second mode of operation. In some embodiments, the test mode of operation of the computer system enables the user of the computer system to practice and/or try the second mode of operation while the computer system maintains a connection with a terrestrial communication network, such as a cellular communication network and/or a WiFi communication network. Initiating the process to activate the test mode allows the user of the computer system to practice and/or test the second mode of operation while the computer system maintains operation in the first mode of operation so that the user of the computer system can quickly and efficiently activate the second mode of operation when desired, thereby reducing the number of inputs needed to perform an operation.

In some embodiments, the test mode includes the computer system (e.g., 100, 300, 500, 600, 634, 646, 654, and/or 658) displaying, via the display generation component (e.g., 602), one or more third user interfaces (e.g., 680 and/or 684) that are not displayed while the computer system (e.g., 100, 300, 500, 600, 634, 646, 654, and/or 658) is operating in the second mode of operation (e.g., one or more user interfaces having a first appearance that include one or more user interface elements that prompt the user to perform one or more actions and/or that provide information about the second mode of operation of the computer system) (in some embodiments, the second mode of operation of the computer system includes displaying, via the display generation component, one or more fourth user interfaces having a second appearance, different from the first appearance (e.g., the one or more fourth user interfaces include a different appearance, different content, and/or different indications than the one or more third user interfaces so that the user of the computer system can identify and/or recognize that the one or more third user interfaces relate to the test mode of the second mode of operation as opposed to the second mode of operation)). Displaying the one or more third user interfaces while in the test mode that are not displayed while the computer system operates in the second mode of operation allows the user to recognize that the test mode of the second mode of operation is different from the second mode of operation, thereby providing improved visual feedback to the user.

In some embodiments, the input (e.g., 650x and/or 650y) corresponding to the request to activate the test mode includes an input (e.g., a touch input, an air gesture, a voice command, and/or a button press) corresponding to a selectable activation user interface element (e.g., a button, selectable icon, affordance, and/or user-interactive user interface element) of a control user interface (e.g., 670) (e.g., a user interface that includes one or more selectable user interface elements that are configured to control, such as adjust, enable, or disable, various functions of the computer system) (in some embodiments, the control user interface and the second user interface are the same user interface). Initiating the process to activate the test mode in response to the input corresponding to the selectable test mode activation user interface element of the control user interface allows the user to quickly navigate between user interfaces to activate the second mode of operation, thereby reducing the number of inputs needed to perform an operation.

Note that details of the processes described above with respect to method 800 (e.g., FIG. 8) are also applicable in an analogous manner to the methods described above/below. For example, methods 700 and 900 optionally include one or more of the characteristics of the various methods described above with reference to method 800. For example, the computer system of method 700 can initiate operation in the first mode of operation via method 800. As another example, the computer system of method 900 can be utilized to communicate with the computer system of method 800. For brevity, these details are not repeated below.

FIG. 9 is a flow diagram illustrating a method for initiating communications using a computer system in accordance with some embodiments. Method 900 is performed at a computer system (e.g., 100, 300, 500, 600, 634, 646, 654, and/or 658) (e.g., a smart phone, a smart watch, a tablet computer, a laptop computer, a desktop computer, a wearable device, and/or head-mounted device). In some embodiments, the computer system (e.g., 100, 300, 500, 600, 634, 646, 654, and/or 658) is in communication with (e.g., includes and/or is connected to) a display generation component (e.g., 602) (e.g., a display, touch-screen display, a monitor, a holographic display system, and/or a head-mounted display system) and/or one or more input devices (e.g., 602 and/or 658a) (e.g., a touch-sensitive surface (e.g., a touch-sensitive display); a mouse; a keyboard; a remote control; a visual input device (e.g., one or more cameras such as, e.g., an infrared camera, a depth camera, a visible light camera, and/or a gaze tracking camera); an audio input device (e.g., a microphone); a biometric sensor (e.g., a fingerprint sensor, a face identification sensor, a gaze tracking sensor, and/or an iris identification sensor); and/or one or more mechanical input devices (e.g., a depressible input mechanism; a button; a rotatable input mechanism; a crown; and/or a dial)). Some operations in method 900 are, optionally, combined, the orders of some operations are, optionally, changed, and some operations are, optionally, omitted.

As described below, method 900 provides an intuitive way for initiating communications. The method reduces the cognitive burden on a user for initiating communications, thereby creating a more efficient human-machine interface. For battery-operated computing devices, enabling a user to initiate communications faster and more efficiently conserves power and increases the time between battery charges.

In response to a request (e.g., 650l) to send a communication (e.g., a request to send an electronic message, such as a text message, a photo message, a voice message, and/or a video message, and/or initiate a real-time communication, such as a phone call, an audio call, and/or a video call, over a communication network, such as a cellular communication network, a WiFi communication network, and/or a satellite communication network) to an external device (902) (e.g., the computer system receives one or more user inputs, via one or more input devices of the computer system, requesting to draft a communication and/or to send a communication to an external device that is different from the computer system) and in accordance with a determination that the external device (e.g., 600) is operating in a first mode of operation (e.g., the mode of operation of computer system 600 shown at FIGS. 6G, 6H, and/or 6O-6AJ) (e.g., a mode of operation in which the computer system is configured to and/or enabled to perform communications via a non-terrestrial communication network (e.g., via a satellite communication network), a mode of operation in which the computer system attempts to initiate and/or initiates communication with a non-terrestrial communication network, a mode of operation in which the computer system is unable to connect to a cellular network, a mode of operation in which the computer system is unable to connect to a WiFi network, and/or a mode of operation in which the computer system is in connection with and/or receiving a signal from a Global Positioning System (GPS)), the computer system (e.g., 100, 300, 500, 600, 634, 646, 654, and/or 658) prompts (904) (e.g., displays prompt 656g) (e.g., the computer system outputs (such as by displaying a user interface object and/or a user interface, via a display generation component of the computer system, outputting speech and/or audio, via a speaker of the computer system, and/or outputting haptic feedback, via one or more haptic output devices of the computer system) that provides guidance to a user of the computer system to perform and/or provide a predetermined user input) a user of the computer system (e.g., 100, 300, 500, 600, 634, 646, 654, and/or 658) to provide an input (e.g., 650m) (e.g., a touch input, an air gesture, a voice command, and/or a button press) to confirm sending the communication to the external device (e.g., 600) (e.g., confirm that the user of the computer system intends to send the communication while the external device is operating in the first mode of operation) via a first communication protocol (e.g., via a non-terrestrial communication network, such as a satellite communication network).

In response to the request (e.g., 650l) to send the communication to the external device (902) (e.g., 600) and in accordance with a determination that the external device (e.g., 600) is not operating in the first mode of operation (906) (e.g., the mode of operation of computer system 600 shown at FIGS. 6A, 6I, and/or 6AL-6AP) (e.g., the external device is operating in a normal mode of operation in which the computer system is configured to send and/or receive communications, sends and/or receives communications, and/or attempts to send and/or receive communications via one or more terrestrial networks, such as a cellular network and/or a WiFi network), the computer system (e.g., 100, 300, 500, 600, 634, 646, 654, and/or 658) forgoes (908) prompting (e.g., does not display prompt 656g) the user to provide a user input (e.g., 650m) to confirm sending the communication to the external device (e.g., 600) via the first communication protocol; and the computer system (e.g., 100, 300, 500, 600, 634, 646, 654, and/or 658) sends (910) the communication to the external device (e.g., 600) via a second communication protocol (e.g., a terrestrial communication network, such as a cellular network and/or a WiFi network) different from the first communication protocol.

Prompting the user of the computer system to provide an input to confirm sending the communication to the external device via the first communication protocol in accordance with the determination that the external device is operating in the first mode of operation automatically notifies the user that the external device is operating in the first mode of operation without requiring additional user input and/or provides confirmation that the user intends to send the communication to the external device while the external device is operating in the first mode of operation, thereby providing improved visual feedback to the user, reducing the number of inputs needed to perform an operation, and/or performing an operation when a set of conditions has been met without requiring further user input.

In some embodiments, prior to prompting (e.g., displaying prompt 656g) the user of the computer system (e.g., 100, 300, 500, 600, 634, 646, 654, and/or 658) to provide the input (e.g., 650m) to confirm sending the communication to the external device (e.g., 600) (and, optionally, in accordance with the determination that the external device is operating in the first mode of operation) and in accordance with a determination that a set of one or more communication criteria is met (e.g., the external device is operating in the first mode of operation and/or the external device is associated with a first type of contactable entity), the computer system (e.g., 100, 300, 500, 600, 634, 646, 654, and/or 658) displays, via a display generation component (e.g., 602) (e.g., a display, touch-screen display, a monitor, a holographic display system, and/or a head-mounted display system) that is configured to communicate with the computer system (e.g., 100, 300, 500, 600, 634, 646, 654, and/or 658), a status indicator (e.g., 636c and/or 636d) (e.g., text, graphical user interface elements, graphical objects, and/or images) indicating that the external device (e.g., 600) is operating in the first mode of operation (e.g., the mode of operation of computer system 600 shown at FIGS. 6G, 6H, and/or 6O-6AJ) (e.g., the status indicator informs the user of the computer system that the external device is operating in the first mode of operation so that the user of the computer system can determine whether to continue with sending the communication). In some embodiments, prior to prompting the user of the computer system to provide the input to confirm sending the communication to the external device: in accordance with a determination that the set of one or more communication criteria is not met (e.g., the external device is not operating in the first mode of operation and/or the external device is not associated with the first type of contactable entity), the computer system forgoes displaying the status indicator indicating that the external device is operating in the first mode of operation. Displaying the status indicator indicating that the external device is operating in the first mode of operation in accordance with the determination that the set of communication criteria is met notifies the user that the external device is operating in the first mode of operation, thereby providing improved visual feedback to the user.

In some embodiments, prior to prompting (e.g., displaying prompt 656g) the user of the computer system (e.g., 100, 300, 500, 600, 634, 646, 654, and/or 658) to provide the input (e.g., 650m) to confirm sending the communication to the external device (e.g., 600) (and, optionally, in accordance with the determination that the external device is operating in the first mode of operation) and in accordance with a determination that the set of one or more communication criteria is not met, wherein the set of one or more communication criteria is not met when the external device (e.g., 600) is associated with a contactable entity of a first type (e.g., the contactable entity satisfies a set of criteria, the contactable entity is a contact with which the user of the computer system infrequently communicates, such as a contactable entity with which the user of the computer system has not communicated with within a predetermined length of time, a predetermined number of times, a predetermined number of times within a predetermined length of time, and/or within a predetermined frequency, and/or a contact that the user of the computer system has not assigned a predetermined designation), the computer system (e.g., 100, 300, 500, 600, 634, 646, 654, and/or 658) forgoes display of (e.g., the computer system does not display) the status indicator (e.g., 636c and/or 636d) indicating that the external device (e.g., 600) is operating in the first mode of operation (e.g., the mode of operation of computer system 600 shown at FIGS. 6G, 6H, and/or 6O-6AJ). In some embodiments, the computer system displays the status indicator indicating that the external device is operating in the first mode of operation only for contactable entities with which the user of the computer system frequently communications and/or contactable entities that the user of the computer system has assigned a predetermined designation. Forgoing display of the status indicator indicating that the external device is operating in the first mode of operation in accordance with the determination that the external device is associated with a contactable entity of the first type of the user of the computer system allows the computer system to conserve battery power by displaying the status indicator for contactable entities having a particular designation, thereby improving battery life and increasing the amount of time between battery charges.

In some embodiments, in response to detecting, via one or more input devices (e.g., 602 and/or 658a) (e.g., a touch-sensitive surface (e.g., a touch-sensitive display); a mouse; a keyboard; a remote control; a visual input device (e.g., one or more cameras such as, e.g., an infrared camera, a depth camera, a visible light camera, and/or a gaze tracking camera); an audio input device (e.g., a microphone); a biometric sensor (e.g., a fingerprint sensor, a face identification sensor, a gaze tracking sensor, and/or an iris identification sensor); and/or one or more mechanical input devices (e.g., a depressible input mechanism; a button; a rotatable input mechanism; a crown; and/or a dial)) configured to communicate with the computer system (e.g., 100, 300, 500, 600, 634, 646, 654, and/or 658), a user input (e.g., 650m) corresponding to the input to confirm sending the communication to the external device (e.g., 600) via the first communication protocol (e.g., the user of the computer system provided the user input confirming the sending of the communication), the computer system (e.g., 100, 300, 500, 600, 634, 646, 654, and/or 658) initiates a process to send the communication to the external device (e.g., 600) (e.g., via the first communication protocol). After sending the communication to the external device (e.g., 600) and in accordance with the determination that the external device (e.g., 600) is associated with the contactable entity of the first type, the computer system (e.g., 100, 300, 500, 600, 634, 646, 654, and/or 658) displays, via the display generation component, the status indicator (e.g., 636c, 636d, and/or 656h) indicating that the external device (e.g., 600) is operating in the first mode of operation (e.g., the mode of operation of computer system 600 shown at FIGS. 6G, 6H, and/or 6O-6AJ) (e.g., the computer system displays the status indicator after sending the communication when the external device is associated with the contactable entity of the first type of the user of the computer system). Displaying the status indicator indicating that the external device is operating in the first mode of operation after sending the communication to the external device and in accordance with the determination that the external device is associated with the contactable entity of the first type of the user of the computer system notifies the user that the external device is operating in the first mode of operation, thereby providing improved visual feedback to the user.

In some embodiments, prior to prompting (e.g., displaying prompt 656g) the user of the computer system (e.g., 100, 300, 500, 600, 634, 646, 654, and/or 658) to provide the input (e.g., 650m) to confirm sending the communication to the external device (e.g., 600) via the first communication protocol (and, optionally, in response to the request to send the communication to the external device), the computer system (e.g., 100, 300, 500, 600, 634, 646, 654, and/or 658) displays, via a display generation component (e.g., 602) (e.g., a display, touch-screen display, a monitor, a holographic display system, and/or a head-mounted display system) that is configured to communicate with the computer system (e.g., 100, 300, 500, 600, 634, 646, 654, and/or 658), an indication (e.g., 656d) of a character count of the communication (e.g., a number of characters, such as alphanumeric characters and/or special characters, included in a message of the communication and/or a number of input characters in the message of the communication out of a total number of available characters for the message of the communication). Displaying the indication of the character count of the communication allows the user to further recognize that the external device is operating in the first mode of operation and to conserve the amount of data and/or information included in the communication to conserve battery power, thereby providing improved visual feedback to the user, improving battery life, and/or increasing the amount of time between battery charges.

In some embodiments, after sending the communication to the external device (e.g., 600) via the first communication protocol and in accordance with a determination that the communication was delivered to an intermediate device (e.g., a satellite) associated with the first communication protocol (e.g., the computer system receives information from the intermediate device confirming that the intermediate device received the communication), the computer system (e.g., 100, 300, 500, 600, 634, 646, 654, and/or 658) displays, via a display generation component (e.g., 602) (e.g., a display, touch-screen display, a monitor, a holographic display system, and/or a head-mounted display system) that is configured to communicate with the computer system (e.g., 100, 300, 500, 600, 634, 646, 654, and/or 658), an indication (e.g., 656j) (e.g., text, images, and/or graphical user interface elements) that the communication was delivered to (e.g., received by) the intermediate device associated with the first communication protocol. In some embodiments, the indication that the communication was delivered to the intermediate device associated with the first communication protocol does not include an indication that the communication was delivered to and/or received by the external device. In some embodiments, after sending the communication to the external device via the first communication protocol and in accordance with a determination that the communication was not delivered to the intermediate device associated with the first communication protocol, the computer system forgoes display of the indication that the communication was delivered to the intermediate device associated with the first communication protocol. Displaying the indication that the communication was delivered to the intermediate device associated with the first communication protocol notifies the user that the communication was delivered to the intermediate device, thereby providing improved visual feedback to the user.

In some embodiments, after sending the communication to the external device (e.g., 600) via the second communication protocol (e.g., before the communication is delivered and/or received by the external device) and in accordance with a determination that the external device (e.g., 600 transitioned to the first mode of operation (e.g., the mode of operation of computer system 600 shown at FIGS. 6G, 6H, and/or 6O-6AJ) prior to the external device (e.g., 600) receiving the communication via the second communication protocol (e.g., the external device received one or more user inputs requesting to transition operation of the external device from a second mode of operation to the first mode of operation before the external device received the communication via the second communication protocol), the computer system (e.g., 100, 300, 500, 600, 634, 646, 654, and/or 658) prompts (e.g., displays prompt 656g) (e.g., the computer system outputs (such as by displaying a user interface object and/or a user interface, via a display generation component of the computer system, outputting speech and/or audio, via a speaker of the computer system, and/or outputting haptic feedback, via one or more haptic output devices of the computer system) that provides guidance to a user of the computer system to perform and/or provide a predetermined user input) the user of the computer system (e.g., 100, 300, 500, 600, 634, 646, 654, and/or 658) to provide the input (e.g., 650m) (e.g., a touch input, an air gesture, a voice command, and/or a button press) to confirm sending the communication to the external device (e.g., 600) (e.g., confirm that the user of the computer system intends to send the communication while the external device is operating in the first mode of operation) via the first communication protocol. Prompting the user of the computer system to provide the input to confirm sending the communication to the external device via the first communication protocol in accordance with the determination that the external device transitioned to the first mode of operation prior to receiving the communication via the second communication protocol notifies the user that the external device is now operating in the first mode of operation without requiring additional user input and/or provides confirmation that the user intends to send the communication to the external device while the external device is operating in the first mode of operation, thereby providing improved visual feedback to the user, reducing the number of inputs needed to perform an operation, and/or performing an operation when a set of conditions has been met without requiring further user input.

In some embodiments, after sending the communication to the external device (e.g., 600) via the first communication protocol, the computer system (e.g., 100, 300, 500, 600, 634, 646, 654, and/or 658) detects, via one or more input devices (e.g., 602 and/or 658a) (e.g., a touch-sensitive surface (e.g., a touch-sensitive display); a mouse; a keyboard; a remote control; a visual input device (e.g., one or more cameras such as, e.g., an infrared camera, a depth camera, a visible light camera, and/or a gaze tracking camera); an audio input device (e.g., a microphone); a biometric sensor (e.g., a fingerprint sensor, a face identification sensor, a gaze tracking sensor, and/or an iris identification sensor); and/or one or more mechanical input devices (e.g., a depressible input mechanism; a button; a rotatable input mechanism; a crown; and/or a dial)) configured to communicate with the computer system (e.g., 100, 300, 500, 600, 634, 646, 654, and/or 658), a request (e.g., 650l) to send a second communication to the external device (e.g., 600) (e.g., the computer system receives a request to send a second communication after the computer system has sent the communication). In response to detecting the request (e.g., 650l) to send the second communication to the external device (e.g., 600) and in accordance with the determination that the external device (e.g., 600) is operating in the first mode of operation (e.g., the mode of operation of computer system 600 shown at FIGS. 6G, 6H, and/or 6O-6AJ), the computer system (e.g., 100, 300, 500, 600, 634, 646, 654, and/or 658) forgoes prompting (e.g., displaying prompt 656g) the user of the computer system (e.g., 100, 300, 500, 600, 634, 646, 654, and/or 658) to provide the input (e.g., 650m) to confirm sending the second communication to the external device (e.g., 600) via the first communication protocol (e.g., the computer system does not prompt the user of the computer system to confirm sending subsequent communications, such as the second communication, after the computer system sent the communication and received the input confirming sending the communication to the external device via the first communication protocol). Forgoing prompting the user to provide the input to confirm sending the second communication to the external device via the first communication protocol after the communication has been sent to the external device allows the computer system to conserve battery power because the computer system already received confirmation to send communications to the external device, thereby improving battery life and/or increasing the amount of time between battery charges.

In some embodiments, in response to the request (e.g., 650l) to send the communication to the external device (e.g., 600) and in accordance with a determination that the request (e.g., 650l) to send the communication to the external device (e.g., 600) includes a first type of communication (e.g., a communication sent via computer system 658, as shown at FIGS. 6Z and 6AA) (e.g., a short message system communication and/or a non-encrypted message), the computer system (e.g., 100, 300, 500, 600, 634, 646, 654, and/or 658) forgoes sending the communication to the external device (e.g., 600) via the first communication protocol (e.g., the computer system does not prompt the user of the computer system to provide the input to confirm sending the communication to the external device via the first communication protocol and does not send the communication to the external device via the first communication protocol); and the computer system (e.g., 100, 300, 500, 600, 634, 646, 654, and/or 658) initiates a process to receive a third communication (e.g., a communication received by computer system 646, as shown at FIG. 6U) (e.g., a text message, a photo message, a voice message, and/or a video message) (in some embodiments, the third communication is the first type of communication) from the external device (e.g., 600) via the first communication protocol (e.g., the computer system receives data via the first communication protocol, where the data corresponds to and/or is associated with the third communication). In some embodiments, the computer system cannot send communications of the first type to the external device while the external device is operating in the first mode of operation, but the computer system can receive communications of the first type from the external device while the external device is operating in the first mode of operation. Forgoing sending the communication to the external device via the first communication protocol and initiating the process to receive the third communication from the external device via the first communication protocol when the request to send the communication to the external device includes the first type of communication further notifies the user that the external device is operating in the first mode of operation and/or allows the computer system to conserve battery power by limiting the types of communications sent to the external device, thereby providing improved visual feedback to the user, improving battery life, and/or increasing the amount of time between battery charges.

In some embodiments, after receiving the third communication (e.g., the communication received at computer system 646 at FIG. 6U) from the external device (e.g., 600) via the first communication protocol, the computer system (e.g., 100, 300, 500, 600, 634, 646, 654, and/or 658) detects, via one or more input devices (e.g., 602 and/or 658a) (e.g., a touch-sensitive surface (e.g., a touch-sensitive display); a mouse; a keyboard; a remote control; a visual input device (e.g., one or more cameras such as, e.g., an infrared camera, a depth camera, a visible light camera, and/or a gaze tracking camera); an audio input device (e.g., a microphone); a biometric sensor (e.g., a fingerprint sensor, a face identification sensor, a gaze tracking sensor, and/or an iris identification sensor); and/or one or more mechanical input devices (e.g., a depressible input mechanism; a button; a rotatable input mechanism; a crown; and/or a dial)) configured to communicate with the computer system (e.g., 100, 300, 500, 600, 634, 646, 654, and/or 658), a request (e.g., 6500) to send a fourth communication (e.g., the fourth communication is the first type of communication) to the external device (e.g., 600) via the first communication protocol. In response to detecting the request (e.g., 6500) to send the fourth communication to the external device (e.g., 600) via the first communication protocol, the computer system (e.g., 100, 300, 500, 600, 634, 646, 654, and/or 658) initiates a process for sending a fourth communication to the external device (e.g., 600) via the first communication protocol (e.g., the computer system is configured to send the fourth communication to the external device via the first communication protocol after the computer system has received the third communication from the external device via the first communication protocol). Initiating the process for sending the fourth communication to the external device via the first communication protocol in response to detecting the request to send the fourth communication and after receiving the third communication from the external device allows the computer system to confirm that an additional user of the external device intends to communicate with the user of the computer system and conserves battery power of the computer system, thereby improving battery life and/or increasing the amount of time between battery charges.

In some embodiments, in accordance with a determination that the request (e.g., 650l) to send the communication to the external device (e.g., 600) is received from a second external device (e.g., 642) (e.g., a smart phone, a smart watch, a tablet computer, a laptop computer, a desktop computer, a wearable device, and/or head-mounted device) that is in communication with (e.g., a paired relationship, such as a relationship in which a first type of data is transmitted between the computer system and a second external device) the computer system (e.g., 100, 300, 500, 600, 634, 646, 654, and/or 658), the computer system (e.g., 100, 300, 500, 600, 634, 646, 654, and/or 658) forgoes sending the communication to the external device (e.g., 600) via the computer system (e.g., 100, 300, 500, 600, 634, 646, 654, and/or 658) (e.g., via the first communication protocol in accordance with the determination that the external device is operating in the first mode of operation and via the second communication protocol in accordance with the determination that the external device is not operating in the first mode of operation); and the computer system (e.g., 100, 300, 500, 600, 634, 646, 654, and/or 658) initiates a process to send the communication to the external device (e.g., 600) via the second external device (e.g., 642) (e.g., via the first communication protocol in accordance with the determination that the external device is operating in the first mode of operation and via the second communication protocol in accordance with the determination that the external device is not operating in the first mode of operation). In some embodiments, the second external device is not configured to establish a connection with a first element of the first communication protocol but is configured to send the communication to the external device via a second element of the first communication protocol. In some embodiments, in accordance with a determination that the request to send the communication to the external device is received from the computer system, the computer system sends the communication to the external device (e.g., via the first communication protocol in accordance with the determination that the external device is operating in the first mode of operation and via the second communication protocol in accordance with the determination that the external device is not operating in the first mode of operation). Enabling a smart phone or a smart watch to send communications to the external device while the external device is operating in the first mode of operation allows the user of the computer system additional flexibility to send the communication via an available and/or convenient device, thereby reducing the number of inputs needed to perform an operation.

In some embodiments, in accordance with the determination that the external device (e.g., 600) is operating in the first mode of operation (e.g., the mode of operation of computer system 600 shown at FIGS. 6G, 6H, and/or 6O-6AJ) and in accordance with a determination that the request (e.g., 650l) to send the communication to the external device (e.g., 600) is a request to send a communication to multiple external devices (e.g., send a message to the users associated with message user interface object 620h) (e.g., the request to send the communication includes a request to send the communication to multiple, different external devices associated with contactable entities, such as a group message or a group chat), the computer system (e.g., 100, 300, 500, 600, 634, 646, 654, and/or 658) forgoes prompting (e.g., displaying prompt 656g) the user of the computer system (e.g., 100, 300, 500, 600, 634, 646, 654, and/or 658) to provide the input (e.g., 650m) to confirm sending the communication to the external device (e.g., 600) via the first communication protocol (e.g., the computer system does not prompt the user of the computer system to provide the input to confirm sending the communication to the external device via the first communication protocol and does not send the communication to the external device via the first communication protocol when the request to send the communication to the external device is a request to send the communication to multiple external devices). Forgoing prompting the user of the computer to provide the input to confirm sending the communication to the external device (and forgoing sending the communication to the external device) via the first communication protocol when the request to send the communication to the external device includes a request to send a communication with multiple external device allows the computer system to conserve battery power by limiting the types of communications that can be sent to the external device while the external device operates in the first mode of operation, thereby improving battery life and/or increasing the amount of time between battery charges.

Note that details of the processes described above with respect to method 900 (e.g., FIG. 9) are also applicable in an analogous manner to the methods described above. For example, methods 700 and 800 optionally include one or more of the characteristics of the various methods described above with reference to method 900. For example, the computer system of method 700 can receive communications via the computer system of method 900. As another example, the computer system of method 900 can be utilized to communicate with the computer system of method 800.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve communication between devices. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to enable communications between devices. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of initiating communications, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, communications between devices can occur based on non-personal information data or a bare minimum amount of personal information, such as the content being requested by the device associated with a user, other non-personal information available to the devices, or publicly available information.

1.-57. (canceled)

58. A computer system, comprising:
one or more processors; and
memory storing one or more programs configured to be executed by the one or more processors, the one or more programs including instructions for:
in response to a request to send a communication to an external device:
in accordance with a determination that the external device is operating in a first mode of operation, prompting a user of the computer system to provide an input to confirm sending the communication to the external device via a first communication protocol; and
in accordance with a determination that the external device is not operating in the first mode of operation:
forgoing prompting the user to provide a user input to confirm sending the communication to the external device via the first communication protocol; and
sending the communication to the external device via a second communication protocol different from the first communication protocol.

59. The computer system of claim 58, wherein the one or more programs further include instructions for:
prior to prompting the user of the computer system to provide the input to confirm sending the communication to the external device:
in accordance with a determination that a set of one or more communication criteria is met, displaying, via a display generation component that is configured to communicate with the computer system, a status indicator indicating that the external device is operating in the first mode of operation.

60. The computer system of claim 59, wherein the one or more programs further include instructions for:
prior to prompting the user of the computer system to provide the input to confirm sending the communication to the external device:
in accordance with a determination that the set of one or more communication criteria is not met, wherein the set of one or more communication criteria is not met when the external device is associated with a contactable entity of a first type, forgoing display of the status indicator indicating that the external device is operating in the first mode of operation.

61. The computer system of claim 60, wherein the one or more programs further include instructions for:
in response to detecting, via one or more input devices configured to communicate with the computer system, a user input corresponding to the input to confirm sending the communication to the external device via the first communication protocol, initiating a process to send the communication to the external device; and
after sending the communication to the external device:
in accordance with the determination that the external device is associated with the contactable entity of the first type, displaying, via the display generation component, the status indicator indicating that the external device is operating in the first mode of operation.

62. The computer system of claim 58, wherein the one or more programs further include instructions for:
prior to prompting the user of the computer system to provide the input to confirm sending the communication to the external device via the first communication protocol, displaying, via a display generation component that is configured to communicate with the computer system, an indication of a character count of the communication.

63. The computer system of claim 58, wherein the one or more programs further include instructions for:
after sending the communication to the external device via the first communication protocol and in accordance with a determination that the communication was delivered to an intermediate device associated with the first communication protocol, displaying, via a display generation component that is configured to communicate with the computer system, an indication that the communication was delivered to the intermediate device associated with the first communication protocol.

64. The computer system of claim 58, wherein the one or more programs further include instructions for:
after sending the communication to the external device via the second communication protocol:
in accordance with a determination that the external device transitioned to the first mode of operation prior to the external device receiving the communication via the second communication protocol, prompting the user of the computer system to provide the input to confirm sending the communication to the external device via the first communication protocol.

65. The computer system of claim 58, wherein the one or more programs further include instructions for:
after sending the communication to the external device via the first communication protocol, detecting, via one or more input devices configured to communicate with the computer system, a request to send a second communication to the external device; and
in response to detecting the request to send the second communication to the external device:
in accordance with the determination that the external device is operating in the first mode of operation, forgoing prompting the user of the computer system to provide the input to confirm sending the second communication to the external device via the first communication protocol.

66. The computer system of claim 58, wherein the one or more programs further include instructions for:
in response to the request to send the communication to the external device:
in accordance with a determination that the request to send the communication to the external device includes a first type of communication:
forgoing sending the communication to the external device via the first communication protocol; and
initiating a process to receive a third communication from the external device via the first communication protocol.

67. The computer system of claim 66, wherein the one or more programs further include instructions for:
after receiving the third communication from the external device via the first communication protocol, detecting, via one or more input devices configured to communicate with the computer system, a request to send a fourth communication to the external device via the first communication protocol; and
in response to detecting the request to send the fourth communication to the external device via the first communication protocol, initiating a process for sending a fourth communication to the external device via the first communication protocol.

68. The computer system of claim 58, wherein the one or more programs further include instructions for:
in accordance with a determination that the request to send the communication to the external device is received from a second external device that is in communication with the computer system:
forgoing sending the communication to the external device via the computer system; and
initiating a process to send the communication to the external device via the second external device.

69. The computer system of claim 58, wherein the one or more programs further include instructions for:
in accordance with the determination that the external device is operating in the first mode of operation and in accordance with a determination that the request to send the communication to the external device is a request to send a communication to multiple external devices, forgoing prompting the user of the computer system to provide the input to confirm sending the communication to the external device via the first communication protocol.

70.-73. (canceled)

74. A non-transitory computer-readable storage medium storing one or more programs configured to be executed by one or more processors of a computer system, the one or more programs including instructions for:
in response to a request to send a communication to an external device:
in accordance with a determination that the external device is operating in a first mode of operation, prompting a user of the computer system to provide an input to confirm sending the communication to the external device via a first communication protocol; and
in accordance with a determination that the external device is not operating in the first mode of operation:
forgoing prompting the user to provide a user input to confirm sending the communication to the external device via the first communication protocol; and
sending the communication to the external device via a second communication protocol different from the first communication protocol.

75. A method, comprising:
at a computer system:
in response to a request to send a communication to an external device:
in accordance with a determination that the external device is operating in a first mode of operation, prompting a user of the computer system to provide an input to confirm sending the communication to the external device via a first communication protocol; and
in accordance with a determination that the external device is not operating in the first mode of operation:
forgoing prompting the user to provide a user input to confirm sending the communication to the external device via the first communication protocol; and
sending the communication to the external device via a second communication protocol different from the first communication protocol.

76. (canceled)

77. (canceled)
